SEQUENCE LISTING (10 sequences)

SEQ ID NO: 1 - protein, 23 aa, Artificial Sequence
  Synthetic peptide derived from Haemophilus Influenza Haemagglutinin-2
GLFGAIAGFIENGWEGMIDGGGC

SEQ ID NO: 2 - protein, 30 aa, Artificial Sequence
  Synthetic amphipathic peptide
WEAALAEALAEALAEHLAEALAEALEALAA

SEQ ID NO: 3 - protein, 30 aa, Artificial Sequence
  Synthetic amphipathic peptide
WEAKLAKALAKALAKHLAKALAKALKACEA

SEQ ID NO: 4 - protein, 50 aa, Artificial sequence
  Synthetic peptide
DDDDDDDDDDDDDDDDDDDDDDDDDDDDDDDDDDDDDDDDDDDDDDDDDD

SEQ ID NO: 5 - protein, 75 aa, Artificial sequence
  Synthetic peptide
DDDDDDDDDDDDDDDDDDDDDDDDDDDDDDDDDDDDDDDDDDDDDDDDDDDDDDDDDDDDDDDDDDDDDDDDDDD

SEQ ID NO: 6 - protein, 100 aa, Artificial sequence
  Synthetic peptide
DDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDDD

SEQ ID NO: 7 - protein, 50 aa, Artificial sequence
  Synthetic peptide
XXXXXXXXXXXXXXXXXXXXXXXXXXXXXXXXXXXXXXXXXXXXXXXXXX

SEQ ID NO: 8 - protein, 100 aa, Artificial sequence
  Synthetic peptide
XXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXX

SEQ ID NO: 9 - protein, 50 aa, Artificial sequence; identical to SEQ ID NO: 7
  Synthetic peptide

SEQ ID NO: 10 - protein, 100 aa, Artificial sequence; identical to SEQ ID NO: 8
  Synthetic peptide

(19) United States
(12) Patent Application Publication
(10) Pub. No.: US 2010/0292432 A1
(43) Pub. Date: Nov. 18, 2010

(54) POLYMERS FOR POLYNUCLEOTIDE ENCAPSULATION

(75) Inventors: Gregoire Cardoen, Port-Gentil (FR); Kevin N. Sill, Tampa, FL (US); Janni Mirosevich, Tampa, FL (US); Habib Skaff, Tampa, FL (US)

Correspondence Address: CHOATE, HALL & STEWART LLP, TWO INTERNATIONAL PLACE, BOSTON, MA, 02110, US

(73) Assignee: Intezyne Technologies, Incorporated, Tampa, FL (US)

(21) Appl. No.: 12/770,315

(22) Filed: Apr. 29, 2010

Related U.S. Application Data
(60) Provisional application No. 61/174,340, filed on Apr. 30, 2009.

(51) Int. Cl. C08G 69/40

(52) U.S. Cl. 528/327; 528/331

(57) ABSTRACT

The present invention provides block copolymers comprising hydrophobic moieties in a cationic complexing block, methods of preparing the same, and intermediates thereto. The compounds are useful in a variety of applications such as the assembly of micellar polyion complexes. The invention further provides methods of using said compounds and compositions thereof.

### CROSS REFERENCE TO RELATED APPLICATIONS

The present invention claims priority to U.S. provisional application Ser. No. 61/174,340, filed Apr. 30, 2009, the entirety of which is hereby incorporated by reference.

### FIELD OF THE INVENTION

The present invention relates to the field of polymer chemistry and more particularly to copolymers and uses thereof.

### BACKGROUND OF THE INVENTION

The development of new therapeutic agents has dramatically improved the quality of life and survival rate of patients suffering from a variety of disorders. However, drug delivery innovations are needed to improve the success rate of these treatments. Specifically, delivery systems are still needed which effectively minimize premature excretion and/or metabolism of therapeutic agents and deliver these agents specifically to diseased cells thereby reducing their toxicity to healthy cells.

Rationally-designed, nanoscopic drug carriers, or “nanovectors,” offer a promising approach to achieving these goals due to their inherent ability to overcome many biological barriers. Moreover, their multi-functionality permits the incorporation of cell-targeting groups, diagnostic agents, and a multitude of therapeutic agents in a single delivery system. Polymer micelles, formed by the molecular assembly of functional, amphiphilic block copolymers, represent one notable type of multifunctional nanovector.

Polymer micelles are particularly attractive due to their ability to deliver large payloads of a variety of drugs (e.g. small molecule, proteins, and DNA/RNA therapeutics), their improved in vivo stability as compared to other colloidal carriers (e.g. liposomes), and their nanoscopic size which allows for passive accumulation in diseased tissues, such as solid tumors, by the enhanced permeation and retention (EPR) effect. Using appropriate surface functionality, polymer micelles are further decorated with cell-targeting groups and permeation enhancers that can actively target diseased cells and aid in cellular entry, resulting in improved cell-specific delivery.

While self assembly represents a convenient method for the bottom-up design of nanovectors, the forces that drive and sustain the assembly of polymer micelles are concentration dependent and inherently reversible. In clinical applications, where polymer micelles are rapidly diluted following administration, this reversibility, along with high concentrations of micelle-destabilizing blood components (e.g. proteins, lipids, and phospholipids), often leads to premature dissociation of the drug-loaded micelle before active or passive targeting is effectively achieved. For polymer micelles to fully reach their cell-targeting potential and exploit their envisioned multi-functionality, in vivo circulation time must be improved. Drug delivery vehicles are needed that are stable to post-administration dilution, can avoid biological barriers (e.g. reticuloendothelial system (RES) uptake), and deliver drugs in response to the physiological environment encountered in diseased tissues such as solid tumors.

### DETAILED DESCRIPTION OF CERTAIN EMBODIMENTS OF THE INVENTION

### 1. General Description:

There are several key factors that limit the use of lipoplexes and polyplexes for in vivo gene delivery applications, particularly when systemic delivery is desired. These include instability of these electrostatic assemblies in high salt environments, irreversible protein binding to the complex that can alter its pharmacokinetic profile, and capture by RES due to excess positive charge. The covalent attachment of poly(ethylene glycol) (PEG) to gene carriers has been shown to address many of these limitations by sterically shielding the complex from unwanted cellular and protein interactions as well as imparting the inherent, stealth properties of PEG. MacLachlan and coworkers have demonstrated that PEG-lipid conjugates, used in conjunction with traditional lipids, can improve the stability and circulation half-life of DNA-loaded lipoplexes (J. Control. Release, 2006, 112, 280). Similarly, Kissel and coworkers have developed PEG-modified PEI polyplexes that showed enhanced circulation lifetimes when compared to unmodified PEI polyplexes (Pharm. Res., 2002, 19, 810).

PEG has become a standard choice for the hydrophilic, corona-forming segment of block copolymer micelles, and numerous studies have confirmed its ability to reduce RES uptake of micellar delivery systems. See Kwon, G.; Suwa, S.; Yokoyama, M.; Okano, T.; Sakurai, Y.; Kataoka, K. J. Cont. Rel. 1994, 29, 17-23; Caliceti, P.; Veronese, F. M. Adv. Drug Del. Rev. 2003, 55, 1261-1277; Ichikawa, K.; Hikita, T.; Maeda, N.; Takeuchi, Y.; Namba, Y.; Oku, N. Bio. Pharm. Bull. 2004, 27, and 443-444. The ability to tailor PEG chain lengths offers numerous advantages in drug carrier design since studies have shown that circulation times and RES uptake are influenced by the length of the PEG block. In general, longer PEG chains lead to longer circulation times and enhanced stealth properties. In a systematic study of PEG-b-poly(lactic-co-glycolic acid) (PLGA) micelles with PEG molecular weights ranging from 5,000-20,000 Da, Langer and coworkers found that micelles coated with 20,000 Da PEG chains were the least susceptible to liver uptake. After 5 hours of circulation, less than 30% of the micelles had accumulated in the liver. See Gref, R.; Minamitake, Y.; Peracchia, M. T.; Trubetskoy, V.; Torchilin, V.; Langer, R. Science 1994, 263, 1600-1603.

Block copolymers of PEG and cationic poly(amino acid)s (e.g. PEG-b-poly(L-Lysine)) have been synthesized and utilized as reagents for DNA and RNA delivery (J. Bioact. Compat. Pol., 2000, 15, 115, Bioconjugate Chem., 1997, 8, 702). When block copolymers of this type are combined with nucleic acid-based agents, the cationic block condenses and encapsulates the negatively charged agent, forming a complex with a PEG corona (often referred to as polyion complexes (PICs)). Although PEG can improve the pharmacokinetic profiles of PICs and other lipo- and polyplexes (Gene Ther., 2002, 9, 407), it may also reduce transfection efficiency by minimizing interactions with the cellular membrane and subsequent cell uptake. The conjugation of targeting ligands that bind to cellular receptors and promote endocytosis of DNA and RNA-loaded PICs is a promising approach to promote cell uptake while retaining the stealth properties imparted by the PEG corona (Bioconjugate Chem., 2007, 18, 1415).

Kataoka (J. Am. Chem. Soc., 2005, 127, 2810-2811, J. Am. Chem. Soc., 2004, 126, 13612-13613 and J. Am. Chem. Soc., 2008, 130, 6001-6009) reported that the introduction of buffering capacity to the complexing cationic block greatly increases in vitro gene expression by increasing endosomal escape. Without being bound to any particular theory, it is believed that the introduction of secondary and tertiary amines buffer the endosomal compartments, requiring the cell to introduce greater than usual amounts of chloride ions. This increase in ionic strength leads to an increase in the endosomal osmotic pressure, eventually rupturing the compartment. The contents of the endosome (including the PIC and polynucleotide) are now released into the cytoplasm. Interestingly, adequate buffering capacity is not readily found within the scope of natural amino acids. Kataoka (Reactive and Functional Polymers, 2007, 67, 1361-1372) reported that modification of PEG-PBLA (PEG-poly(benzyl-L-aspartate) with diethylene triamine (DET) in an aminolysis reaction leads to a block copolymer with amino acid side chains consisting of an amide, a secondary amine, and a primary amine (PEG-P(AspDET)). The primary amine serves to complex with the polynucleotide and the secondary amine acts as a pH buffer as described above. It is important to note that the aminolysis reaction can lead to partial racemization of the parent L stereochemistry and partial isomerization from the α and β amino acid derivatives (mechanism described in previous reference). Despite this partial racemization of the L stereocenter, we surprisingly found a marked difference when comparing the in vitro transfection efficiency of DET modified polymers prepared from PEG-PBLA and PEG-PB(D/L)A (i.e., having partial racemization). Without wishing to be bound by any particular theory, it is believed that a D/L mixed polymer allows for greater flexibility within the ionic core, resulting in an improved transfection agent.

In addition to addressing the buffering capacity and endosomal escape, one must consider the morphology of the PIC. The non-viral delivery agents discussed above typically describe a block copolymer consisting of a hydrophilic PEG chain and a cationic block, which is inherently hydrophilic. As discussed previously, the purpose of the PEG chain is to impart a “stealth” nature to the PIC and the cationic segment is responsible for interacting with the polynucleotide to form the ion complex. Often, PICs formed with such block copolymers are described as possessing a micellar structure, with the ion complex on the interior surrounded by a PEG outer shell; however, no conclusive, experimental evidence exists to show that these PICs exist as an idealized micelle. One must consider the fact that hydrophobic interactions, the fundamental thermodynamic driving force for micelle formation, are not present in a system composed of block copolymer possessing two hydrophilic segments. Since there is no hydrophobic core to drive the micelle assembly (as found in amphiphilic block copolymers), one can envision PIC morphologies where individual ion complexes, and thus charge, are dispersed randomly throughout the complex and are not sequestered to the interior. If an excess of positive charge, as found at N:P ratios greater than one, is localized at the exterior of the complex, the stealth effect of the PEG is negated and the complex would be susceptible to opsonization and subsequent clearance by the RES system. Thus, it would be advantageous to prepare a block copolymer that is capable of both complexing a polynucleotide assembling into a micellar structure.

The present invention describes block copolymers comprising hydrophobic moieties in the cationic complexing block to drive the assembly of a micellar PIC. In certain aspects, the present invention provides multiblock copolymers comprising a polymeric hydrophilic block and a mixed random copolymer block consisting of hydrophobic and amine-containing amino acid residues. In some embodiments, provided copolymers further comprise a crosslinked or crosslinkable block.

In certain embodiments, the present invention provides triblock copolymers comprising a polymeric hydrophilic block, a crosslinked or crosslinkable poly(amino acid) block, and an amine-containing block.

In certain embodiments, the present invention provides a multiblock copolymer comprising a polymeric hydrophilic block, one or more hydrophobic stabilization blocks, and an amine containing block which may or may not contain a separate hydrophobic monomer.

In certain embodiments, a provided multiblock copolymer is suitable for polynucleotide encapsulation. As used herein, the term “polynucleotide” refers to DNA or RNA. In some embodiments, a polynucleotide is a short interfering RNA (siRNA), a microRNA (miRNA), a plasmid DNA (pDNA), a short hairpin RNA (shRNA), messanger RNA (mRNA), and antisense RNA (aRNA), to name a few, and encompasses both the nucleotide sequence and any structural embodiments thereof, such as double stranded, single stranded, helical, hairpin, etc.

In some embodiments, the present invention provides a micelle comprising a multiblock copolymer which comprises a polymeric hydrophilic block and a mixed random copolymer block consisting of hydrophobic and amine-containing amino acid residues; characterized in that said micelle has an inner core suitable for polynucleotide encapsulation and a hydrophilic shell. It will be appreciated that the polymeric hydrophilic block corresponds to the hydrophilic shell, and the mixed random copolymer block corresponds to the inner core for encapsulation of polynucleotides. In certain embodiments, the present invention provides a micelle comprising a triblock copolymer, said triblock copolymer comprising a polymeric hydrophilic block, a crosslinked or crosslinkable poly(amino acid) block, and an amine-containing block.

According to another aspect, the present invention provides a polynucleotide-loaded micelle comprising a multiblock copolymer which comprises a polymeric hydrophilic block and a mixed random copolymer block consisting of hydrophobic and amine-containing amino acid residues; characterized in that said micelle has a polynucleotide-loaded inner core and a hydrophilic shell.

Provided multiblock copolymers, and micelles comprising the same, are described in detail herein.

### 2. Definitions:

Compounds of this invention include those described generally above, and are further illustrated by the embodiments, sub-embodiments, and species disclosed herein. As used herein, the following definitions shall apply unless otherwise indicated. For purposes of this invention, the chemical elements are identified in accordance with the Periodic Table of the Elements, CAS version, Handbook of Chemistry and Physics, 75^{th} Ed. Additionally, general principles of organic chemistry are described in “Organic Chemistry,” Thomas Sorrell, University Science Books, Sausalito: 1999, and “March's Advanced Organic Chemistry”, 5^{th} Ed., Ed.: Smith, M. B. and March, J., John Wiley & Sons, New York: 2001, the entire contents of which are hereby incorporated by reference.

As used herein, the term “polynucleotide” refers to DNA or RNA. In some embodiments, a polynucleotide is a short interfering RNA (siRNA), a microRNA (miRNA), a plasmid DNA (pDNA), a short hairpin RNA (shRNA), messanger RNA (mRNA), and antisense RNA (aRNA), to name a few, and encompasses both the nucleotide sequence and any structural embodiments thereof, such as double stranded, single stranded, helical, hairpin, etc.

As used herein, the term “micelle” refers to a polymer assembly comprised of a hydrophilic shell (or corona) and a hydrophobic and/or ionic interior. In addition, the term micelle may refer to any poly ion complex assembly consisting of a multiblock copolymer possessing a net positive charge and a suitable negatively charged polynucleotide.

As used herein, the term “sequential polymerization,” and variations thereof, refers to the method wherein, after a first monomer (e.g. NCA, lactam, or imide) is incorporated into the polymer, thus forming an amino acid “block,” a second monomer (e.g. NCA, lactam, or imide) is added to the reaction to form a second amino acid block, which process may be continued in a similar fashion to introduce additional amino acid blocks into the resulting multi-block copolymers.

As used herein, the term “multiblock copolymer” refers to a polymer comprising one synthetic polymer portion and two or more poly(amino acid) portions. Such multi-block copolymers include those having the format W-X′-X″, wherein W is a synthetic polymer portion and X and X′ are poly(amino acid) chains or “amino acid blocks.” In certain embodiments, the multiblock copolymers of the present invention are triblock copolymers. As described herein, one or more of the amino acid blocks may be “mixed blocks,” meaning that these blocks can contain a mixture of amino acid monomers thereby creating multiblock copolymers of the present invention. In some embodiments, the multiblock copolymers of the present invention comprise a mixed amino acid block and are tetrablock copolymers.

As used herein, the term “triblock copolymer” refers to a polymer comprising one synthetic polymer portion and two poly(amino acid) portions.

As used herein, the term “tetrablock copolymer” refers to a polymer comprising one synthetic polymer portion and three poly(amino acid) portions.

As used herein, the term “pentablock copolymer” refers to a polymer comprising two synthetic polymer portions and three poly(amino acid) portions, where one synthetic polymer portion is on each side of the poly(amino acid) portion (i.e. W-X-X′-X″-W′ wherein W and W′ are synthetic polymer blocks and X, X′, and X″ are each a poly(amino acid) block).

As used herein, the term “portion” or “block” refers to a repeating polymeric sequence of defined composition. A portion or a block may consist of a single monomer or may be comprise of on or more monomers, resulting in a “mixed block”.

One skilled in the art will recognize that a monomer repeat unit is defined by parentheses depicted around the repeating monomer unit. The number (or letter representing a numerical range) on the lower right of the parentheses represents the number of monomer units that are present in the polymer chain. In the case where only one monomer represents the block (e.g. a homopolymer), the block will be denoted solely by the parentheses. In the case of a mixed block, multiple monomers comprise a single, continuous block. It will be understood that brackets will define a portion or block. For example, one block may consist of four individual monomers, each defined by their own individual set of parentheses and number of repeat units present. All four sets of parentheses will be enclosed by a set of brackets, denoting that all four of these monomers combine in random, or near random, order to comprise the mixed block. For clarity, the randomly mixed block of [BCADDCBADABCDABC] would be represented in shorthand by [(A)₄(B)₄(C)₄(D)₄].

As used herein, the term “inner core” as it applies to a micelle of the present invention refers to the center of the micelle formed by the terminal poly(amino acid) block. In accordance with the present invention, the inner core is not crosslinked. By way of illustration, in a triblock polymer of the format W-X′-X″, as described above, the inner core corresponds to the X″ block. It is contemplated that the X″ block can be a mixed block.

As used herein, the term “outer core” as it applies to a micelle of the present invention refers to the layer formed by the first poly(amino acid) block. The outer core lies between the inner core and the hydrophilic shell. In certain embodiments, the outer core is either crosslinkable or is cross-linked. By way of illustration, in a triblock polymer of the format W-X′-X″, as described above, the outer core corresponds to the X′ block. It is contemplated that the X′ block can be a mixed block. In certain embodiments, the outer core may be comprised of a hydrophobic amino acid block that serves to stabilize the micelle through hydrophobic interactions.

As used herein, the terms “polynucleotide-loaded”, “complexed”, “loaded”, and “encapsulated” and derivatives thereof, are used interchangeably. In accordance with the present invention, a “polynucleotide-loaded” micelle refers to a micelle having one or more polynucleotides situated within the inner core of the micelle. This is also referred to as a polynucleotide being “encapsulated” within the micelle.

As used herein, the term “polymeric hydrophilic block” refers to a polymer that is not a poly(amino acid) and is hydrophilic in nature. Such hydrophilic polymers are well known in the art and include poly(ethylene oxide) (also referred to as PEO, polyethylene glycol, or PEG), and derivatives thereof, poly(N-vinyl-2-pyrolidone), and derivatives thereof, poly(phosphocholine methacrylate) and derivatives thereof, poly(N-isopropylacrylamide), and derivatives thereof, poly(hydroxyethyl acrylate), and derivatives thereof, poly(hydroxylethyl methacrylate), and derivatives thereof, and polymers of N-(2-hydroxypropoyl)methacrylamide (HMPA) and derivatives thereof.

As used herein, the term “poly(amino acid)” or “amino acid block” refers to a covalently linked amino acid chain wherein each monomer is an amino acid unit. Such amino acid units include natural and unnatural amino acids. Such poly(amino acids) include those having suitably protected functional groups. For example, amino acid monomers may have hydroxyl or amino moieties that are optionally protected by a suitable hydroxyl protecting group or a suitable amine protecting group, as appropriate. Such suitable hydroxyl protecting groups and suitable amine protecting groups are described in more detail herein, infra. As used herein, an amino acid block comprises one or more monomers or a set of two or more monomers. In certain embodiments, an amino acid block comprises one or more monomers such that the overall block is hydrophilic. In other embodiments, an amino acid block comprises one or more monomers such that the overall block is hydrophobic. In still other embodiments, amino acid blocks of the present invention include random amino acid blocks, i.e., blocks comprising a mixture of amino acid residues.

As used herein, the phrase “natural amino acid side-chain group” refers to the side-chain group of any of the 20 amino acids naturally occurring in proteins. Such natural amino acids include the nonpolar, or hydrophobic amino acids, glycine, alanine, valine, leucine isoleucine, methionine, phenylalanine, tryptophan, and proline. Cysteine is sometimes classified as nonpolar or hydrophobic and other times as polar. Natural amino acids also include polar, or hydrophilic amino acids, such as tyrosine, serine, threonine, aspartic acid (also known as aspartate, when charged), glutamic acid (also known as glutamate, when charged), asparagine, and glutamine. Certain polar, or hydrophilic, amino acids have charged side-chains. Such charged amino acids include lysine, arginine, and histidine. One of ordinary skill in the art would recognize that protection of a polar or hydrophilic amino acid side-chain can render that amino acid nonpolar. For example, a suitably protected tyrosine hydroxyl group can render that tyroine nonpolar and hydrophobic by virtue of protecting the hydroxyl group.

As used herein, the term “D,L-mixed poly(amino acid) block” refers to a poly(amino acid) block wherein the poly(amino acid) consists of a mixture of amino acids in both the D- and L-configurations. In certain embodiments, the D,L-mixed poly(amino acid) block consists of a mixture of D-configured hydrophobic amino acids and L-configured cationic amino acid side-chain groups such that the overall poly(amino acid) block comprising is hydrophobic. In certain embodiments, the D,L-mixed poly(amino acid) block consists of a mixture of D-configured hydrophobic amino acids and L-configured hydrophilic cationic amino acid side-chain groups such that the overall poly(amino acid) block comprising is hydrophilic.

As used herein, the phrase “unnatural amino acid side-chain group” refers to the side-chain group of amino acids not included in the list of 20 amino acids naturally occurring in proteins, as described above. Such amino acids include the D-isomer of any of the 20 naturally occurring amino acids. Unnatural amino acids also include homoserine, ornithine, norleucine, and thyroxine. Other unnatural amino acids side-chains are well known to one of ordinary skill in the art and include unnatural aliphatic side chains. Other unnatural amino acids include modified amino acids, including those that are N-alkylated, cyclized, phosphorylated, acetylated, amidated, azidylated, labelled, and the like. In some embodiments, an unnatural amino acid is a D-isomer. In some embodiments, an unnatural amino acid is a L-isomer.

As used herein, the phrase “amine-containing amino acid side-chain group” refers to natural or unnatural amino acid side-chain groups, as defined above, which comprise an amine moiety. The amine moiety may be primary, secondary, tertiary, or quaternary, and may be part of an optionally substituted group aliphatic or optionally substituted aryl group.

As used herein, the phrase N to P (N/P or N:P) refers to the ratio of protonatable nitrogens (N) to negatively charged phosphate groups in the DNA or RNA backbone (P).

As used herein, the phrase “hydrophobic amino acid side-chain group” refers to natural or unnatural amino acid side-chain groups, as defined above, which are hydrophobic. These groups are not necessarily mutually exclusive from amine-containing amino acid side-chain groups. For example, tryptophan and histidine, which possess amine-containing side-chain groups, may be considered to be hydrophobic.

As used herein, the phrase “living polymer chain-end” refers to the terminus resulting from a polymerization reaction that maintains the ability to react further with additional monomer or with a polymerization terminator.

As used herein, the term “termination” refers to attaching a terminal group to a polymer chain-end by the reaction of a living polymer with an appropriate compound. Alternatively, the term “termination” may refer to attaching a terminal group to an amine or hydroxyl end, or derivative thereof, of the polymer chain.

As used herein, the term “polymerization terminator” is used interchangeably with the term “polymerization terminating agent” and refers to a compound that reacts with a living polymer chain-end to afford a polymer with a terminal group. Alternatively, the term “polymerization terminator” may refer to a compound that reacts with an amine or hydroxyl end, or derivative thereof, of the polymer chain, to afford a polymer with a terminal group.

As used herein, the term “polymerization initiator” refers to a compound, which reacts with, or whose anion or free base form reacts with, the desired monomer in a manner that results in polymerization of that monomer. In certain embodiments, a polymerization initiator is the compound that reacts with an alkylene oxide to afford a polyalkylene oxide block. In some embodiments, a polymerization initiator is an amine salt described herein.

The term “aliphatic” or “aliphatic group,” as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-20 carbon atoms. In some embodiments, aliphatic groups contain 1-10 carbon atoms. In other embodiments, aliphatic groups contain 1-8 carbon atoms. In still other embodiments, aliphatic groups contain 1-6 carbon atoms, and in yet other embodiments aliphatic groups contain 1-4 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroatom” means one or more of oxygen, sulfur, nitrogen, phosphorus, or silicon. This includes any oxidized form of nitrogen, sulfur, phosphorus, or silicon; the quaternized form of any basic nitrogen, or; a substitutable nitrogen of a heterocyclic ring including ═N— as in 3,4-dihydro-2H-pyrrolyl, —NH— as in pyrrolidinyl, or ═N(R^{†})- as in N-substituted pyrrolidinyl.

The term “unsaturated,” as used herein, means that a moiety has one or more units of unsaturation.

The term “aryl” used alone or as part of a larger moiety as in “aralkyl,” “aralkoxy,” or “aryloxyalkyl,” refers to monocyclic, bicyclic, and tricyclic ring systems having a total of five to fourteen ring members, wherein at least one ring in the system is aromatic and wherein each ring in the system contains three to seven ring members. The term “aryl” may be used interchangeably with the term “aryl ring.”

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable,” as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘}may be substituted as defined below and is independently hydrogen, C₁₋₆ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{∘}(or the ring formed by taking two independent occurrences of R^{∘}together with their intervening atoms), are independently halogen, —(CH₂)₀₋₂R^{}, -(haloR^{}), —(CH₂)₀₋₂OH, —(CH₂)₀₋₂OR^{}, —(CH₂)₀₋₂CH(OR^{})₂; —O(haloR^{}), —CN, —N₃, —(CH₂)₀₋₂C(O)R^{}, —(CH₂)₀₋₂C(O)OH, —(CH₂)₀₋₂C(O)OR^{}, —(CH₂)₀₋₂SR^{}, —(CH₂)₀₋₂SH, —(CH₂)₀₋₂NH₂, —(CH₂)₀₋₂NHR^{}, —(CH₂)₀₋₂NR^{}₂, —NO₂, —SiR^{}₃, —OSiR^{}₃, —C(O)SR^{}, —(C₁₋₄ straight or branched alkylene)C(O)OR^{}, or —SSR^{} wherein each R^{} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. A suitable tetravalent substituent that is bound to vicinal substitutable methylene carbons of an “optionally substituted” group is the dicobalt hexacarbonyl cluster represented by

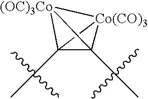

when depicted with the methylenes which bear it.

Suitable substituents on the aliphatic group of R* include halogen, —R^{}, -(haloR^{}), —OH, —OR^{}, —O(haloR^{}), —CN, —C(O)OH, —C(O)OR^{}, —NH₂, —NHR^{}, —NR^{}₂, or —NO₂, wherein each R^{} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{}, -(haloR^{}), —OH, —OR^{}, —O(haloR^{}), —CN, —C(O)OH, —C(O)OR^{}, —NH₂, —NHR^{}, —NR^{}₂, or —NO₂, wherein each R^{} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Protected hydroxyl groups are well known in the art and include those described in detail in Protecting Groups in Organic Synthesis, T. W. Greene and P. G. M. Wuts, 3^{rd} edition, John Wiley & Sons, 1999, the entirety of which is incorporated herein by reference. Examples of suitably protected hydroxyl groups further include, but are not limited to, esters, carbonates, sulfonates allyl ethers, ethers, silyl ethers, alkyl ethers, arylalkyl ethers, and alkoxyalkyl ethers. Examples of suitable esters include formates, acetates, proprionates, pentanoates, crotonates, and benzoates. Specific examples of suitable esters include formate, benzoyl formate, chloroacetate, trifluoroacetate, methoxyacetate, triphenylmethoxyacetate, p-chlorophenoxyacetate, 3-phenylpropionate, 4-oxopentanoate, 4,4-(ethylenedithio)pentanoate, pivaloate(trimethylacetate), crotonate, 4-methoxy-crotonate, benzoate, p-benylbenzoate, 2,4,6-trimethylbenzoate. Examples of suitable carbonates include 9-fluorenylmethyl, ethyl, 2,2,2-trichloroethyl, 2-(trimethylsilyl)ethyl, 2-(phenylsulfonyl)ethyl, vinyl, allyl, and p-nitrobenzyl carbonate. Examples of suitable silyl ethers include trimethylsilyl, triethylsilyl, t-butyldimethylsilyl, t-butyldiphenylsilyl, triisopropylsilyl ether, and other trialkylsilyl ethers. Examples of suitable alkyl ethers include methyl, benzyl, p-methoxybenzyl, 3,4-dimethoxybenzyl, trityl, t-butyl, and allyl ether, or derivatives thereof. Alkoxyalkyl ethers include acetals such as methoxymethyl, methylthiomethyl, (2-methoxyethoxy)methyl, benzyloxymethyl, beta-(trimethylsilyl)ethoxymethyl, and tetrahydropyran-2-yl ether. Examples of suitable arylalkyl ethers include benzyl, p-methoxybenzyl (MPM), 3,4-dimethoxybenzyl, O-nitrobenzyl, p-nitrobenzyl, p-halobenzyl, 2,6-dichlorobenzyl, p-cyanobenzyl, 2- and 4-picolyl ethers.

Protected amines are well known in the art and include those described in detail in Greene (1999). Suitable mono-protected amines further include, but are not limited to, aralkylamines, carbamates, allyl amines, amides, and the like. Examples of suitable mono-protected amino moieties include t-butyloxycarbonylamino (—NHBOC), ethyloxycarbonylamino, methyloxycarbonylamino, trichloroethyloxycarbonylamino, allyloxycarbonylamino (—NHAlloc), benzyloxocarbonylamino (—NHCBZ), allylamino, benzylamino (—NHBn), fluorenylmethylcarbonyl (—NHFmoc), formamido, acetamido, chloroacetamido, dichloroacetamido, trichloroacetamido, phenylacetamido, trifluoroacetamido, benzamido, t-butyldiphenylsilyl, and the like. Suitable di-protected amines include amines that are substituted with two substituents independently selected from those described above as mono-protected amines, and further include cyclic imides, such as phthalimide, maleimide, succinimide, and the like. Suitable di-protected amines also include pyrroles and the like, 2,2,5,5-tetramethyl-[1,2,5]azadisilolidine and the like, and azide.

Protected aldehydes are well known in the art and include those described in detail in Greene (1999). Suitable protected aldehydes further include, but are not limited to, acyclic acetals, cyclic acetals, hydrazones, imines, and the like. Examples of such groups include dimethyl acetal, diethyl acetal, diisopropyl acetal, dibenzyl acetal, bis(2-nitrobenzyl)acetal, 1,3-dioxanes, 1,3-dioxolanes, semicarbazones, and derivatives thereof.

Protected carboxylic acids are well known in the art and include those described in detail in Greene (1999). Suitable protected carboxylic acids further include, but are not limited to, optionally substituted C₁₋₆ aliphatic esters, optionally substituted aryl esters, silyl esters, activated esters, amides, hydrazides, and the like. Examples of such ester groups include methyl, ethyl, propyl, isopropyl, butyl, isobutyl, benzyl, and phenyl ester, wherein each group is optionally substituted. Additional suitable protected carboxylic acids include oxazolines and ortho esters.

Protected thiols are well known in the art and include those described in detail in Greene (1999). Suitable protected thiols further include, but are not limited to, disulfides, thioethers, silyl thioethers, thioesters, thiocarbonates, and thiocarbamates, and the like. Examples of such groups include, but are not limited to, alkyl thioethers, benzyl and substituted benzyl thioethers, triphenylmethyl thioethers, and trichloroethoxycarbonyl thioester, to name but a few.

Unless otherwise stated, structures depicted herein are also meant to include all isomeric (e.g., enantiomeric, diastereomeric, and geometric (or conformational)) forms of the structure; for example, the R and S configurations for each asymmetric center, Z and E double bond isomers, and Z and E conformational isomers. Therefore, single stereochemical isomers as well as enantiomeric, diastereomeric, and geometric (or conformational) mixtures of the present compounds are within the scope of the invention. Unless otherwise stated, all tautomeric forms of the compounds of the invention are within the scope of the invention. Additionally, unless otherwise stated, structures depicted herein are also meant to include compounds that differ only in the presence of one or more isotopically enriched atoms. For example, compounds having the present structures except for the replacement of hydrogen by deuterium or tritium, or the replacement of a carbon by a ¹³C- or ¹⁴C-enriched carbon are within the scope of this invention. Such compounds are useful, for example, in neutron scattering experiments, as analytical tools, or probes in biological assays.

As used herein, the term “detectable moiety” is used interchangeably with the term “label” and relates to any moiety capable of being detected (e.g., primary labels and secondary labels). A “detectable moiety” or “label” is the radical of a detectable compound.

“Primary” labels include radioisotope-containing moieties (e.g., moieties that contain ³²P, ³³P, ³⁵S, ³H, or ¹⁴C), mass-tags, and fluorescent labels, and are signal-generating reporter groups which can be detected without further modifications.

Other primary labels include those useful for positron emission tomography including molecules containing radioisotopes (e.g. ¹⁸F) or ligands with bound radioactive metals (e.g. ⁶²Cu). In other embodiments, primary labels are contrast agents for magnetic resonance imaging such as gadolinium, gadolinium chelates, or iron oxide (e.g Fe₃O₄, Fe₂O₃, MFe₂O₄ (where M is a suitable metal such as Cu, Mn, etc.)) particles. Similarly, semiconducting nanoparticles (e.g. cadmium selenide, cadmium sulfide, cadmium telluride) are useful as fluorescent labels. Other metal nanoparticles (e.g colloidal gold) also serve as primary labels.

“Secondary” labels include moieties such as biotin, or protein antigens, that require the presence of a second compound to produce a detectable signal. For example, in the case of a biotin label, the second compound may include streptavidin-enzyme conjugates. In the case of an antigen label, the second compound may include an antibody-enzyme conjugate. Additionally, certain fluorescent groups can act as secondary labels by transferring energy to another compound or group in a process of nonradiative fluorescent resonance energy transfer (FRET), causing the second compound or group to then generate the signal that is detected.

Unless otherwise indicated, radioisotope-containing moieties are optionally substituted hydrocarbon groups that contain at least one radioisotope. Unless otherwise indicated, radioisotope-containing moieties contain from 1-40 carbon atoms and one radioisotope. In certain embodiments, radioisotope-containing moieties contain from 1-20 carbon atoms and one radioisotope.

The terms “fluorescent label,” “fluorescent group,” “fluorescent compound,” “fluorescent dye,” and “fluorophore,” as used herein, refer to compounds or moieties that absorb light energy at a defined excitation wavelength and emit light energy at a different wavelength. Examples of fluorescent compounds include, but are not limited to: Alexa Fluor dyes (Alexa Fluor 350, Alexa Fluor 488, Alexa Fluor 532, Alexa Fluor 546, Alexa Fluor 568, Alexa Fluor 594, Alexa Fluor 633, Alexa Fluor 660, Alexa Fluor 680, Alexa Fluor 700, and Alexa Fluor 750), AMCA, AMCA-S, BODIPY dyes (BODIPY FL, BODIPY R6G, BODIPY TMR, BODIPY TR, BODIPY 530/550, BODIPY 558/568, BODIPY 564/570, BODIPY 576/589, BODIPY 581/591, BODIPY 630/650, BODIPY 650/665), Carboxyrhodamine 6G, carboxy-X-rhodamine (ROX), Cascade Blue, Cascade Yellow, Coumarin 343, Cyanine dyes (Cy3, Cy5, Cy3.5, Cy5.5), Dansyl, Dapoxyl, Dialkylaminocoumarin, 4′,5′-Dichloro-2′,7′-dimethoxy-fluorescein, DM-NERF, Eosin, Erythrosin, Fluorescein, FAM, Hydroxycoumarin, IRDyes (IRD40, IRD 700, IRD 800), JOE, Lissamine rhodamine B, Marina Blue, Methoxycoumarin, Naphthofluorescein, Oregon Green 488, Oregon Green 500, Oregon Green 514, Pacific Blue, PyMPO, Pyrene, Rhodamine B, Rhodamine 6G, Rhodamine Green, Rhodamine Red, Rhodol Green, 2′,4′,5′,7′-Tetra-bromosulfone-fluorescein, Tetramethyl-rhodamine (TMR), Carboxytetramethylrhodamine (TAMRA), Texas Red, Texas Red-X.

The term “mass-tag” as used herein refers to any moiety that is capable of being uniquely detected by virtue of its mass using mass spectrometry (MS) detection techniques. Examples of mass-tags include electrophore release tags such as N-[3-[4′-[(p-Methoxytetrafluorobenzyl)oxy]phenyl]-3-methylglyceronyl]isonipecotic Acid, 4′-[2,3,5,6-Tetrafluoro-4-(pentafluorophenoxyl)]methyl acetophenone, and their derivatives. The synthesis and utility of these mass-tags is described in U.S. Pat. Nos. 4,650,750, 4,709,016, 5,360,8191, 5,516,931, 5,602,273, 5,604,104, 5,610,020, and 5,650,270. Other examples of mass-tags include, but are not limited to, nucleotides, dideoxynucleotides, oligonucleotides of varying length and base composition, oligopeptides, oligosaccharides, and other synthetic polymers of varying length and monomer composition. A large variety of organic molecules, both neutral and charged (biomolecules or synthetic compounds) of an appropriate mass range (100-2000 Daltons) may also be used as mass-tags.

The term “substrate,” as used herein refers to any material or macromolecular complex to which a functionalized end-group of a block copolymer can be attached. Examples of commonly used substrates include, but are not limited to, glass surfaces, silica surfaces, plastic surfaces, metal surfaces, surfaces containing a metallic or chemical coating, membranes (e.g., nylon, polysulfone, silica), micro-beads (eg., latex, polystyrene, or other polymer), porous polymer matrices (e.g., polyacrylamide gel, polysaccharide, polymethacrylate), macromolecular complexes (e.g., protein, polysaccharide).

The term “fusogenic peptide” refers to a peptide sequence that promotes escape from endolysosomal compartments. Great efforts have been undertaken to further enhance endolysosomal escape and thus prevent lysosomal degradation. A key strategy has been adapted from viral elements that promote escape from the harsh endolysosomal environment and deliver their genetic information intact into the nucleus. Apart from complete virus capsids and purified capsid proteins, short amino acid sequences derived from the N-terminus of Haemophilus Influenza Haemagglutinin-2 have also been shown to induce pH-sensitive membrane disruption, leading to improved transfection of DNA-polycation polymer complexes in vitro. One such example is the INF7 peptide (GLFGAIAGFIENGWEGMIDGGGC). At neutral pH (pH 7.0) the INF peptide forms a random coil structure without fusogenic activity. However, this peptide undergoes a conformational change into an amphipathic α-helix at pH 5.0 and aggregates resulting in the formation of pores which destabilize endosomal membranes causing vesicle leakage. Indeed, the INF7 peptide has been used in combination with polymer based delivery systems and shown to tremendously enhance gene transfection activity without affecting cell cytotoxicity. Other synthetic fusogenic peptides include the GALA (WEAALAEALAEALAEHLAEALAEALEALAA) and KALA (WEAKLAKALAKALAKHLAKALAKALKACEA) peptides. These peptides have previously been used to successfully promote extensive membrane destabilization and subsequently, contribute to transfection enhancement.

As used herein, the term “targeting group” refers to any molecule, macromolecule, or biomacromolecule which selectively binds to receptors that are expressed or over-expressed on specific cell types. Targeting groups are well known in the art and include those described in International application publication number WO 2008/134731, published Nov. 6, 2008, the entirety of which is hereby incorporated by reference. In some embodiments, the targeting group is a moiety selected from folate, a Her-2 binding peptide, a urokinase-type plasminogen activator receptor (uPAR) antagonist, a CXCR4 chemokine receptor antagonist, a GRP78 peptide antagonist, an RGD peptide, an RGD cyclic peptide, a luteinizing hormone-releasing hormone (LHRH) antagonist peptide, an aminopeptidase targeting peptide, a brain homing peptide, a kidney homing peptide, a heart homing peptide, a gut homing peptide, an integrin homing peptide, an angiogencid tumor endothelium homing peptide, an ovary homing peptide, a uterus homing peptide, a sperm homing peptide, a microglia homing peptide, a synovium homing peptide, a urothelium homing peptide, a prostate homing peptide, a lung homing peptide, a skin homing peptide, a retina homing peptide, a pancreas homing peptide, a liver homing peptide, a lymph node homing peptide, an adrenal gland homing peptide, a thyroid homing peptide, a bladder homing peptide, a breast homing peptide, a neuroblastoma homing peptide, a lymphona homing peptide, a muscle homing peptide, a wound vasculature homing peptide, an adipose tissue homing peptide, a virus binding peptide, or a fusogenic peptide.

The term “oligopeptide”, as used herein refers to any peptide of 2-65 amino acid residues in length. In some embodiments, oligopeptides comprise amino acids with natural amino acid side-chain groups. In some embodiments, oligopeptides comprise amino acids with unnatural amino acid side-chain groups. In certain embodiments, oligopeptides are 2-50 amino acid residues in length. In certain embodiments, oligopeptides are 2-40 amino acid residues in length. In some embodiments, oligopeptides are cyclized variations of the linear sequences.

### Description of Exemplary Embodiments

A. Multiblock Copolymers

As described generally above, in certain embodiments the present invention provides a micelle comprising a multiblock copolymer which comprises a polymeric hydrophilic block and a one or more poly(amino acid) blocks which may or may not consist of a mixed poly(amino acid) block; characterized in that said micelle has an inner core suitable for polynucleotide encapsulation and a hydrophilic shell. In certain embodiments, a provided multiblock copolymer further comprises an optionally crosslinked or crosslinkable block.

Amphiphilic multiblock copolymers, as described herein, can self-assemble in aqueous solution to form nano- and micron-sized structures. In water, these multiblock cationic copolymers co-assemble with polynucleotides through electrostatic interactions between the cationic side chains of the polymer and the anionic phosphates of the polynucleotide. In some cases, the number of phosphates on the polynucleotides may exceed the number of cationic charges on the multiblock copolymer. It will be appreciated that multiple polymers may be used to achieve charge neutrality (i.e. N/P=1) between the polymer and encapsulated polynucleotide. It will also be appreciated that when an excess of polymer is used to encapsulate a polynucleotide, the polymer/polynucleotide complex can possess an overall positive charge (i.e. N/P>1).

Without wishing to be bound by any particular theory, it is believed that the mixed random copolymer block consisting of hydrophobic and amine-containing amino acid residues collapses to form the micellar core, while a hydrophilic PEG block forms a peripheral corona and imparts water solubility. It will be appreciated that the hydrophilic PEG corona may also shield the excess charge of the polycation/polynucletide complex in the micelle core (e.g. when N/P>1), rendering the exterior of the micelle charge neutral. In certain embodiments, the multiblock copolymers in accordance with the present invention possess distinct hydrophilic and cationic segments that form micelles.

In some embodiments, such multiblock polymers optionally comprise a poly(amino acid) block which contains functionality suitable for crosslinking It will be appreciated that this functionality is found on the corresponding amino acid side-chain.

In certain embodiments, a PEG block possesses a molecular weight of about 10,000 Da (225 repeat units). In some embodiments, a PEG block possesses a molecular weight of about 12,000 Da (270 repeat units). In some embodiments, a PEG block possesses a molecular weight of about 8,000 Da (180 repeat units). In some embodiments, a PEG block possesses a molecular weight of about 5,000 Da (110 repeat units). In certain embodiments, a PEG block possesses a molecular weight of about 20,000 Da (454 repeat units). In some embodiments, a PEG block possesses a molecular weight of about 40,000 Da (908 repeat units). Without wishing to be bound by theory, it is believed that this particular PEG chain length imparts adequate water-solubility to the micelles and provides relatively long in vivo circulation times.

In certain embodiments, the present invention provides a diblock copolymer of formula I:

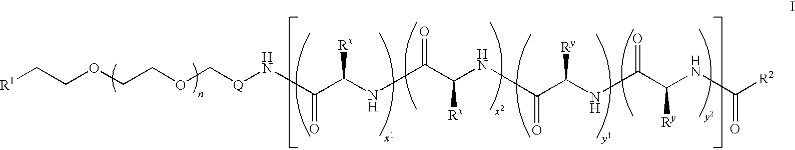

wherein:
n is 50-2500;
x¹ is 0 to 250;
x² is 0 to 250;
y¹ is 0 to 250, provided that x¹ and y¹ are not simultaneously zero;
y² is 0 to 250, provided that y¹ and y² are not simultaneously zero;
R^{x} is a natural or unnatural amino acid side-chain group that is hydrophobic;
R^{y} is a natural or unnatural amino acid side-chain group comprising an ester moiety;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a diblock copolymer of formula I-a:

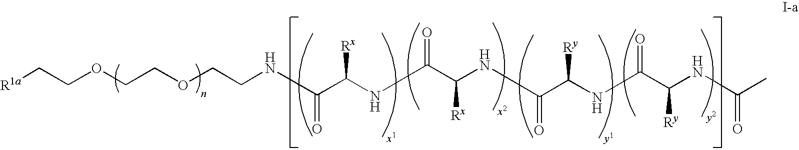

wherein:
n is 50-2500;
x¹ is 0 to 250;
x² is 0 to 250;
y¹ is 0 to 250, provided that x¹ and y¹ are not simultaneously zero;
y² is 0 to 250, provided that y¹ and y² are not simultaneously zero;
R^{x} is an amino acid side-chain group corresponding to that of glycine, alanine, norleucine, phenylalanine, isoleucine, norvaline, proline, leucine, methionine, or valine;
R^{y} is an amino acid side-chain group corresponding to that of benzyl aspartate, benzyl glutamate, t-butyl aspartate, t-butyl glutamate, methyl aspartate, methyl glutamate, alkyl aspartate or alkyl glutamate;
R^{1a} is —N₃, —OCH₂C≡CH, or —OCH₃.

In some embodiments, the R^{1a} group of formula I-a is —N₃. In certain embodiments, the R^{1a} group of formula I-a is —OCH₂C≡CH. In some embodiments, the R^{1a} group of formula I-a is —OCH₃.

As defined generally above, the R^{y} group of formulae I or I-a is a natural or unnatural amino acid side-chain group comprising an ester moiety capable of undergoing aminolysis. One of ordinary skill in the art would recognize that many readily available amine-containing compounds are suitable for such aminolysis reactions. Exemplary amine derivatives suitable for such aminolysis are set forth in Table 1, below.

TABLE 1

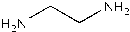

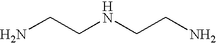

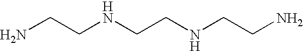

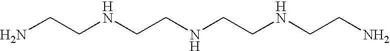

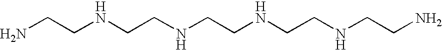

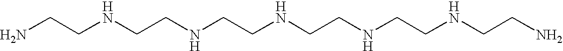

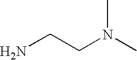

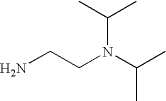

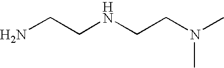

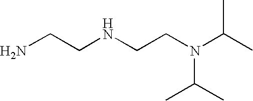

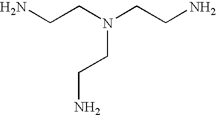

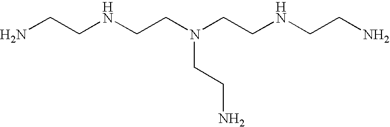

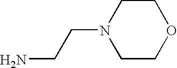

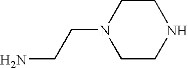

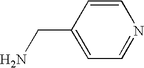

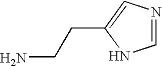

When compounds of formulae I or I-a are treated with a suitable amine under aminolysis conditions, a rearrangement to a beta-amino acid or racemization of the side chain's stereocenter is a possible side reaction. The mechanism for this rearrangement is detailed in Kataoka et. al. Reactive and Functional Polymers, 2007, 67, 1361-1372 and is represented in Scheme 1, below.

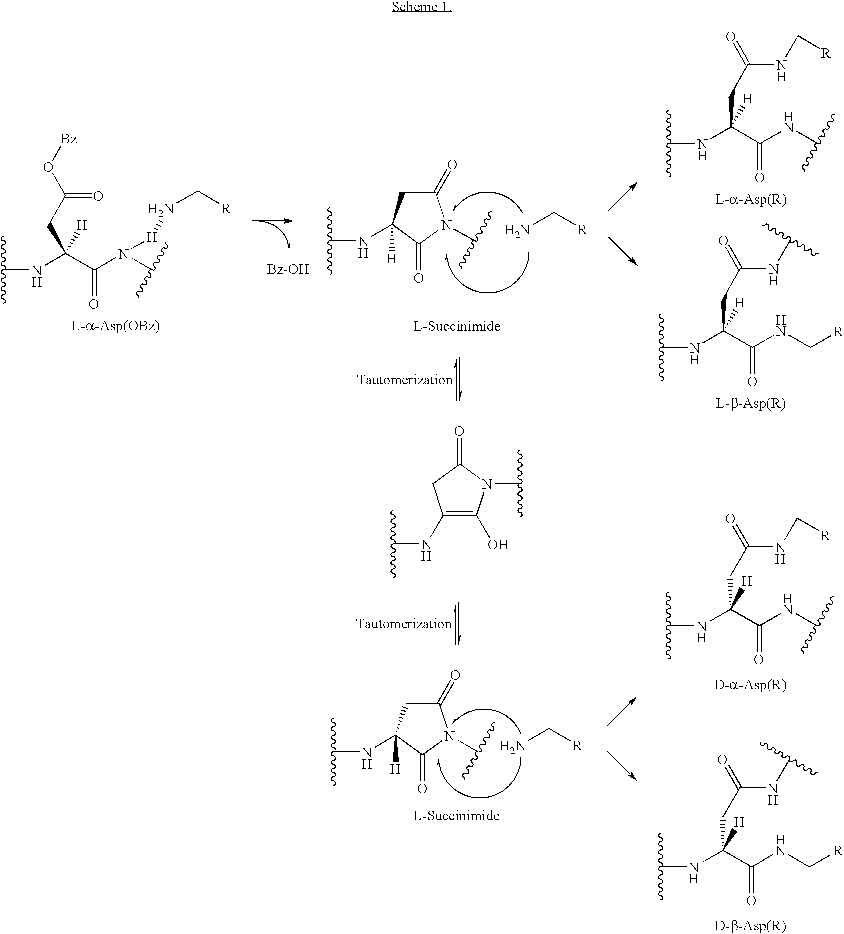

The exact reaction conditions (e.g. temperature, solvent polarity, equivalents of amine) all influence the nature of the side reactions that can occur. Thus, during the course of aminolysis, one can envision four classes of product compounds: a case where both racemization of the stereocenter and rearrangement to the beta amino acid occurs, a case where only racemization occurs, a case where only rearrangement to the beta amino acid occurs, and a case where neither racemization nor rearrangement occurs. Without wishing to be bound to any particular theory, it is believed that if the starting material is enriched in either L or D stereocenters, then the resulting product will retain at least a portion of, and, in some embodiments, the majority of, the original stereochemical enrichment. One of ordinary skill in the art will recognize that such partial racemization and/or rearrangement, when present, results in the formation of a mixed block.

In certain embodiments, the present invention provides a diblock copolymer of formula I-b:

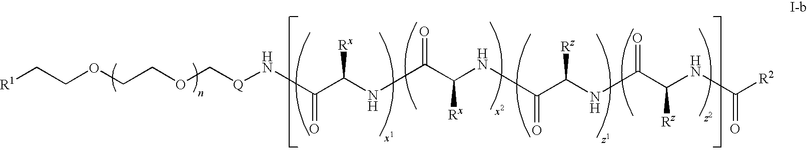

wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

Another aspect of the present invention provides a method for preparing a multi-block copolymer of formula I-b:

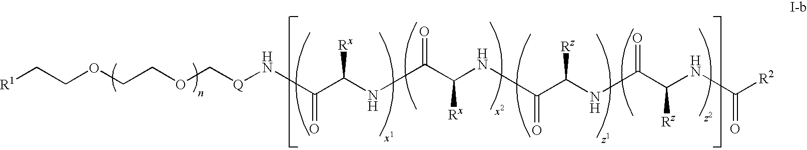

wherein each of R¹, R^{x}, R^{z}, R², Q, n, x¹, x², z¹, and z² is as defined above and described herein, said method comprising the steps of:
a) providing a compound of formula I:

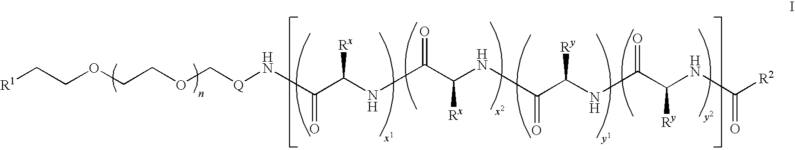

wherein each of R¹, R^{x}, R^{y}, R², Q, n, x¹, x², y¹, and y² is as defined above and described herein, and
b) reacting the compound of formula I with a suitable amine to form the compound of formula I-b.

In certain embodiments, the present invention provides a diblock copolymer of formula I-c:

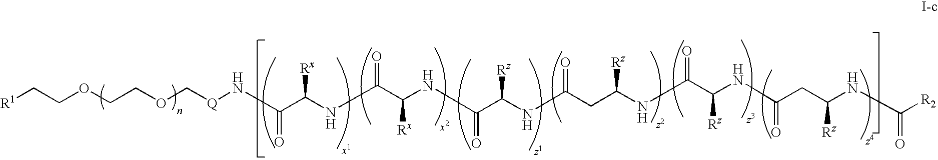

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
   each Y is independently —O— or —S—;
   p is 0-10;
   t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

It will be appreciated that the phrase “each R^{z} is independently -L-R⁴” is intended to encompass a mixed block that may result from the beta-amino acid rearrangement chemistry depicted in Scheme 1, above. In certain embodiments, a R^{z} group in a z² block is a homolog of a R^{z} group in a z¹ block.

In certain embodiments, the present invention provides a diblock copolymer of formula I-d:

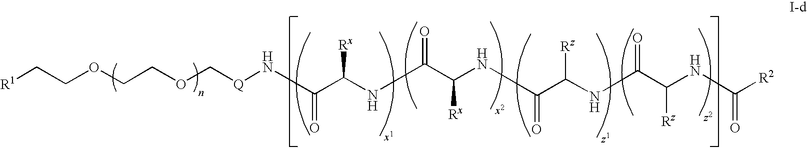

wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a diblock copolymer of formula I-e:

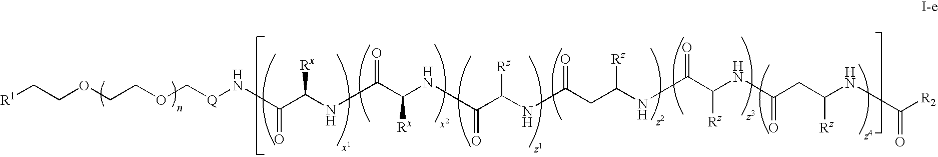

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
   each Y is independently —O— or —S—;
   p is 0-10;
   t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

As defined generally above, the n group of formulae I, I-a, I-b, I-c, I-d, or I-e is 50-2500. In some embodiments, n is about 110 to about 460. In certain embodiments, the present invention provides compounds of formulae I, I-a, I-b, I-c, I-d, or I-e, as described above, wherein n is about 270. In some embodiments, n is about 225. In some embodiments, n is about 350. In some embodiments, n is about 110. In some embodiments, n is about 454. In some embodiments, n is selected from 110±10, 180±10, 225±10, 275±10, 315±10, or 450±10.

In certain embodiments, the x¹ group of formulae I, I-a, I-b, I-c, I-d, or I-e is about 0 to about 250. In certain embodiments, the x¹ group of formulae I, I-a, I-b, I-c, I-d, or I-e is about 10. In some embodiments, x¹ is about 0 to about 50. In some embodiments, x¹ is about 20. In some embodiments, x¹ is about 30. In some embodiments, x¹ is about 40. In some embodiments, x¹ is selected from 10±5, 20±5, 30±5, 40±5, or 50±5.

In certain embodiments, the x² group of formulae I, I-a, I-b, I-c, I-d, or I-e is about 0 to about 250. In some embodiments, x² is about 0 to about 50. In certain embodiments, the x² group of formulae I, I-a, I-b, I-c, I-d, or I-e is 0. In some embodiments, x² is about 10. In some embodiments, x² is about 20. In some embodiments, x² is about 40. In some embodiments, x² is selected from 10±5, 20±5, 30±5, 40±5, or 50±5.

In certain embodiments, the y¹ group of formulae I or I-a is about 0 to about 250. In other embodiments, y¹ is about 100 to about 200. In certain embodiments, the y¹ group of formula I is 0. In some embodiments, y¹ is about 140. In some embodiments, y¹ is about 160. In some embodiments, y¹ is about 180. In some embodiments, y¹ is selected from 150±10, 160±10, 170±10, 180±10, or 190±10.

In certain embodiments, the y² group of formulae I or I-a is about 0 to about 250. In some embodiments, y² is about 100 to about 200. In certain embodiments, the y² group of formulae I or I-a is 0. In some embodiments, y² is about 140. In some embodiments, y² is about 160. In some embodiments, y² is about 180. In some embodiments, y² is selected from 150±10, 160±10, 170±10, 180±10, or 190±10.

In certain embodiments, the z¹ group of formulae I-b, I-c, I-d, or I-e is about 0 to about 250. In some embodiments, z¹ is about 100-200. In certain embodiments, the z¹ group of formulae I-b, I-c, I-d, or I-e is 0. In some embodiments, z¹ is about 140. In some embodiments, z¹ is about 160. In some embodiments, z¹ is about 180. In some embodiments, z¹ is selected from 150±10, 160±10, 170±10, 180±10, or 190±10.

In certain embodiments, the z² group of formulae I-b, I-c, I-d, or I-e is about 0 to about 250. In some embodiments, z² is about 100-200. In certain embodiments, the z² group of formulae I-b, I-c, I-d, or I-e is 0. In some embodiments, z² is about 140. In some embodiments, z² is about 160. In some embodiments, z² is about 180. In some embodiments, z² is selected from 150±10, 160±10, 170±10, 180±10, or 190±10.

In certain embodiments, the sum of x¹ and x² is about 25 and the sum of z¹ and z² is about 25. In certain embodiments, the sum of x¹ and x² is about 50 and the sum of z¹ and z² is about 50. In certain embodiments, the sum of x¹ and x² is about 100 and the sum of z¹ and z² is about 100.

In certain embodiments, the z³ group of formulae I-c or I-e is about 0 to about 250. In some embodiments, z³ is about 100-200. In certain embodiments, the z³ group of formulae I-c or I-e is 0. In some embodiments, z³ is about 140. In some embodiments, z³ is about 160. In some embodiments, z³ is about 180. In some embodiments, z³ is selected from 150±10, 160±10, 170±10, 180±10, or 190±10.

In certain embodiments, the z⁴ group of formulae I-c or I-e is about 0 to about 250. In some embodiments, z⁴ is about 100-200. In certain embodiments, the z⁴ group of formulae I-c or I-e is 0. In some embodiments, z⁴ is about 140. In some embodiments, z⁴ is about 160. In some embodiments, z⁴ is about 180. In some embodiments, z⁴ is selected from 150±10, 160±10, 170±10, 180±10, or 190±10.

In some embodiments, the R¹ group of formulae I, I-a, I-b, I-c, I-d, or I-e is —N₃, which is suitable for Click chemistry and therefore useful for conjugating said compound to biological systems or macromolecules such as proteins, viruses, and cells, to name but a few. The Click reaction is known to proceed quickly and selectively under physiological conditions. In contrast, most conjugation reactions are carried out using the primary amine functionality on proteins (e.g. lysine or protein end-group). Because most proteins contain a multitude of lysines and arginines, such conjugation occurs uncontrollably and/or non-specifically at multiple sites on the protein. This is particularly problematic when lysines or arginines are located around the active site of an enzyme or other biomolecule. Thus, in some embodiments the present invention provides a method of conjugating the azide end group of a compound of formula formulae I, I-a, I-b, I-c, I-d, or I-e to a macromolecule via Click chemistry. In certain embodiments, the present invention provides a macromolecule conjugated to a compound of formula I via the R¹ azide group.

In certain embodiments, Z is a bivalent triazolyl moiety. In some embodiments, Z is a valence bond.

In some embodiments, p is 0. In some embodiments, p is 1-10.

In some embodiments, t is 0. In some embodiments, t is 1-10.

In some embodiments, R³ is —N₃.

In some embodiments, the R³ group of formulae I, I-a, I-b, I-c, I-d, or I-e is a targeting group. Targeting groups are well known in the art and include those described in International application publication number WO 2008/134731, published Nov. 6, 2008, the entirety of which is hereby incorporated by reference. In some embodiments, a T targeting group is a moiety selected from folate, a Her-2 binding peptide, a urokinase-type plasminogen activator receptor (uPAR) antagonist, a CXCR4 chemokine receptor antagonist, a GRP78 peptide antagonist, an RGD peptide, an RGD cyclic peptide, a luteinizing hormone-releasing hormone (LHRH) antagonist peptide, an aminopeptidase targeting peptide, a brain homing peptide, a kidney homing peptide, a heart homing peptide, a gut homing peptide, an integrin homing peptide, an angiogencid tumor endothelium homing peptide, an ovary homing peptide, a uterus homing peptide, a sperm homing peptide, a microglia homing peptide, a synovium homing peptide, a urothelium homing peptide, a prostate homing peptide, a lung homing peptide, a skin homing peptide, a retina homing peptide, a pancreas homing peptide, a liver homing peptide, a lymph node homing peptide, an adrenal gland homing peptide, a thyroid homing peptide, a bladder homing peptide, a breast homing peptide, a neuroblastoma homing peptide, a lymphona homing peptide, a muscle homing peptide, a wound vasculature homing peptide, an adipose tissue homing peptide, a virus binding peptide, or a fusogenic peptide. In certain embodiments, a targeting group is a peptide moiety. In some embodiments, a targeting group is a moiety selected from a tumor homing group, a prostate specific membrane antigen homing peptide, an aminopeptidate N homing peptide, a Her-2 homing peptide, a colong cancer homing peptide, a VEGFR1 homing peptide, or a CXCR4 homing peptide. In certain embodiments, a targeting group is an oliogopeptide.

As defined generally above, the Q group of formulae I, I-a, I-b, I-c, I-d, or I-e is a valence bond or a bivalent, saturated or unsaturated, straight or branched C₁₋₁₂ hydrocarbon chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur. In certain embodiments, Q is a valence bond. In other embodiments, Q is a bivalent, saturated C₁₋₁₂ alkylene chain, wherein 0-6 methylene units of Q are independently replaced by -Cy-, —O—, —NH—, —S—, —OC(O)—, —C(O)O—, or —C(O)—, wherein -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur. In some embodiments, Q is —CH₂—.

In certain embodiments, the Q group of formulae I, I-a, I-b, I-c, I-d, or I-e is -Cy- (i.e. a C₁ alkylene chain wherein the methylene unit is replaced by -Cy-), wherein -Cy- is an optionally substituted 5-8 membered bivalent, saturated, partially unsaturated, or aryl ring having 0-4 heteroatoms independently selected from nitrogen, oxygen, or sulfur. According to one aspect of the present invention, -Cy- is an optionally substituted bivalent aryl group. In some embodiments, -Cy- is an optionally substituted bivalent phenyl group. In some embodiments, -Cy- is an optionally substituted 5-8 membered bivalent, saturated carbocyclic ring. In some embodiments, -Cy- is an optionally substituted 5-8 membered bivalent, saturated heterocyclic ring having 1-2 heteroatoms independently selected from nitrogen, oxygen, or sulfur. Exemplary -Cy- groups include optionally substituted bivalent rings selected from phenyl, pyridyl, pyrimidinyl, cyclohexyl, cyclopentyl, or cyclopropyl.

As defined above, the R^{x} group of formulae I, I-a, I-b, I-c, I-d, or I-e is a natural or unnatural hydrophobic amino acid side-chain group. In certain embodiments, hydrophobic amino acid side-chain groups correspond to that of glycine, alanine, valine, leucine, isoleucine, norleucine, phenylalanine, methionine, norvaline, or proline. In certain embodiments, R^{x} is an amino acid side-chain group corresponding to that of leucine. In certain embodiments, R^{x} is an amino acid side-chain group corresponding to that of norleucine. In certain embodiments, R^{x} is an amino acid side-chain group corresponding to that of phenylalanine

As defined above, the R^{y} group of formulae I or I-a is a natural or unnatural amino acid side-chain group that contains an ester capable of undergoing aminolysis. In certain embodiments, ester containing amino acid side-chain groups corresponds to that of benzyl aspartate, benzyl glutamate, t-butyl aspartate, t-butyl glutamate, methyl aspartate, methyl glutamate, alkyl aspartate or alkyl glutamate. In some embodiments, the ester containing amino acid side-chain group corresponds to that of benzyl aspartate. In some embodiments, the ester containing amino acid side-chain group corresponds to that of benzyl glutamate.

As defined generally above, the R^{z} group of formulae I-b, I-c, I-d, or I-e contains an amide and one or more primary, secondary, tertiary amines, aryl amine or imidazole derivative or mixture thereof. In certain embodiments, the R^{z} group is selected from a group found in Table 1.

TABLE 1
Representative R^{z} groups

i

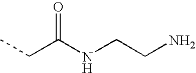

ii

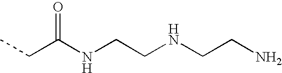

iiI

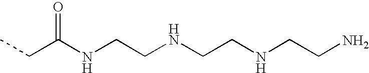

iv

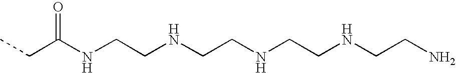

v

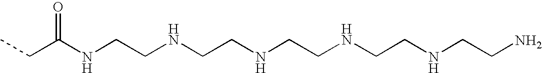

vi

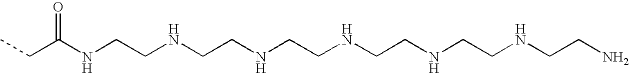

vii

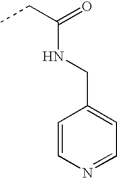

viii

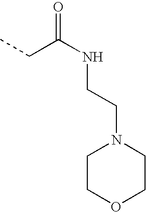

ix

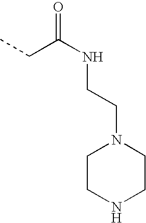

x

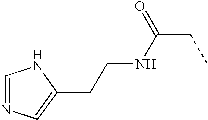

xi

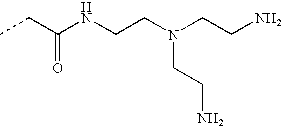

xii

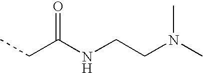

xiii

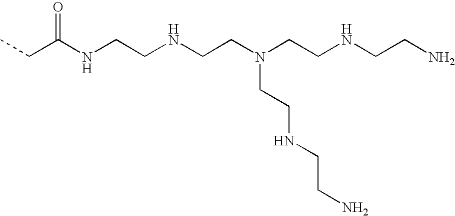

xiv

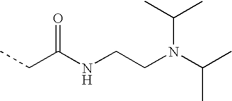

xv

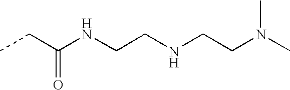

xvi

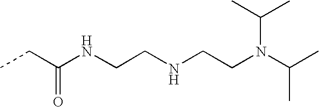

xvii

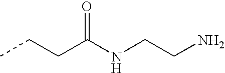

xviii

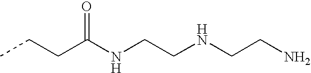

xix

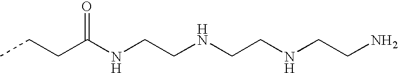

xx

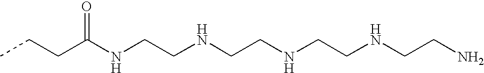

xxi

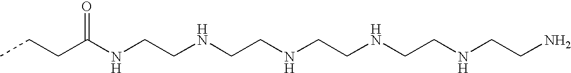

xxii

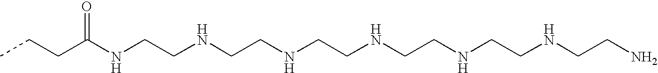

xxiii

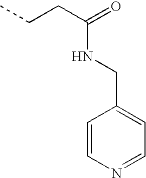

xxiv

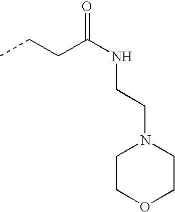

xxv

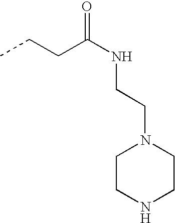

xxvi

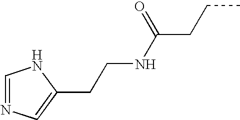

xxvii

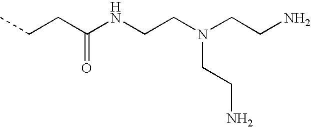

xxviii

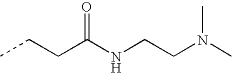

xxix

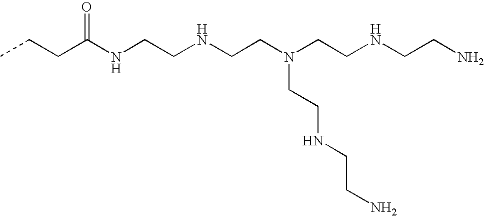

xxx

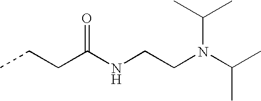

xxxi

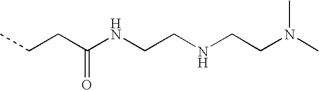

xxxii

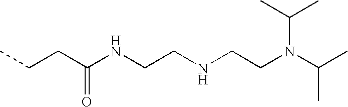

In some embodiments, the R² group of formulae I, I-b, I-c, I-d, or I-e is optionally substituted aliphatic. In some embodiments, R² is C₁₋₄ optionally substituted aliphatic. In certain embodiments, R² is methyl.

In some embodiments, the present invention provides a composition comprising a compound of formula I-b and at least one compound selected from a compound of formula I-c, I-d, and/or I-e.

In certain embodiments, the present invention provides a triblock copolymer of formula II:

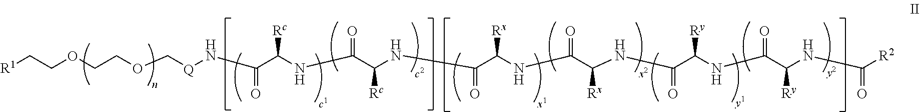

wherein:
n is 50-2500;
c¹ is 0 to 100;
C² is 0 to 100, provided that c¹ and c² are not simultaneously zero;
x¹ is 0 to 250;
x² is 0 to 250;
y¹ is 0 to 250, provided that x¹ and y¹ are not simultaneously zero;
y² is 0 to 250, provided that y¹ and y² are not simultaneously zero;
R^{c} is a natural or unnatural amino acid side-chain group that is capable of crosslinking;
R^{x} is a natural or unnatural amino acid side-chain group that is hydrophobic;
R^{y} is a natural or unnatural amino acid side-chain group that contains an ester;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C_{1 12} alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula II-a:

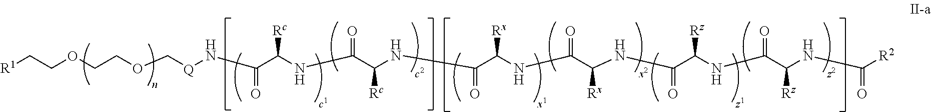

wherein:
n is 50-2500;
c¹ is 0 to 100;
c² is 0 to 100, provided that c¹ and c² are not simultaneously zero;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{c} is a natural or unnatural amino acid side-chain group that is capable of crosslinking;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

Another aspect of the present invention provides a method for preparing a multi-block copolymer of formula II-a:

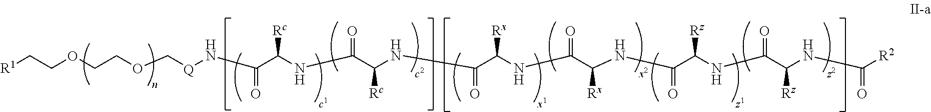

wherein each of R¹, R^{c}, R^{x}, R^{z}, R², Q, n, c¹, c², x¹, x², z¹, and z² is as defined above and described herein, said method comprising the steps of:
a) providing a compound of formula II:

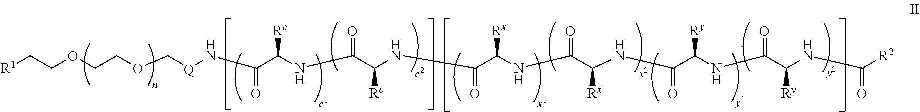

wherein each of R¹, R^{c}, R^{x}, R^{y}, R², Q, n, c¹, c², x¹, x², y¹, and y² is as defined above and described herein, and
b) reacting the compound of formula II with a suitable amine to form the compound of formula II-a.

In certain embodiments, the present invention provides a triblock copolymer of formula II-b:

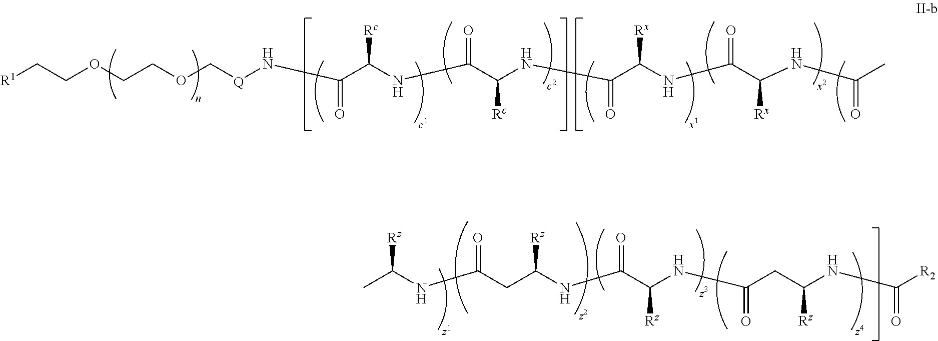

wherein:
n is 50-2500;
c¹ is 0 to 100;
c² is 0 to 100, provided that c¹ and c² are not simultaneously zero;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{c} is a natural or unnatural amino acid side-chain group that is capable of crosslinking;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula II-c:

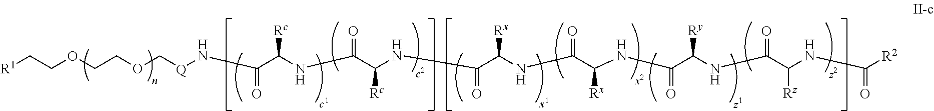

wherein:
n is 50-2500;
c¹ is 0 to 100;
C² is 0 to 100, provided that c¹ and c² are not simultaneously zero;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{c} is a natural or unnatural amino acid side-chain group that is capable of crosslinking;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula II-d:

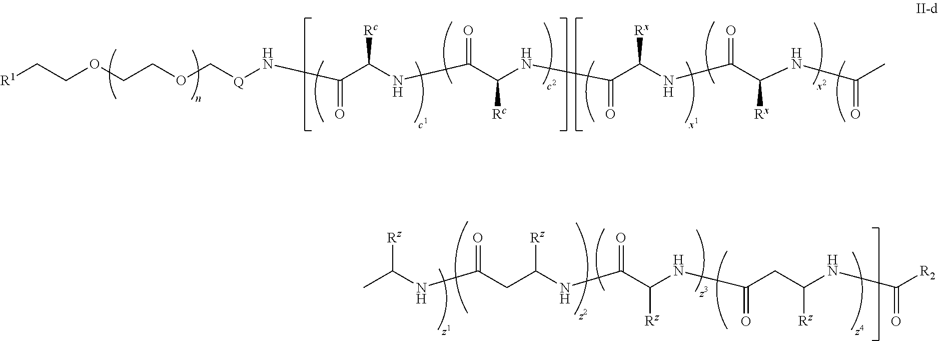

wherein:
n is 50-2500;
c¹ is 0 to 100;
c² is 0 to 100, provided that c¹ and c² are not simultaneously zero;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{c} is a natural or unnatural amino acid side-chain group that is capable of crosslinking;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In some embodiments, each of the R¹, R², Q, R^{x}, R^{y}, R^{z}, n, x¹, x², y¹, y², z¹, z², z³ and z⁴ groups of formulae II, II-a, II-b, II-c, or II-d are independently as described with respect to formula I, above.

In certain embodiments, the R^{c} group of formula II is a crosslinkable amino acid side-chain group. In certain embodiments, such crosslinkable amino acid side-chain groups correspond to that of tyrosine, serine, cysteine, threonine, aspartic acid (also known as aspartate, when charged), glutamic acid (also known as glutamate, when charged), asparagine, histidine, lysine, arginine, glutamine, or a benzimidazole-functionalized amino acid. In some embodiments, R^{c} is a benzamidazole derivative or an amino acid side-chain group corresponding to that of glutamic acid, aspartic acid, or histidine.

As defined above, the R^{c} group of formula II is a natural or unnatural amino acid side-chain group capable of forming cross-links. It will be appreciated that a variety of amino acid side-chain functional groups are capable of such cross-linking, including, but not limited to, carboxylate, thiol, amine, and imidazole groups. Examples of R^{c} moieties having functional groups capable of forming cross-links include a glutamic acid side-chain, —CH₂C(O)OH, an aspartic acid side-chain, —CH₂CH₂C(O)OH, a cysteine side-chain, a lysine, an ornithine, or a histidine side-chain, —CH₂-imidazol-4-yl. In some embodiments, R^{c} is a glutamic acid side chain. In other embodiments, R^{c} is an aspartic acid side chain. In still other embodiments, R^{c} is a histidine side-chain. In yet other embodiments, R^{c} is a benzamidazole derivative.

In some embodiments, the present invention provides a composition comprising a compound of formula II-a and at least one compound selected from a compound of formula II-b, II-c, II-d, and/or II-e.

In certain embodiments, the present invention provides a multiblock copolymer of formula III:

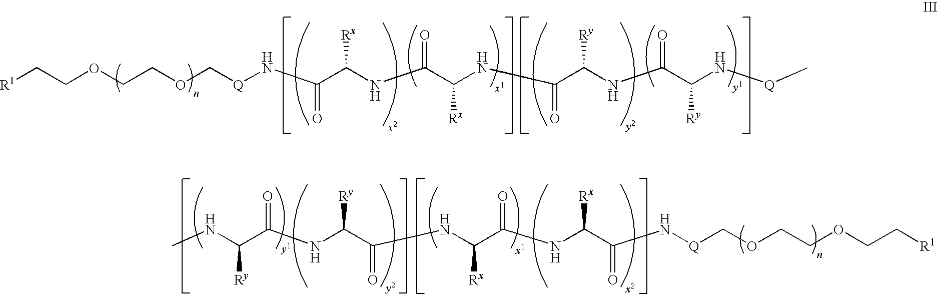

wherein:
n is 50-2500;
x¹ is 0 to 250;
x² is 0 to 250;
y¹ is 0 to 250, provided that x¹ and y¹ are not simultaneously zero;
y² is 0 to 250, provided that y¹ and y² are not simultaneously zero;
R^{x} is a natural or unnatural amino acid side-chain group that is hydrophobic;
R^{y} is a natural or unnatural amino acid side-chain group that contains an ester;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group; and
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

In certain embodiments, the present invention provides a triblock copolymer of formula III-a:

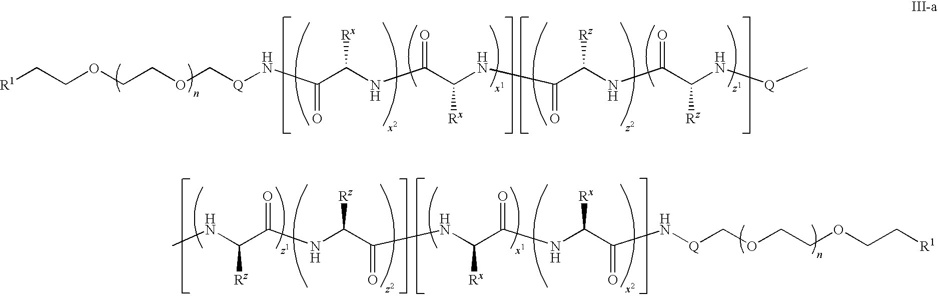

wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group; and
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

In some embodiments, each Q is independently a C₁₋₁₂ alkylene chain, wherein 0-2 methylene units of Q are independently replaced by -Cy-, —O—, —C(O)—, or —NH—. In certain embodiments, -Cy- is an optionally substituted triazolyl.

Another aspect of the present invention provides a method for preparing a multi-block copolymer of formula III-a:

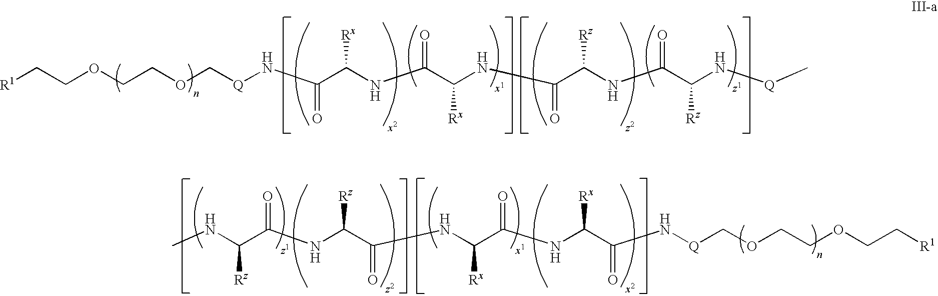

wherein each of R¹, R^{x}, R^{z}, R², Q, n, x¹, x², z¹, and z² is as defined above and described herein, said method comprising the steps of:
a) providing a compound of formula III:

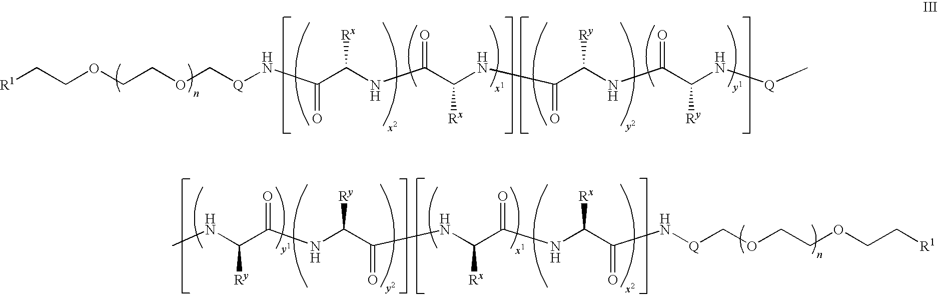

wherein each of R¹, R^{c}, R^{x}, R^{y}, R², Q, n, c¹, c², x¹, x², y¹, and y² is as defined above and described herein, and
b) reacting the compound of formula III with a suitable amine to form the compound of formula III-a.

In certain embodiments, the present invention provides a triblock copolymer of formula III-b:

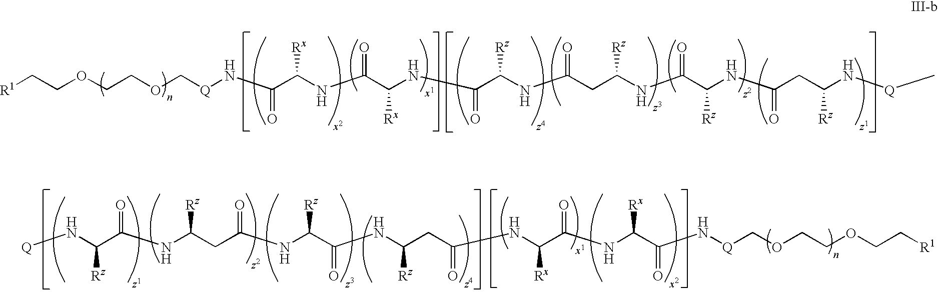

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group; and
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

In certain embodiments, the present invention provides a triblock copolymer of formula III-c:

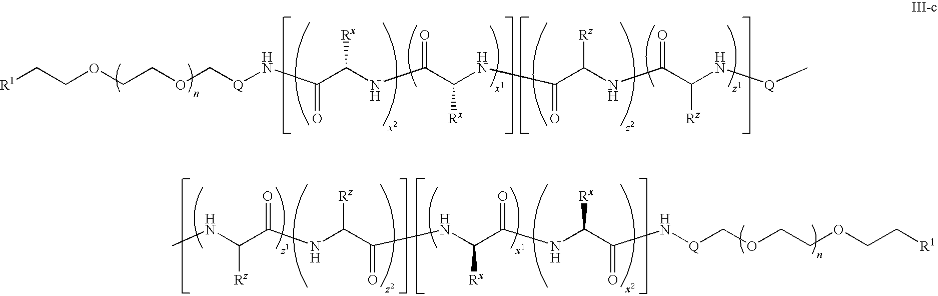

wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group; and
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

In certain embodiments, the present invention provides a triblock copolymer of formula III-d:

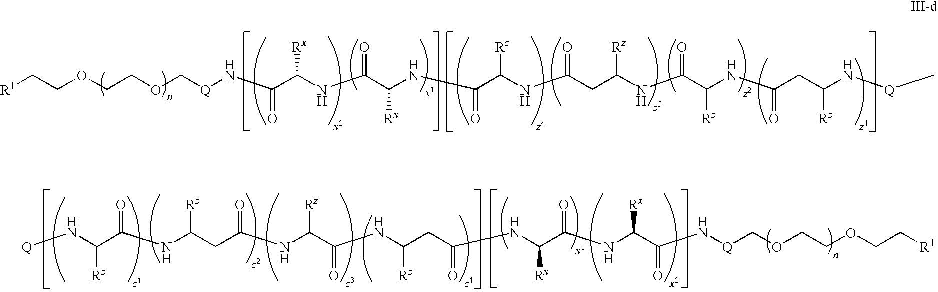

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group; and
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

In some embodiments, each of the R¹, R², Q, R^{x}, R^{y}, R^{z}, n, x¹, x², y¹, y², z¹, z², z³ and z⁴ groups of formulae III, III-a, III-b, III-c, or III-d are independently as described with respect to formula I, above.

In certain embodiments, the present invention provides a composition comprising a compound of formula III-a and at least one of a compound of formula III-b, III-c, or III-d.

In certain embodiments, the present invention provides a multiblock copolymer of formula IV:

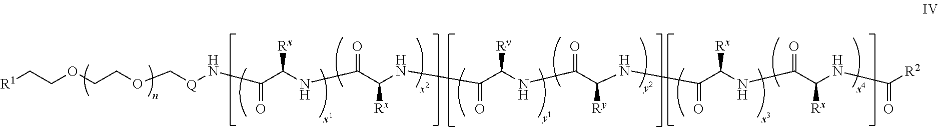

wherein:
n is 50-2500;
x¹ is 0 to 250;
x² is 0 to 250;
y¹ is 0 to 250, provided that x¹ and y¹ are not simultaneously zero;
y² is 0 to 250, provided that y¹ and y² are not simultaneously zero;
x³ is 0 to 250;
x⁴ is 0 to 250, provided that x³ and x⁴ are not simultaneously zero;
R^{x} is a natural or unnatural amino acid side-chain group that is hydrophobic;
R^{y} is a natural or unnatural amino acid side-chain group that contains an ester;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula IV-a:

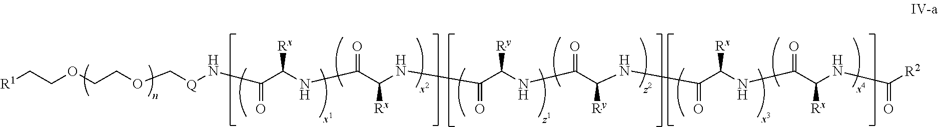

wherein:
n is 50-2500;
x¹ is 0 to 250;
x² is 0 to 250;
z¹ is 0 to 250, provided that x¹ and y¹ are not simultaneously zero;
z² is 0 to 250, provided that y¹ and y² are not simultaneously zero;
x³ is 0 to 250;
x⁴ is 0 to 250, provided that x³ and x⁴ are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In some embodiments for compounds of formulae IV and IV-a, the sum of x¹ and x² is about 25, the sum of z¹ and z² is about 25, and the sum of x³ and x⁴ is about 25. In some embodiments, the sum of x¹ and x² is about 50, the sum of z¹ and z² is about 50, and the sum of x³ and x⁴ is about 50. In some embodiments, the sum of x¹ and x² is about 100, the sum of z¹ and z² is about 100, and the sum of x³ and x⁴ is about 100.

Another aspect of the present invention provides a method for preparing a multi-block copolymer of formula IV-a:

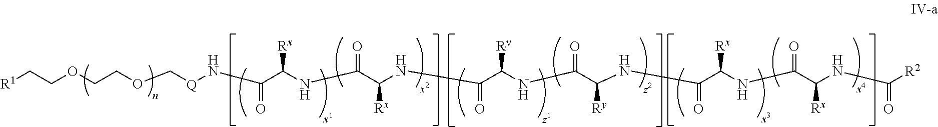

wherein each of R¹, R^{x}, R^{z}, R², Q, n, x¹, x², x³, x⁴, z¹, and z² is as defined above and described herein, said method comprising the steps of:
a) providing a compound of formula IV:

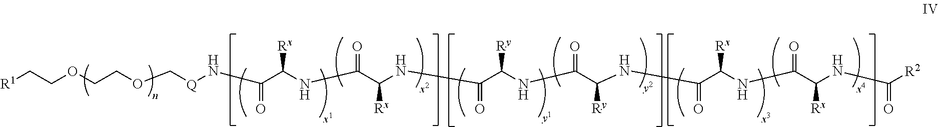

wherein each of R¹, R^{x}, R^{z}, R², Q, n, x¹, x², x³, x⁴, z¹, and z² is as defined above and described herein, and
b) reacting the compound of formula IV with a suitable amine found to form the compound of formula IV-a.

In certain embodiments, the present invention provides a triblock copolymer of formula IV-b:

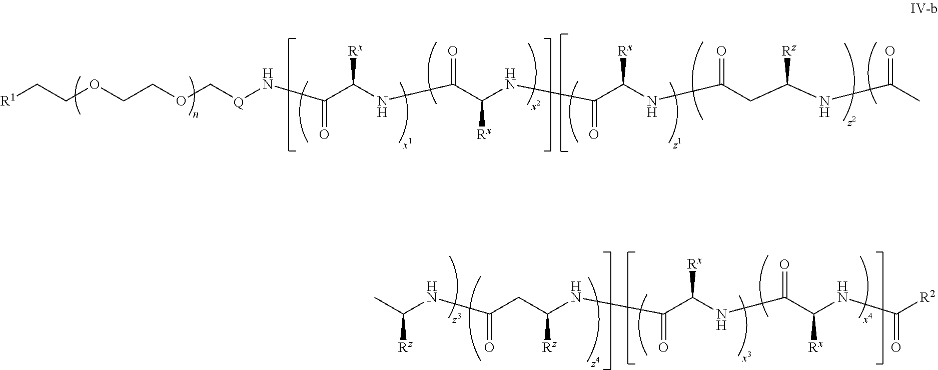

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
x³ is 0 to 250;
x⁴ is 0 to 250, provided that x³ and x⁴ are not simultaneously zero;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula IV-c:

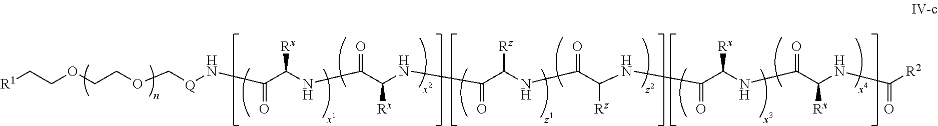

wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
x³ is 0 to 250;
x⁴ is 0 to 250, provided that x³ and x⁴ are not simultaneously zero;
R^{x} is a natural or unnatural amino acid side-chain group that is hydrophobic;
R^{z} is -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In certain embodiments, the present invention provides a triblock copolymer of formula IV-d:

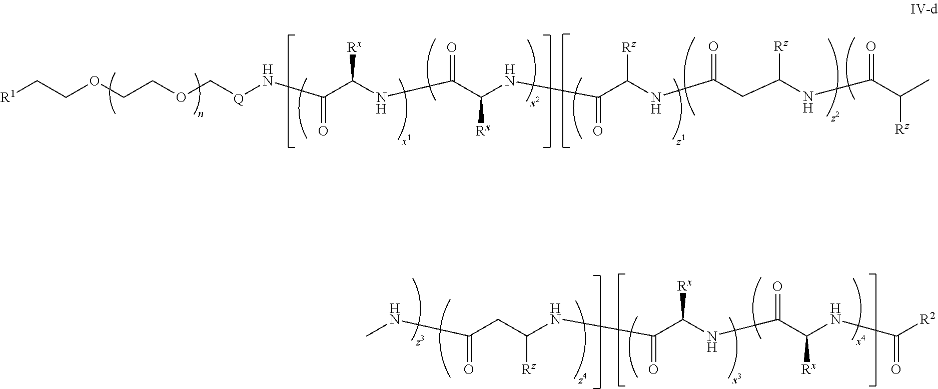

wherein:
n is 50-2500;
x¹ is 0 to 250;
x² is 0 to 250;
z¹ is 0 to 250;
z² is 0 to 250;
z³ is 0 to 250, provided that z¹ and z³ are not simultaneously zero;
z⁴ is 0 to 250;
x³ is 0 to 250;
x⁴ is 0 to 250, provided that x³ and x⁴ are not simultaneously zero;
R^{x} is a natural or unnatural amino acid side-chain group that is hydrophobic;
each R^{z} is independently -L-R⁴ wherein:
   L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
   Het is a bivalent 5-6 membered saturated, partially unsaturated, or aromatic ring having at least one nitrogen and 0-3 additional heteroatoms independently selected from nitrogen, oxygen, or sulfur;
   R⁴ is R or N(R)₂;
   each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
   Z is a valence bond, a bivalent triazolyl moiety, —O—, —S—, —C≡C—, or —CH₂—;
   each Y is independently —O— or —S—;
   p is 0-10;
   t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
   -Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

In some embodiments, each of the R¹, R², Q, R^{x}, R^{y}, R^{z}, n, x¹, x², y¹, y², z¹, z², z³ and z⁴ groups of formulae IV, IV-a, IV-b, IV-c, or IV-d are independently as described with respect to formula I, above.

In certain embodiments, the x³ group of formulae IV, IV-a, IV-b, IV-c, or IV-d is about 0 to about 250. In certain embodiments, the x³ group of formulae IV, IV-a, IV-b, IV-c, or IV-d is about 10. In some embodiments x³ is about 0 to about 50. In some embodiments, x³ is about 20. In some embodiments, x³ is about 30. In some embodiments, x³ is about 40. In some embodiments, x³ is selected from 10±5, 20±5, 30±5, 40±5, or 50±5.

In certain embodiments, the x⁴ group of formulae IV, IV-a, IV-b, IV-c, or IV-d is about 0 to about 250. In certain embodiments, the x⁴ group of formulae IV, IV-a, IV-b, IV-c, or IV-d is about 10. In some embodiments x⁴ is about 0 to about 50. In some embodiments, x⁴ is about 20. In some embodiments, x⁴ is about 30. In some embodiments, x⁴ is about 40. In some embodiments, x⁴ is selected from 10±5, 20±5, 30±5, 40±5, or 50±5.

In some embodiments, the present invention provides a composition comprising a compound of formula IV-a and at least one of a compound of formula IV-a, IV-b, IV-c, or IV-d.

In certain embodiments, the present invention provides a diblock copolymer of compound a:

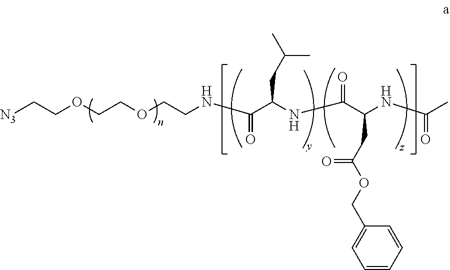

wherein:
n is 50-2500;
y is 5 to 250; and
z is 5 to 250.

As defined generally above, the n group of compound a is 50-2500. In some embodiments, n is about 110 to about 460. In certain embodiments, the present invention provides compounds of compound a as described above, wherein n is about 270. In some embodiments, n is about 225. In some embodiments, n is about 350. In some embodiments, n is about 110. In some embodiments, n is about 454. In some embodiments, n is selected from 110±10, 180±10, 225±10, 275±10, 315±10, or 450±10.

In certain embodiments, the y group of compound a is about 5 to about 250. In certain embodiments, the y group of compound a is about 10. In some embodiments y is about 5-50. In some embodiments y is about 0-50. In other embodiments, y is about 20. In some embodiments, y is about 30. In some embodiments, y is about 40. In some embodiments, y is selected from 10±5, 20±5, 30±5, 40±5, or 50±5.

In certain embodiments, the z group of compound a is about 5 to about 250. In other embodiments, z is about 100-200. In some embodiments, z is about 140. In some embodiments, z is about 160. In some embodiments, z is about 180. In some embodiments, z is selected from 150±10, 160±10, 170±10, 180±10, or 190±10.

In some embodiments, y is about 25 and z is about 25. In some embodiments, y is about 50 and z is about 50. In some embodiments, y is about 100 and z is about 100.

In certain embodiments, the present invention provides a diblock copolymer of compound b:

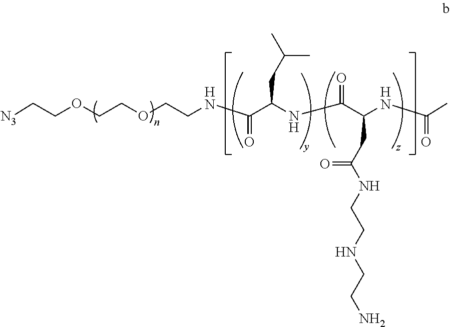

wherein:
n is 50-2500;
y is 5 to 250; and
z is 5 to 250.

As defined generally above, the n group of compound b is 50-2500. In some embodiments, n is about 110 to about 460. In certain embodiments, the present invention provides compounds of compound b as described above, wherein n is about 270. In some embodiments, n is about 225. In some embodiments, n is about 350. In some embodiments, n is about 110. In some embodiments, n is about 454. In some embodiments, n is selected from 110±10, 180±10, 225±10, 275±10, 315±10, or 450±10.

In certain embodiments, the y group of compound b is about 5 to about 250. In certain embodiments, the y group of compound b is about 10. In some embodiments, y is about 5-50. In some embodiments, y is about 0-50. In some embodiments, y is about 20. In some embodiments, y is about 30. In some embodiments, y is about 40. In some embodiments, y is selected from 10±5, 20±5, 30±5, 40±5, or 50±5.

In certain embodiments, the z group of compound b is about 5 to about 250. In some embodiments, z is about 100-200. In other embodiments, z is about 140. According to yet another embodiment, z is about 160. In other embodiments, z is about 180. In other embodiments, z is selected from 150±10, 160±10, 170±10, 180±10, or 190±10.

In some embodiments, y is about 25 and z is about 25. In some embodiments, y is about 50 and z is about 50. In some embodiments, y is about 100 and z is about 100.

In certain embodiments, the present invention provides a diblock copolymer of compound c:

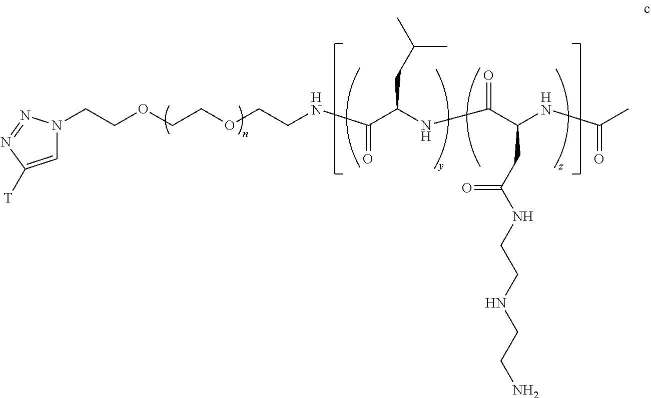

wherein:
n is 50-2500;
y is 5 to 250;
z is 5 to 250; and
T is a targeting group moiety.

As defined generally above, the n group of compound c is 50-2500. In some embodiments, n is about 110 to about 460. In certain embodiments, the present invention provides compounds of compound c as described above, wherein n is about 270. In some embodiments, n is about 225. In some embodiments, n is about 350. In some embodiments, n is about 110. In some embodiments, n is about 454. In some embodiments, n is selected from 110±10, 180±10, 225±10, 275±10, 315±10, or 450±10.

In certain embodiments, the y group of compound c is about 5 to about 250. In certain embodiments, the y group of compound c is about 10. In some embodiments, y is about 5-50. In some embodiments, y is about 0-50. In some embodiments, y is about 20. In some embodiments, y is about 30. In some embodiments, y is about 40. In some embodiments, y is selected from 10±5, 20±5, 30±5, 40±5, or 50±5.

In certain embodiments, the z group of compound c is about 5 to about 250. In other embodiments, z is about 100-200. In other embodiments, z is about 140. According to yet another embodiment, z is about 160. In other embodiments, z is about 180. In other embodiments, z is selected from 150±10, 160±10, 170±10, 180±10, or 190±10.

In some embodiments, y is about 25 and z is about 25. In some embodiments, y is about 50 and z is about 50. In some embodiments, y is about 100 and z is about 100.

As defined generally above, the T group of compound c is a targeting group moiety. Targeting groups are well known in the art and include those described in International application publication number WO 2008/134731, published Nov. 6, 2008, the entirety of which is hereby incorporated by reference. In some embodiments, the T targeting group is a moiety selected from folate, a Her-2 binding peptide, a urokinase-type plasminogen activator receptor (uPAR) antagonist, a CXCR4 chemokine receptor antagonist, a GRP78 peptide antagonist, an RGD peptide, an RGD cyclic peptide, a luteinizing hormone-releasing hormone (LHRH) antagonist peptide, an aminopeptidase targeting peptide, a brain homing peptide, a kidney homing peptide, a heart homing peptide, a gut homing peptide, an integrin homing peptide, an angiogencid tumor endothelium homing peptide, an ovary homing peptide, a uterus homing peptide, a sperm homing peptide, a microglia homing peptide, a synovium homing peptide, a urothelium homing peptide, a prostate homing peptide, a lung homing peptide, a skin homing peptide, a retina homing peptide, a pancreas homing peptide, a liver homing peptide, a lymph node homing peptide, an adrenal gland homing peptide, a thyroid homing peptide, a bladder homing peptide, a breast homing peptide, a neuroblastoma homing peptide, a lymphona homing peptide, a muscle homing peptide, a wound vasculature homing peptide, an adipose tissue homing peptide, a virus binding peptide, or a fusogenic peptide. Such targeting groups are well known in the art and are described in detail in WO 2008/134731.

In certain embodiments, a T targeting group is a peptide moiety. In some embodiments, a T targeting group is a moiety selected from a tumor homing group, a prostate specific membrane antigen homing peptide, an aminopeptidate N homing peptide, a Her-2 homing peptide, a colong cancer homing peptide, a VEGFR1 homing peptide, or a CXCR4 homing peptide.

In certain embodiments, the present invention provides a diblock copolymer of compound d:

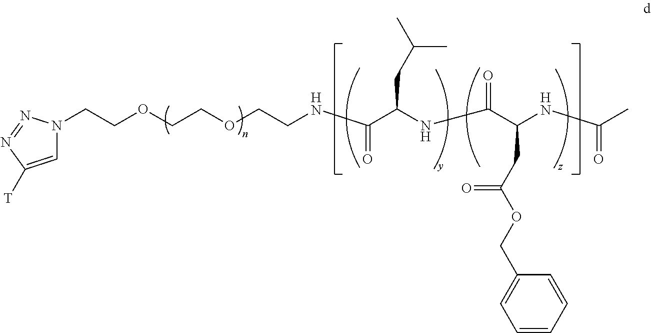

wherein:
n is 50-2500;
y is 5 to 250;
z is 5 to 250; and
T is a targeting group moiety.

As defined generally above, the n group of compound d is 50-2500. In some embodiments, n is about 110 to about 460. In certain embodiments, the present invention provides compounds of compound d as described above, wherein n is about 270. In some embodiments, n is about 225. In some embodiments, n is about 350. In some embodiments, n is about 110. In some embodiments, n is about 454. In some embodiments, n is selected from 110±10, 180±10, 225±10, 275±10, 315±10, or 450±10.

In certain embodiments, the y group of compound d is about 5 to about 250. In certain embodiments, the y group of compound d is about 10. In some embodiments, y is about 5-50. In some embodiments, y is about 0-50. In some embodiments, y is about 20. In some embodiments, y is about 30. In some embodiments, y is about 40. In some embodiments, y is selected from 10±5, 20±5, 30±5, 40±5, or 50±5.

In certain embodiments, the z group of compound d is about 5 to about 250. In some embodiments, z is about 100-200. In some embodiments, z is about 140. In some embodiments, z is about 160. In some embodiments, z is about 180. In some embodiments, z is selected from 150±10, 160±10, 170±10, 180±10, or 190±10.

In some embodiments, y is about 25 and z is about 25. In some embodiments, y is about 50 and z is about 50. In some embodiments, y is about 100 and z is about 100.

As defined generally above, the T group of compound d is a targeting group moiety. Targeting groups are well known in the art and include those described in International application publication number WO 2008/134731, published Nov. 6, 2008, the entirety of which is hereby incorporated by reference. In some embodiments, the T targeting group is a moiety selected from folate, a Her-2 binding peptide, a urokinase-type plasminogen activator receptor (uPAR) antagonist, a CXCR4 chemokine receptor antagonist, a GRP78 peptide antagonist, an RGD peptide, an RGD cyclic peptide, a luteinizing hormone-releasing hormone (LHRH) antagonist peptide, an aminopeptidase targeting peptide, a brain homing peptide, a kidney homing peptide, a heart homing peptide, a gut homing peptide, an integrin homing peptide, an angiogencid tumor endothelium homing peptide, an ovary homing peptide, a uterus homing peptide, a sperm homing peptide, a microglia homing peptide, a synovium homing peptide, a urothelium homing peptide, a prostate homing peptide, a lung homing peptide, a skin homing peptide, a retina homing peptide, a pancreas homing peptide, a liver homing peptide, a lymph node homing peptide, an adrenal gland homing peptide, a thyroid homing peptide, a bladder homing peptide, a breast homing peptide, a neuroblastoma homing peptide, a lymphona homing peptide, a muscle homing peptide, a wound vasculature homing peptide, an adipose tissue homing peptide, a virus binding peptide, or a fusogenic peptide. Such targeting groups are well known in the art and are described in detail in WO 2008/134731.

In some embodiments, the T targeting group is a moiety selected from a tumor homing group, a prostate specific membrane antigen homing peptide, an aminopeptidate N homing peptide, a Her-2 homing peptide, a colong cancer homing peptide, a VEGFR1 homing peptide, or a CXCR4 homing peptide.

Another embodiment of the present invention provides a method for preparing compound c:

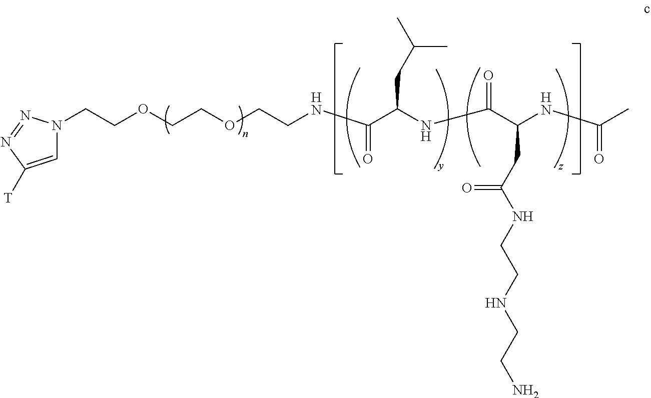

wherein:
n is 50-2500;
y is 5 to 250;
z is 5 to 250; and
T is a targeting group moiety,
   wherein said method comprises the steps of:
a) providing compound a:

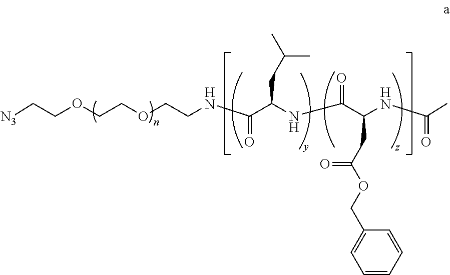

wherein:
n is 50-2500;
y is 5 to 250; and
z is 5 to 250,
b) performing a “click” reaction on compound a to provide compound d:

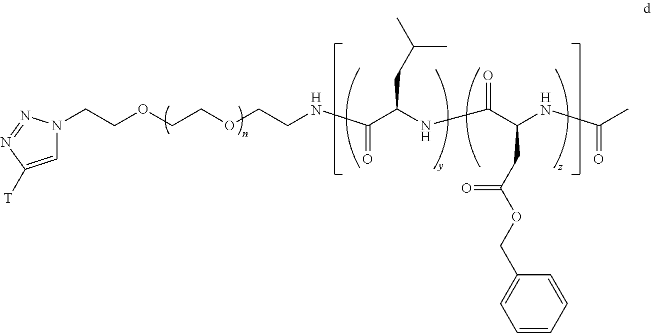

wherein:
n is 50-2500;
y is 5 to 250;
z is 5 to 250; and
T is a targeting group moiety, and
c) performing an aminolysis reaction with diethylene triamine and compound d.

Yet another embodiment of the present invention provides a method for preparing compound c:

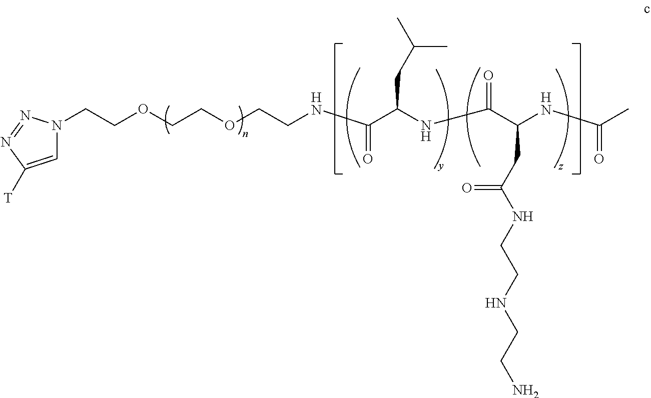

wherein:
n is 50-2500;
y is 5 to 250;
z is 5 to 250; and
T is a targeting group moiety;
wherein said method comprises the steps of:
a) providing compound a:

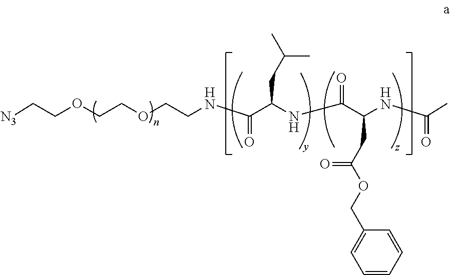

wherein:
n is 50-2500;
y is 5 to 250; and
z is 5 to 250,
b) performing an aminolysis reaction with diethylene triamine and compound a to give compound b

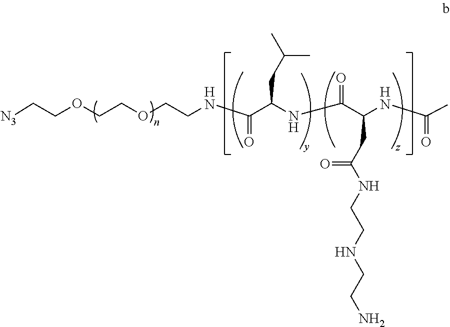

wherein:
n is 50-2500;
y is 5 to 250; and
z is 5 to 250
and c) performing a “click” reaction on compound b.

### Crosslinking Chemistries

In addition to advances in polymer micelle technology, significant efforts have been made in the development of stimuli-responsive polymeric materials that can respond to environmental pH changes. See Chatterjee, J.; Haik, Y.; Chen, C. J. J. App. Polym. Sci. 2004, 91, 3337-3341; Du, J. Z.; Armes, S. P. J. Am. Chem. Soc. 2005, 127, 12800-12801; and Twaites, B. R.; de las Heras Alarcon, C.; Cunliffe, D.; Lavigne, M.; Pennadam, S.; Smith, J. R.; Gorecki, D. C.; Alexander, C. J. Control. Release 2004, 97, 551-566. This is of importance for sensitive protein and nucleic acid-based drugs where escape from acidic intracellular compartments (i.e. endosome and lysosome) and cytoplasmic release are required to achieve therapeutic value. See Murthy, N.; Campbell, J.; Fausto, N.; Hoffman, A. S.; Stayton, P. S. J. Control. Release 2003, 89, 365-374; El-Sayed, M. E. H.; Hoffman, A. S.; Stayton, P. S. J. Control. Release 2005, 104, 417-427; and Liu, Y.; Wenning, L.; Lynch, M.; Reineke, T. J. Am. Chem. Soc. 2004, 126, 7422-7423. Acid-sensitive delivery systems that can successfully escape the endosome and transport small-molecule chemotherapeutic drugs into the cytoplasm are also of interest since these carriers can bypass many of the cellular mechanisms responsible for multi-drug resistance. In some of these cases, the polymers are designed to respond to the significant pH gradient between the blood (pH 7.4) and the late-early endosome (pH˜5.0-6.0).

In contrast to shell-crosslinked micelles, the crosslinking of multiblock copolymer micelles in accordance with the present invention is accomplished without large dilution volumes because micelle-micelle coupling does not occur. Such crosslinking will enhance post-administration circulation time leading to more efficient passive drug targeting by the EPR effect and improved active targeting using cancer-specific targeting groups. In addition, stimuli-responsive crosslinking may offer another targeting mechanism to isolate the release of the chemotherapy drug exclusively within the tumor tissue and cancer cell cytoplasm.

Crosslinking reactions designed for drug delivery preferably meet a certain set of requirements to be deemed safe and useful for in vivo applications. For example, in some embodiments, the crosslinking reaction would utilize non-cytotoxic reagents, would be insensitive to water, would not alter the drug to be delivered, and in the case of cancer therapy, would be reversible at pH levels commonly encountered in tumor tissue (pH˜6.8) or acidic organelles in cancer cells (pH˜5.0-6.0).

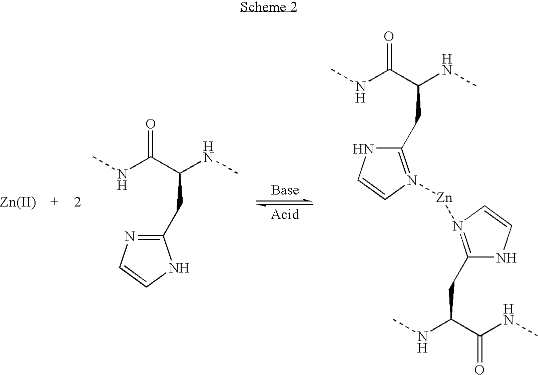

Scheme 2 above illustrates the reaction of an aqueous zinc (II) ion (e.g. from zinc chloride or zinc acetate) with two equivalents of an appropriate imidazole (e.g. histidine) to form a zinc-histidine complex. This reaction occurs rapidly in a slightly basic pH environment and is reversible upon acidification to pH less than 6. (Tezcan, et. al. J. Am. Chem. Soc. 2007, 129, 13347-13375.)

In certain embodiments, R^{c} is a histidine side-chain crosslinked with zinc. Without wishing to be bound by any particular theory, it is believed that zinc-histidine crosslinks are stable in the blood compartment (pH 7.4), allowing for effective accumulation of therapeutic loaded micelles in solid tumors by passive and/or active targeting mechanisms. In the presence of lactic acid concentrations commonly encountered in solid tumors or hydrochloric acid in acidic organelles of cancer cells, rapid degradation of the metal crosslinks occurs which leads to micelle dissociation and release of the polynucleotide at the tumor site.

The choice of zinc as a crosslinking metal is advantageous for effective micelle crosslinking Zinc chloride and the zinc lactate by-product are generally recognized as non-toxic, and other safety concerns are not anticipated. Pharmaceutical grade zinc chloride is commonly used in mouthwash and as a chlorophyll stabilizer in vegetables while zinc lactate is used as an additive in toothpaste and drug preparation. While zinc has been chosen as an exemplary metal for micelle crosslinking, it should be noted that many other metals undergo acid sensitive coupling with imidazole derivatives. These metals include calcium, iron, copper, nickel and other transition metals. One or more of these metals can be substituted for zinc.

The ultimate goal of metal-mediated crosslinking is to ensure micelle stability when diluted in the blood (pH 7.4) followed by rapid dissolution and polynucleotide release in response to a finite pH change such as those found in tumor environments or in intracellular compartments. Previous reports suggest that the zinc-histidine bonds are stable above a threshold pH, below which dissociation to zinc ions and histidine occurs. (Tezcan, et. al. J. Am. Chem. Soc. 2007, 129, 13347-13375.)

Polynucleotide Encapsulation

As described above, the present invention provides a polynucleotide-loaded micelle comprising multiblock copolymers which comprise a polymeric hydrophilic block and a mixed random copolymer block consisting of hydrophobic and amine-containing amino acid residues; characterized in that said micelle has a polynucleotide-loaded inner core and a hydrophilic shell. In some embodiments, the multiblock copolymers of the provided polynucleotide-loaded micelles further comprise a crosslinked or crosslinkable block.

As described herein, micelles of the present invention can be loaded with any polynucleotide agent. In some embodiments, a encapsulated polynucleotide is a plasmid DNA (pDNA). As used herein, pDNA is defined as a circular, double-stranded DNA that contains a DNA sequence (cDNA or complementary DNA) that is to be expressed in cells either in culture or in vivo. The size of pDNA can range from 3 kilo base pairs (kb) to greater than 50 kb. The cDNA that is contained within plasmid DNA is usually between 1-5 kb in length, but can be greater if larger genes are incorporated. pDNA may also incorporate other sequences that allow it to be properly and efficiently expressed in mammalian cells, as well as replicated in bacterial cells. In some embodiments, an encapsulated pDNA expresses a therapeutic gene in cell culture, animals, or humans that possess a defective or missing gene that is responsible for disease.

In some embodiments, a polynucleotide that is encapsulated is capable of silencing gene expression via RNA interference (RNAi). As defined herein, RNAi is a cellular mechanism that suppresses gene expression during translation and/or hinders the transcription of genes through destruction of messenger RNA (mRNA). Without wishing to be bound by any particular theory, it is believed that endogenous double-stranded RNA located in the cell are processed into 20-25 nt short-interfering RNA (siRNA) by the enzyme Dicer. siRNA subsequently binds to the RISC complex (RNA-induced silencing nuclease complex), and the guide strand of the siRNA anneals to the target mRNA. The nuclease activity of the RISC complex then cleaves the mRNA, which is subsequently degraded (Nat. Rev. Mol. Cell Biol., 2007, 8, 23).

In some embodiments, an encapsulated polynucleotide is a siRNA. As used herein, siRNA is defined as a linear, double-stranded RNA that is 20-25 nucleotides (nt) in length and possesses a 2 nt, 3′ overhang on each end which can induce gene knockdown in cell culture or in vivo via RNAi. In some embodiments of the invention, an encapsulated siRNA suppresses disease-relevant gene expression in cell culture, animals, or humans.

In some embodiments, an encapsulated polynucleotide is pDNA that expresses a short-hairpin RNA (shRNA). As used herein, shRNA is a linear, double-stranded RNA, possessing a tight hairpin turn, which is synthesized in cells through transfection and expression of a exogenous pDNA. Without wishing to be bound by any particular theory, it is believed that the shRNA hairpin structure is cleaved to produce siRNA, which mediates gene silencing via RNA interference. In some embodiments of the invention, an encapsulated shRNA suppresses gene expression in cell culture, animals, or humans that are responsible for a disease via RNAi.

In some embodiments, an encapsulated polynucleotide is a microRNA (miRNA). As used herein, miRNA is a linear, single-stranded RNA that ranges between 21-23 nt in length and regulates gene expression via RNAi (Cell, 2004, 116, 281). In some embodiments, an encapsulated miRNA suppresses gene expression in cell culture, animals, or humans that are responsible for a disease via RNAi.

In some embodiments, an encapsulated polynucleotide is a messenger RNA (mRNA). As used herein, mRNA is defined as a linear, single stranded RNA molecule, which is responsible for translation of genes (from DNA) into proteins. In some embodiments, an encapsulated mRNA is encoded from a plasmid cDNA to serve as the template for protein translation. In some embodiments, an encapsulated mRNA translates therapeutic proteins, in vitro and/or in vivo, which can treat disease.

In some embodiments of the invention, an encapsulated polynucleotide is an antisense RNA (aRNA). As used herein, aRNA is a linear, single-stranded RNA that is complementary to a targeted mRNA located in a cell. Without wishing to be bound by any particular theory, it is believed that aRNA inhibits translation of a complementary mRNA by pairing with it and obstructing the cellular translation machinery. It is believed that the mechanism of action for aRNA is different from RNAi because the paired mRNA is not destroyed. In some embodiments, an encapsulated aRNA suppresses gene expression in cell culture, animals, or humans that are responsible for a disease by binding mRNA and physically obstructing translation.

In order that the invention described herein may be more fully understood, the following examples are set forth. It will be understood that these examples are for illustrative purposes only and are not to be construed as limiting this invention in any manner.

### EXEMPLIFICATION

### Preparation of Bifunctional PEGs and Multiblock Copolymers of the Present Invention

As described generally above, multiblock copolymers of the present invention are prepared using the heterobifunctional PEGs described herein and in U.S. patent application Ser. No. 11/256,735, filed Oct. 24, 2005, published as WO2006/047419 on May 4, 2006 and published as US 20060142506 on Jun. 29, 2006, the entirety of which is hereby incorporated herein by reference. The preparation of multiblock polymers in accordance with the present invention is accomplished by methods known in the art, including those described in detail in U.S. patent application Ser. No. 11/325,020, filed Jan. 4, 2006, published as WO2006/74202 on Jul. 13, 2006 and published as US 20060172914 on Aug. 3, 2006, the entirety of which is hereby incorporated herein by reference.

In each of the Examples below, where an amino acid, or corresponding N-carboxy anhydride (NCA), is designated “D”, then that amino acid, or corresponding NCA, is of the D-configuration. Where no such designation is recited, then that amino acid, or corresponding NCA, is of the L-configuration.

### Example 1

### Synthesis of dibenzyl amino ethanol

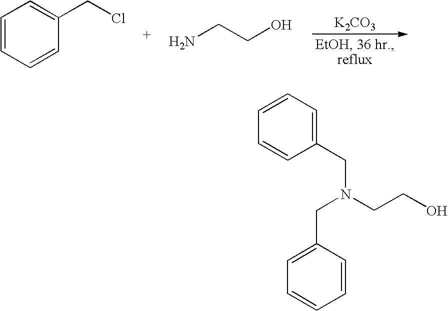

Benzyl chloride (278.5 g, 2.2 mol), ethanol amine (60 mL, 1 mol), potassium carbonate (283.1 g, 2.05 mol) and ethanol (2 L) were mixed together in a 3 L 3-neck flask, fitted with an overhead stirrer, a condenser and a glass plug. The whole setup was heated up to reflux for 36 hr, after which the insoluble solid was filtered through a medium frit. The filtrate was recovered and ethanol was removed by rotovapor. The viscous liquid was redissolved in ether, the solid suspension removed by filtration and extracted twice against water. The ether solution was kept and the aqueous layer was extracted twice with dichloromethane (2×400 mL). The fraction were recombined, dried over MgSO₄, stirred over carbon black for 15 min and filtered through a celite pad. Dichloromethane was removed and the solid was redissolved into a minimal amount of ether (combined volume of 300 mL with the first ether fraction, 300 mL). Hexanes (1700 mL) was added and the solution was heated up gently till complete dissolution of the product. The solution was then cooled down gently, placed in the fridge (+4° C.) overnight and white crystals were obtained. The recrystallization was done a second time. 166.63 g, 69% yield. ¹H NMR (d₆-DMSO) δ 7.39-7.24 (10H), 4.42 (1H), 3.60 (4H), 3.52 (2H), 2.52 (2H).

### Example 2

### Synthesis of (Dibenzyl)-N-EO270-OH

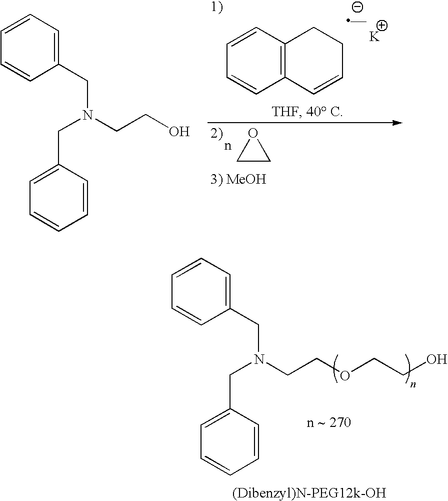

The glassware was assembled while still warm. Vacuum was then applied to the assembly and the ethylene oxide line to about 10 mTorr. The setup was backfilled with argon. 2-Dibenzylamino ethanol (3.741 g, 40.4 mmol) was introduced via the sidearm of the jacketed flask under argon overpressure. Two vacuum/argon backfill cycles were applied to the whole setup. THF line was connected to the 14/20 side-arm and vacuum was applied to the whole setup. At this stage, the addition funnel was closed and left under vacuum. THF (4 L) was introduced via the side-arm in the round bottom flask under an argon overpressure. An aliquot of the THF added to the reaction vessel was collected and analyzed by Karl-Fisher colorometric titration to ensure water content of the THF is less than 6 ppm. Next, 2-dibenzylamino ethanol was converted to potassium 2-dibenzylamino ethoxide via addition of potassium naphthalenide (200 mL). Ethylene oxide (500 ml, 10.44 mol) was condensed under vacuum at −30° C. into the jacketed addition funnel, while the alkoxide solution was cooled to 10 ° C. Once the appropriate amount of ethylene oxide was condensed, the flow of ethylene oxide was stopped, and the liquid ethylene oxide added directly to the cooled alkoxide solution. After complete ethylene oxide addition, the addition funnel was closed and the reaction flask backfilled with argon. While stirring, the following temperature ramp was applied to the reaction: 12 hrs at 20° C., 1 hr from 20° C. to 40° C. and 3 days at 40° C. The reaction went from a light green tint to a golden yellow color. Upon termination with an excess methanol, the solution color changed to light green. The solution was precipitated into ether and isolated by filtration. 459 g, 99% yield was recovered after drying in a vacuum oven overnight. ¹H NMR (d6-DMSO) δ 7.4-7.2 (10H), 4.55 (1H), 3.83-3.21 (910H) ppm.

### Example 3

### Synthesis of H₂N-EO270-OH

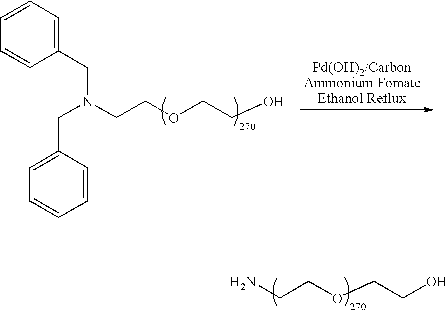

Batch Bz-EO270-OH-A (455 g, 39.56 mmol) was split into two equal amounts and was introduced into two 2 L flasks. Batch Bz-EO270-OH-B (273 g, 23.74 mmol) was put into a 2 L flask as well. The following steps were repeated for each flask. H₂N-EO270-OH (˜225 g), Pd(OH)₂/C (32 g, 45.6 mmol), ammonium formate (80 g, 1.27 mol) and ethanol (1.2 L) were mixed together in a 2 L flask. The reaction was heated to 80° C. while stirring for 24 hrs. The reaction was cooled to room temperature and filtered through a triple layer Celite/MgSO₄/Celite pad. The MgSO₄ powder is fine enough that very little Pd(OH)₂/C permeates through the pad. Celite helps prevent the MgSO₄ layer from cracking At this stage, the three filtrates were combined, precipitated into ˜30 L of ether and filtered through a medium glass frit. The wet polymer was then dissolved into 4 L of water, 1 L of brine and 400 mL of saturated K₂CO₃ solution. The pH was checked to be ˜11 by pH paper. The aqueous solution was introduced into a 12 L extraction funnel, rinsed once with 4 L of ether and extracted 4 times with dichloromethane (6 L, 6 L, 6 L, 2 L). Dichloromethane fractions were recombined, dried over MgSO₄ (3 kg), filtered, concentrated to ˜3 L by rotary evaporation and precipitated into diethyl ether (30 L). 555 g, 75% yield was recovered after filtration and evaporation to dryness in a vacuum oven. ¹H NMR (d6-DMSO) 4.55 (1H), 3.83-3.21 (910H), 2.96 (2H) ppm.

### Example 4

### Synthesis of H₂N-EO270-OH

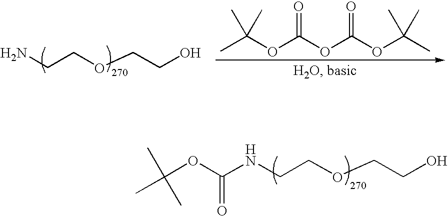

H₂N-EO270-OH (555 g, 48.26 mmol) was dissolved into 4 L of DI water. A saturated solution of K₂CO₃ (120 mL) was added, to keep the pH basic (pH ˜11 with pH paper). Di-tert-butyl dicarbonate (105 g, 0.48 mol) was added to the aqueous solution of H₂N-EO270-OH and allowed to stir at room temperature overnight. At this stage, a 5 mL aliquot of the reaction was extracted with 10 mL of dichloromethane and the dichloromethane extract precipitated into ether. A ¹H NMR was run to ensure completion of the reaction. Thereafter, the aqueous solution was placed into a 12 L extraction funnel, was rinced once with ether (4 L) and extracted three times with dichloromethane (6 L, 6 L and 6 L). The organic fractions were recombined, dried over MgSO₄ (3 kg), filtered, concentrated to ˜4 L and precipitated into 30 L of ether. The white powder was filtered and dried overnight in a vacuum oven, giving 539 g, 97% yield. ¹H NMR (d₆-DMSO) δ 6.75 (1H), 4.55 (1H), 3.83-3.21 (910H), 3.06 (2H), 1.37 (9H) ppm

### Example 5

### Reaction of Boc-HN-EO270-OH with methanesulfonyl chloride and sodium azide to obtain Boc-HN-EO270-N3

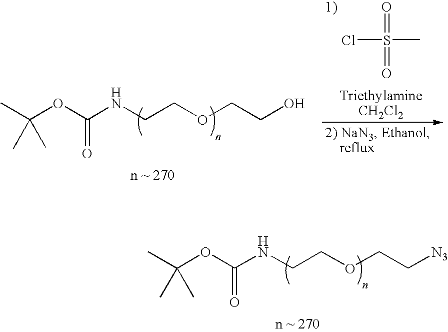

Boc-EO270-OH (539 g, 49.9 mmol) were placed into a 6 L jacketed flask and dried by azeotropic distillation from toluene (3 L). It was then dissolved into 3 L of dry dichloromethane under inert atmosphere. The solution was cooled to 0° C., methanesulfonyl chloride (10.9 mL, 140.8 mmol) was added followed by triethylamine (13.1 mL, 94 mmol). The reaction was allowed to warm to room temperature and proceeded overnight under inert atmosphere. The solution was evaporated to dryness by rotary evaporation and used as-is for the next step.

NaN₃ (30.5 g, 470 mmol) and 3 L of ethanol were added to the flask containing the polymer. The solution was heated to 80° C. and allowed to react overnight. It was then evaporated to dryness by rotary evaporation (bath temperature of 55° C.) and dissolved in 2 L of dichloromethane. The latter solution was the filtered through a Buchner funnel fitted with a Whatman paper #1 to remove most of the salts. The solution was concentrated down to ˜1 L by rotary evaporation. The product was purified by silica gel flash column chromatography using a 8 in. diameter column with a coarse frit. About 7 L of dry silica gel were used. The column was packed with 1:99 MeOH/CH₂Cl₂ and the product was loaded and eluted onto the column by pulling vacuum from the bottom of the column. The elution profile was the following: 1:99 MeOH/CH₂Cl₂ for 1 column volume (CV), 3:97 MeOH/CH₂Cl₂ for 2 CV and 10:90 MeOH/CH₂Cl₂ for 6 CV. The different polymer-containing fractions were recombined (˜40 L of dichloromethane), concentrated by rotary evaporation and precipitated into a 10-fold excess of diethyl ether. The polymer was recovered by filtration as a white powder and dried overnight in vacuo, giving 446.4 g, 82% yield. ¹H NMR (d₆-DMSO) δ 6.75 (1H), 3.83-3.21 (910H), 3.06 (2H), 1.37 (9H) ppm. Mₙ (MALDI-TOF)=11,554 g/mol. PDI (DMF GPC)=1.04

### Example 6

### Synthesis of N₃-EO270-NH₃/DFA salt from N₃-EO270-NH-Boc

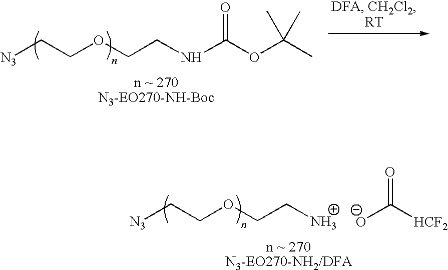

N₃-EO270-NH-Boc (313 g, 27.2 mmol) was weighed into a 2 L beaker, 600 mL of DFA, 600 mL of dichloromethane were added. The solution was stirred at room temperature for 32 hr and the polymer was recovered by two consecutive precipitation in ether (2×30 L). The white powder was dried overnight in a vacuum oven. (306 g, 98% yield). ¹H NMR (d₆-DMSO) δ 7.67 (3H), 6.13 (1H), 3.82-3.00 (1060H), 2.99 (2H).

### Example 7

### Synthesis of D-Leucine NCA

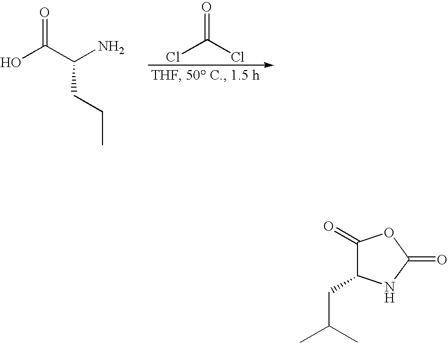

H-DLeu-OH (20.0 g, 152.5 mmol) was suspended in 300 mL of anhydrous THF and heated to 50° C. Phosgene (20% in toluene) (99.3 mL, 198.3 mmol) was added to the amino acid suspension. The amino acid dissolved over the course of approx. 1 hr, forming a clear solution. The solution was concentrated on the rotovap, transferred to a beaker, and hexane was added to precipitate the product. The white solid was isolated by filtration and dissolved in a toluene/THF mixture. The solution was filtered over a bed of Celite to remove any insoluble material. An excess of hexane was added to the filtrate to precipitate the product. The NCA was isolated by filtration and dried in vacuo. 13.8 g (58% yield) of DLeu NCA was isolated as a white, crystalline solid. ¹H NMR (d₆-DMSO) δ 9.13 (1H), 4.44 (1H), 1.74 (1H), 1.55 (2H), 0.90 (6H) ppm.

### Example 8

### Synthesis of Asp(O^{t}Bu)NCA

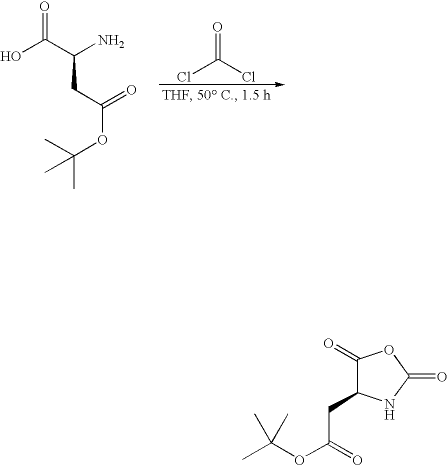

H-Asp(O^{t}Bu)-OH (25.0 g, 132 mmol) was suspended in 500 mL of anhydrous THF and heated to 50° C. Phosgene (20% in toluene) (100 mL, 200 mmol) was added to the amino acid suspension, and the amino acid dissolved over the course of approx. 1 hr, forming a clear solution. The solution was concentrated on by rotary evaporation, transferred to a beaker, and hexane was added to precipitate the product. The white solid was isolated by filtration and dissolved in anhydrous THF. The solution was filtered over a bed of Celite to remove any insoluble material. An excess of hexane was added on the top of the filtrate and the bilayer solution was left in the freezer overnight. The NCA was isolated by filtration and dried in vacuo. 13.1 g (46% yield) of Asp(O^{t}Bu)NCA was isolated as a white, crystalline solid. ¹H NMR (d₆-DMSO) δ 8.99 (1H), 4.61 (1H), 2.93 (1H), 2.69 (1H), 1.38 (9H) ppm.

### Example 9

### Synthesis of Asp(OBzl)NCA

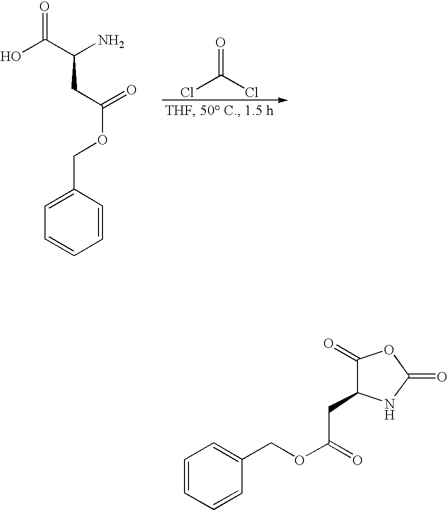

H-Asp(OBzl)-OH (14.0 g, 62.7 mmol) was suspended in 225 mL of anhydrous THF and heated to 50° C. Phosgene (20% in toluene) (40 mL, 80 mmol) was added the amino acid suspension. The amino acid dissolved to give a clear solution over the course of approx. 15 min and was left reacting for another 25 min. The solution was concentrated on the rotovap, the white solid redissolved in a toluene/THF mixture (100 mL/50 mL) and the clear solution rotovaped to dryness. The white solid obtained was redissolved into 100 mL of THF, transferred to a beaker, and dry hexanes were added to precipitate the product. The white solid was isolated by filtration and rinsed twice with dry hexanes (2×200 mL) The NCA was isolated by filtration and dried in vacuo. 14.3 g (65% yield) of Asp(OBzl) NCA was isolated as a white solid. ¹H NMR (d₆-DMSO) δ 9.00 (1H), 7.48-7.25 (5H), 5.13 (2H), 4.69 (1H), 3.09 (1H), 2.92 (1H) ppm

### Example 10

### Synthesis of D-Asp(OBzl)NCA

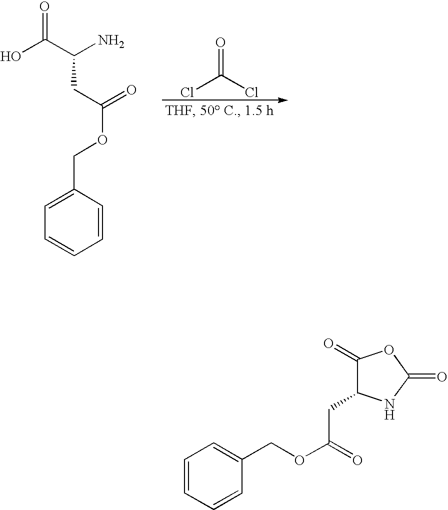

H-D-Asp(OBzl)-OH (30.0 g, 134 mmol) was suspended in 450 mL of anhydrous THF and heated to 50° C. Phosgene (20% in toluene) (100 mL, 100 mmol) was added the amino acid suspension. The amino acid dissolved over the course of approx. 50 min and was left reacting for another 30 min. The solution was concentrated on the rotovap, the white solid redissolved in a toluene/THF mixture (250 mL/50 mL) and the clear solution rotovaped to dryness. The white solid obtained was redissolved into 250 mL of THF, transferred to a beaker, and dry hexanes were added to precipitate the product. The white solid was isolated by filtration and rinsed twice with dry hexanes (2×400 mL) The NCA was isolated by filtration and dried in vacuo. 26.85 g (83.2% yield) of D-Asp(OBzl) NCA was isolated as a white solid. ¹H NMR (d₆-DMSO) δ 9.00 (1H), 7.48-7.25 (5H), 5.13 (2H), 4.69 (1H), 3.09 (1H), 2.92 (1H) ppm

### Example 11

### Synthesis of L-PheNCA

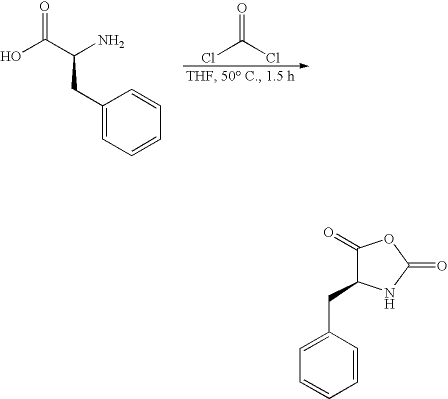

H-L-Phe-OH (20.0 g, 132 mmol) was suspended in 300 mL of anhydrous THF and heated to 50° C. Phosgene (20% in toluene) (90 mL, 182 mmol) was added to the amino acid suspension, and the amino acid dissolved over the course of approx. 1 hr, forming a cloudy solution. The solution was filtered through a paper filter (Whatman #1), concentrated on by rotary evaporation, transferred to a beaker, and hexane was added to precipitate the product. The white solid was isolated by filtration and dissolved in anhydrous THF. The solution was filtered over a bed of Celite to remove any insoluble material. An excess of hexanes were added on the filtrate while stirring with a spatula. The NCA was isolated by filtration and dried in vacuo. 20.0 g (86% yield) of D-PheNCA was isolated as a white, crystalline solid. ¹H NMR (d₆-DMSO) δ 9.09 (1H), 7.40-7.08 (5H), 4.788 (1H), 3.036 (2H) ppm.

### Example 12

### Synthesis of N₃-PEG12K-b-P(Asp(O^{t}Bu)₂₅-co-D-Leu₅₀-co-Orn(Z)₂₅)-Ac

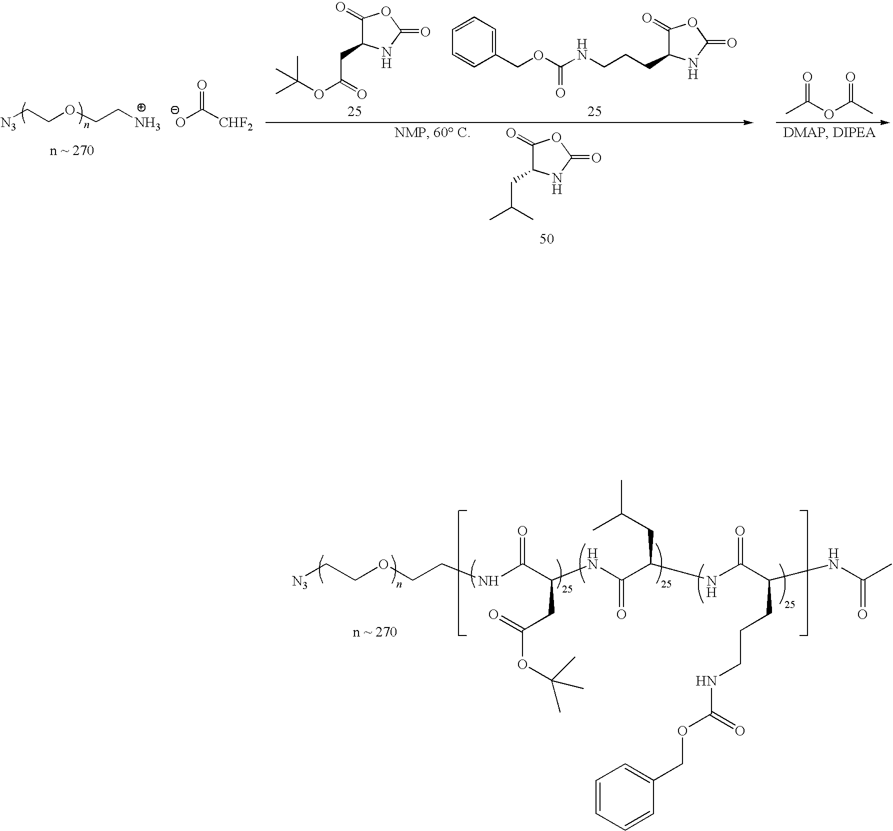

N₃-PEG12k-NH₂/DFA salt, (10.0 g, 0.83 mmol) was weighed into an oven-dried, round-bottom flask, dissolved in toluene, and dried by azeotropic distillation. Excess toluene was removed under vacuum. Asp(O^{t}Bu) NCA (2.15 g, 10 mmol), D-Leu NCA (6.55 g, 41.7 mmol) and Orn(Z) NCA (5.02 g, 17.2 mmol) was added to the flask, the flask was evacuated under reduced pressure, and subsequently backfilled with nitrogen gas. Dry N-methylpyrrolidone (NMP) (130 mL) was introduced by syringe and the solution was heated to 60° C. The reaction mixture was allowed to stir for 5 days at 60° C. under nitrogen gas. The solution was cooled to room temperature and DIPEA (2.0 mL), DMAP (100 mg), and acetic anhydride (2.0 mL) were added. Stirring was continued for 1 hour at room temperature. The polymer was precipitated into diethyl ether (cooled down to −20° C.) and isolated by filtration. The solid was redissolved in dichloromethane and precipitated into diethyl ether (cooled down to −20° C.). The product was isolated by filtration and dried in vacuo to give the block copolymer as an off-white powder. ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 13

### Synthesis of N₃-PEG5K-b-P(Asp(O^{t}Bu)₅₀-co-D-Leu₂₅-co-Orn(Z)₅₀)-Ac

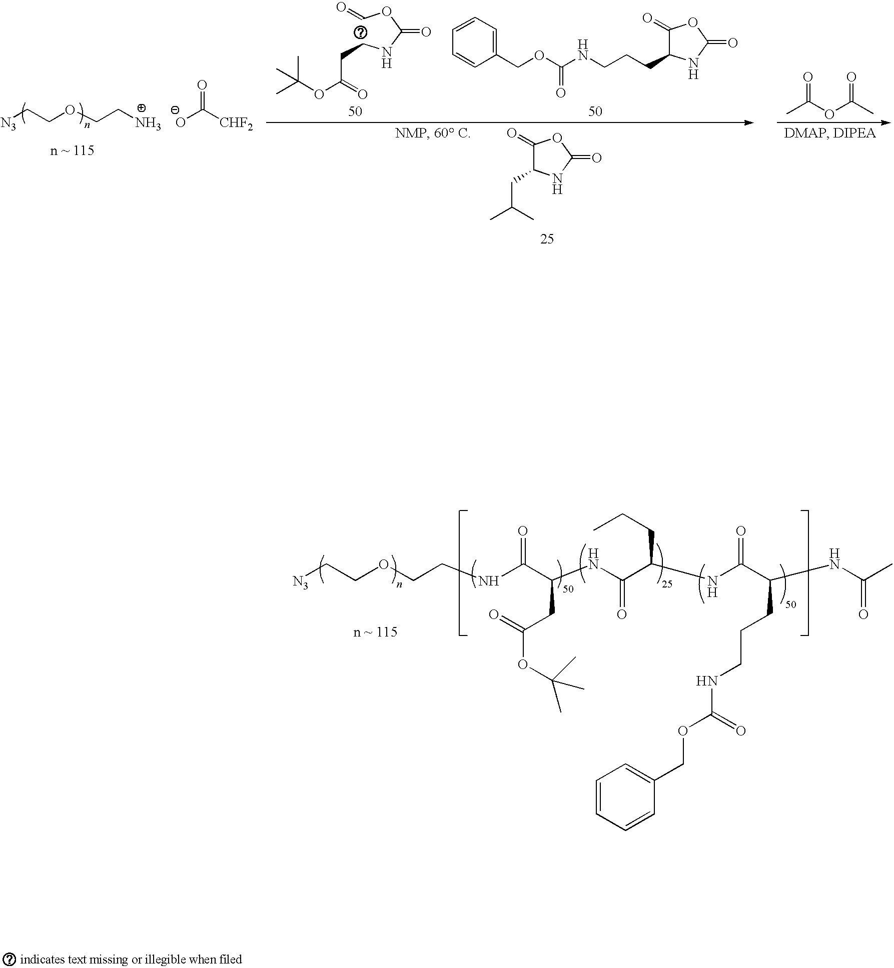

N₃-PEG5K-b-P(Asp(O^{t}Bu)₅₀-co-D-Leu₂₅-co-Orn(Z)₅₀)-Ac was synthesized as described in Example 12 from N₃-PEG-NH₂/DFA salt, 5 kDa (0.5 g, 0.1 mmol), Asp(O^{t}Bu) NCA (1.08 g, 5 mmol), D-Leu NCA (0.39 g, 2.5 mmol), Orn(Z) NCA (1.46 g, 5 mmol) and 23 mL of NMP. The block copolymer was isolated as an off-white powder (1.6 g, 56% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 14

### Synthesis of N₃-PEG5K-b-P(Asp(O^{t}Bu)₇₅-co-D-Leu₂₅-co-Orn(Z)₅₀)-Ac

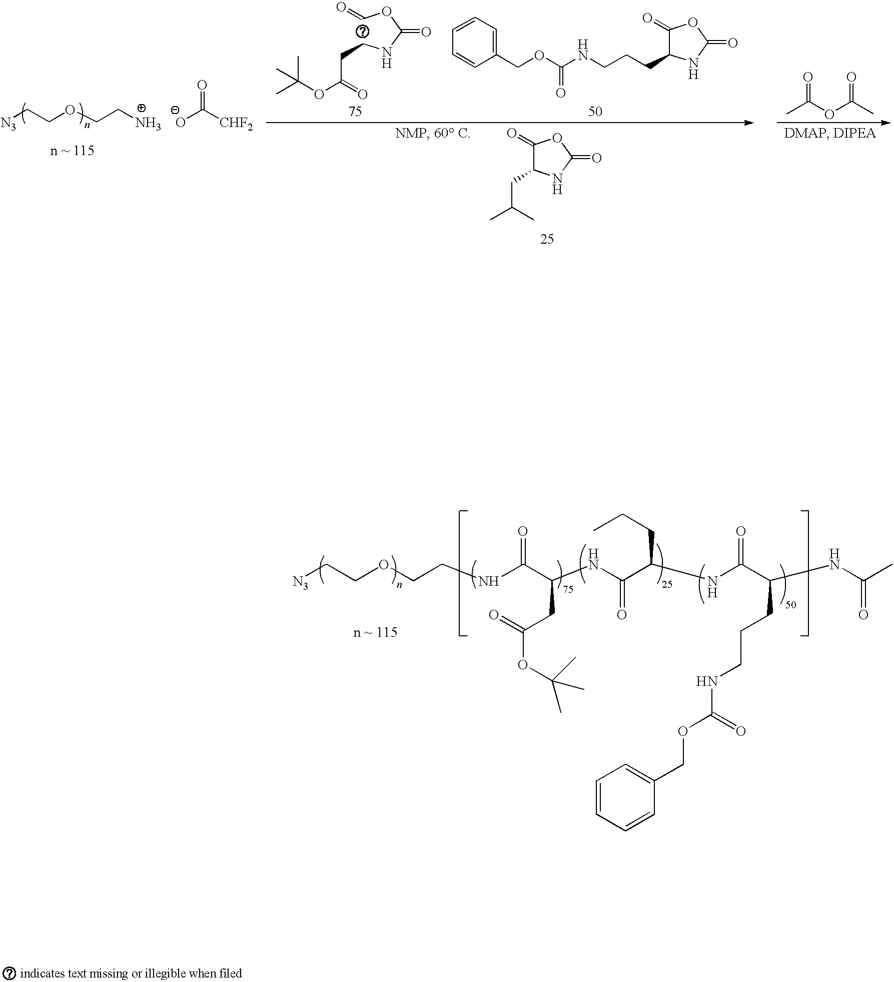

N₃-PEG5K-b-P(Asp(O^{t}Bu)₇₅-co-D-Leu₂₅-co-Orn(Z)₅₀)-Ac was synthesized as described in Example 12 from N₃-PEG-NH₂/DFA salt, 5 kDa (0.5 g, 0.1 mmol), Asp(O^{t}Bu) NCA (1.61 g, 7.5 mmol), D-Leu NCA (0.39 g, 2.5 mmol), Orn(Z) NCA (1.46 g, 5 mmol) and 26 mL of NMP. The block copolymer was isolated as an off-white powder (1.3 g, 39% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 15

### Synthesis of N₃-PEG5K-b-P(Asp(O^{t}Bu)₁₀₀-co-D-Leu₂₅-co-Orn(Z)₅₀)-Ac

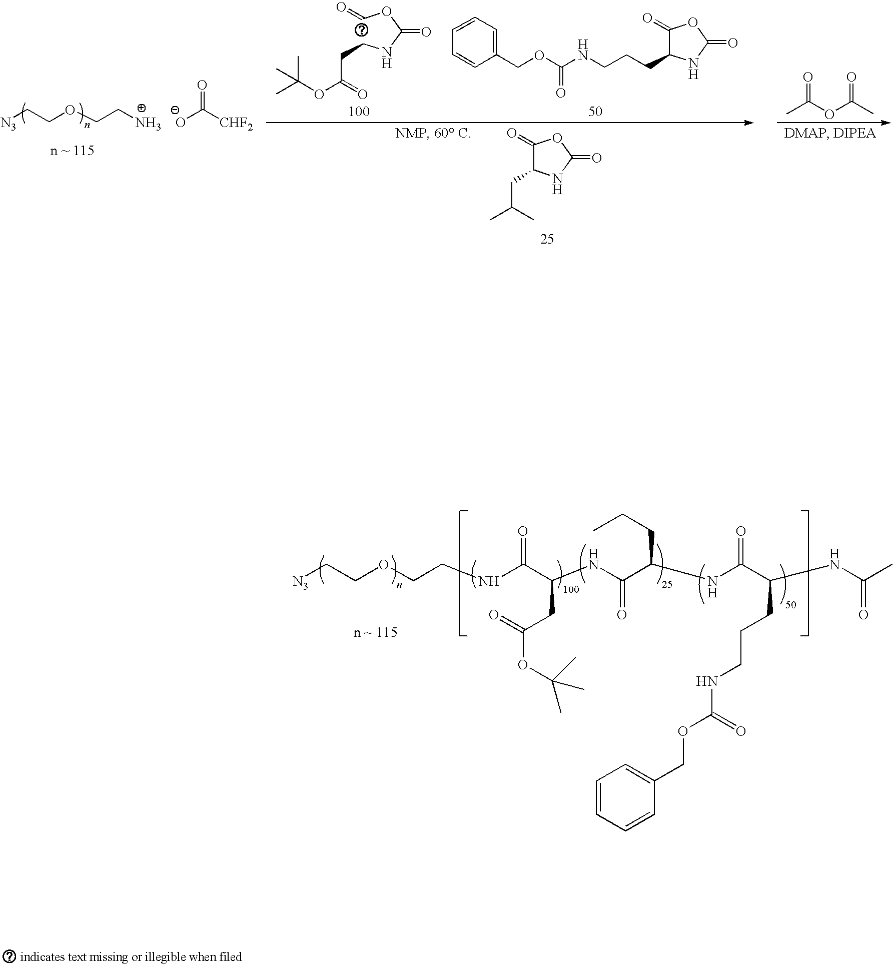

N₃-PEG5K-b-P(Asp(O^{t}Bu)100-co-D-Leu₂₅-co-Orn(Z)₅₀)-Ac was synthesized as described in Example 12 from N₃-PEG-NH₂/DFA salt, 5 kDa (0.5 g, 0.1 mmol), Asp(O^{t}Bu) NCA (2.15 g, 10 mmol), D-Leu NCA (0.39 g, 2.5 mmol), Orn(Z) NCA (1.46 g, 5 mmol) and 30 mL of NMP. The block copolymer was isolated as an off-white powder (1.9 g, 51% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 16

### Synthesis of N₃-PEG5K-b-P(Asp(O^{t}Bu)₁₀₀-co-D-Leu₂₅-co-Orn(Z)₁₀₀)-Ac

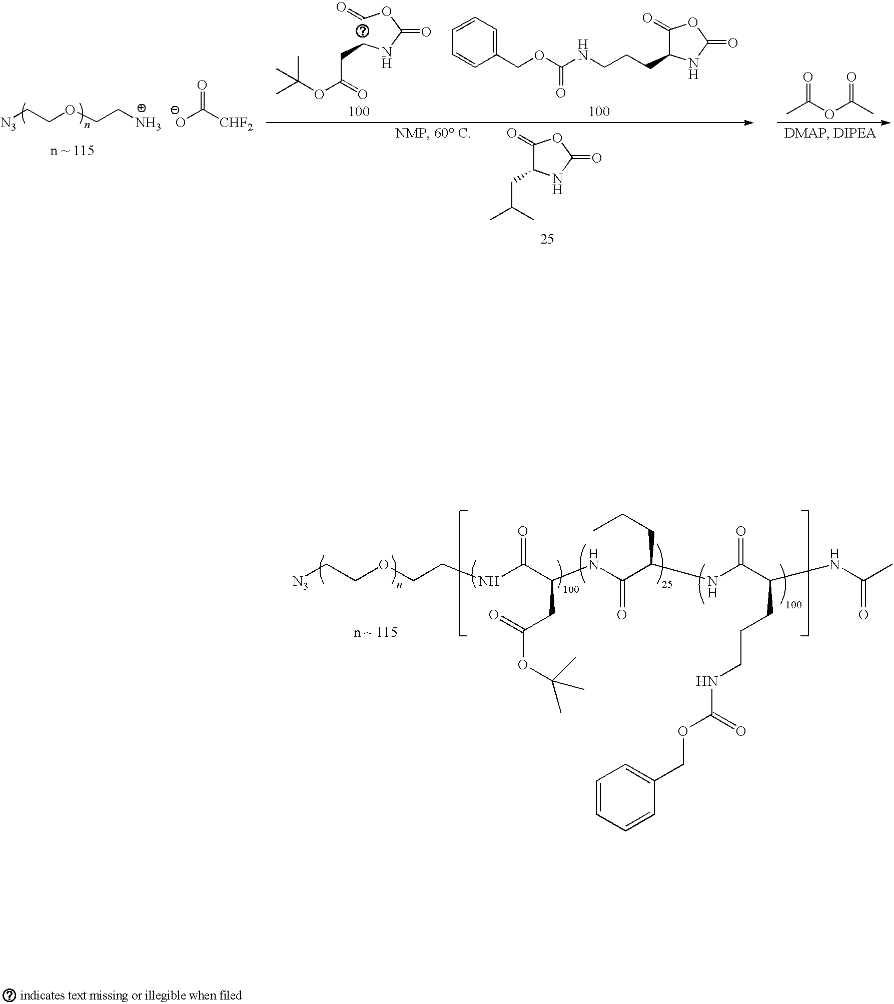

N₃-PEG5K-b-P(Asp(O^{t}Bu)100-co-D-Leu₂₅-co-Orn(Z)₁₀₀)-Ac was synthesized as described in Example 12 from N₃-PEG-NH₂/DFA salt, 5 kDa (0.5 g, 0.1 mmol), Asp(O^{t}Bu) NCA (2.15 g, 10 mmol), D-Leu NCA (0.39 g, 2.5 mmol), Orn(Z) NCA (2.92 g, 10 mmol) and 40 mL of NMP. The block copolymer was isolated as an off-white powder. ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 17

### Synthesis of N₃-PEG5K-b-P(Asp(O^{t}Bu)₇₅-co-D-Leu₂₅-co-Orn(Z)₁₀₀)-Ac

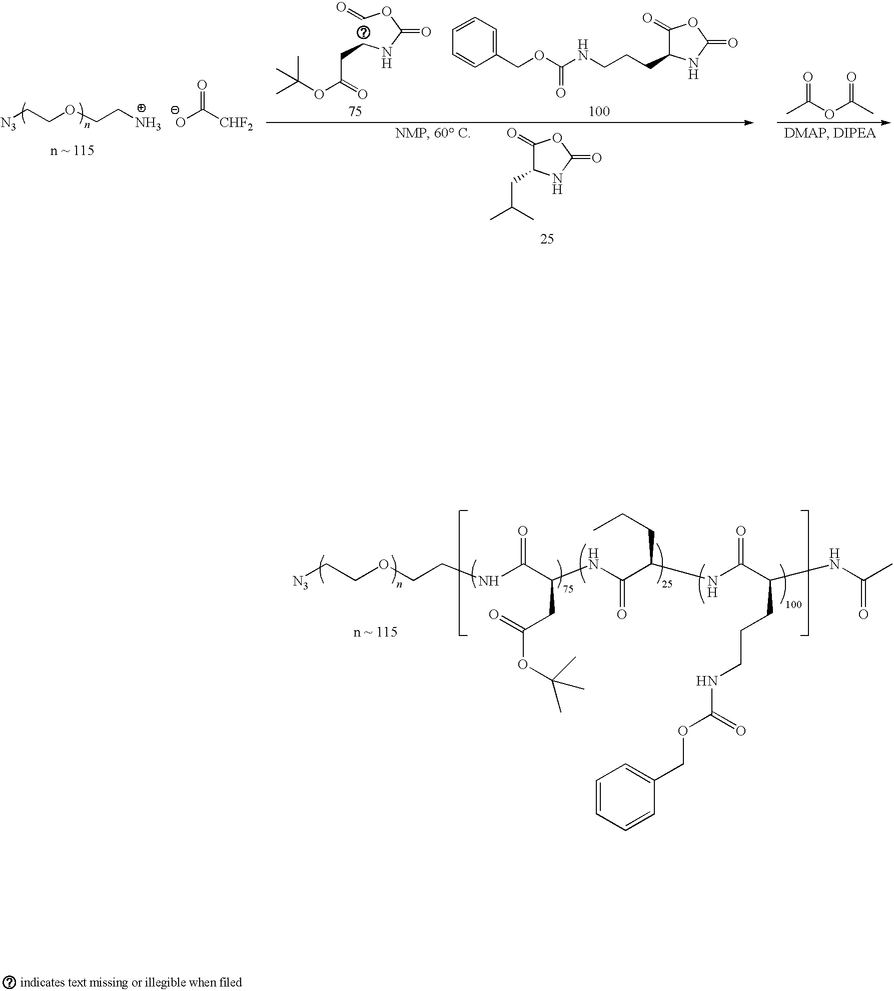

N₃-PEG5K-b-P(Asp(O^{t}Bu)₇₅-co-D-Leu₂₅-co-Orn(Z)₁₀₀)-Ac was synthesized as described in Example 12 from N₃-PEG-NH₂/DFA salt, 5 kDa (0.5 g, 0.1 mmol), Asp(O^{t}Bu) NCA (1.61 g, 7.5 mmol), D-Leu NCA (0.39 g, 2.5 mmol), Orn(Z) NCA (2.92 g, 10 mmol) and 36 mL of NMP. The block copolymer was isolated as an off-white powder. ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 18

### Synthesis of N₃-PEG5K-b-P(Asp(O^{t}Bu)₁₀₀-co-D-Leu₅₀-co-Orn(Z)₅₀)-Ac

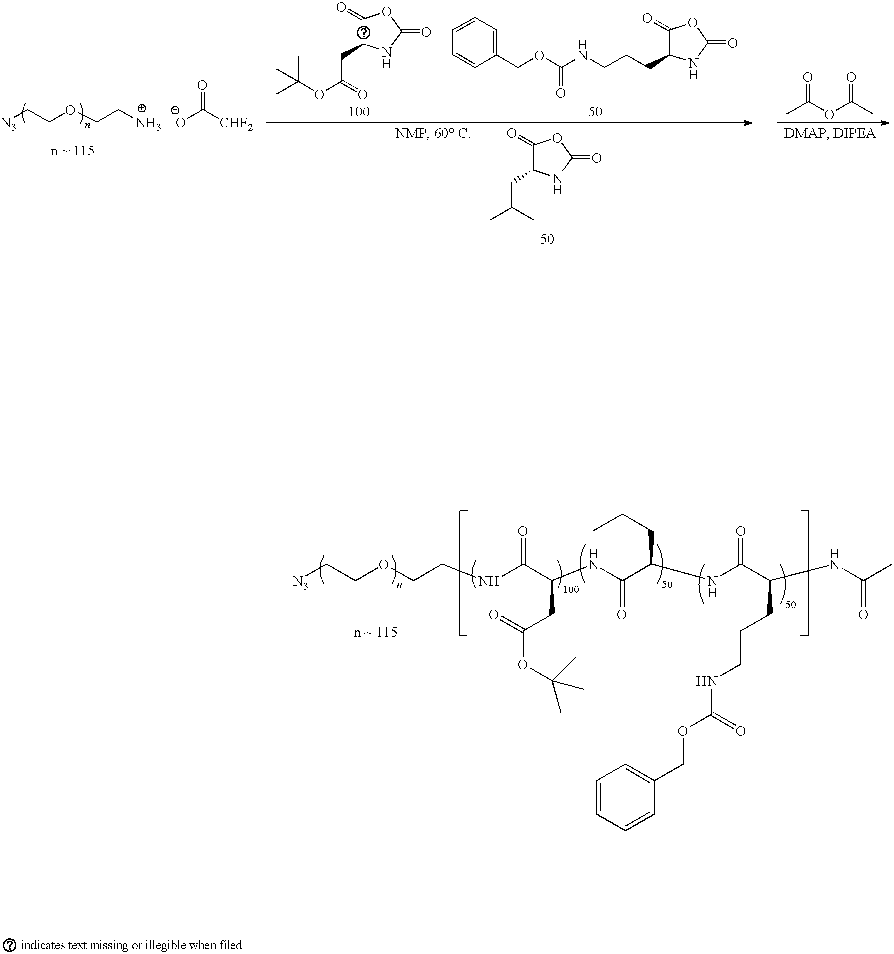

N₃-PEG5K-b-P(Asp(O^{t}Bu)₁₀₀-co-D-Leu₅₀-co-Orn(Z)₅₀)-Ac was synthesized as described in Example 12 from N₃-PEG-NH₂/DFA salt, 5 kDa (0.5 g, 0.1 mmol), Asp(O^{t}Bu) NCA (2.15 g, 10 mmol), D-Leu NCA (0.79 g, 5 mmol), Orn(Z) NCA (1.46 g, 5 mmol) and 33 mL of NMP. The block copolymer was isolated as an off-white powder (2.52 g, 63% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 19

### Synthesis of N₃-PEG5K-b-P(Asp(O^{t}Bu)₅₀-b-P(D-Leu₅₀-co-Orn(Z)₅₀)-Ac

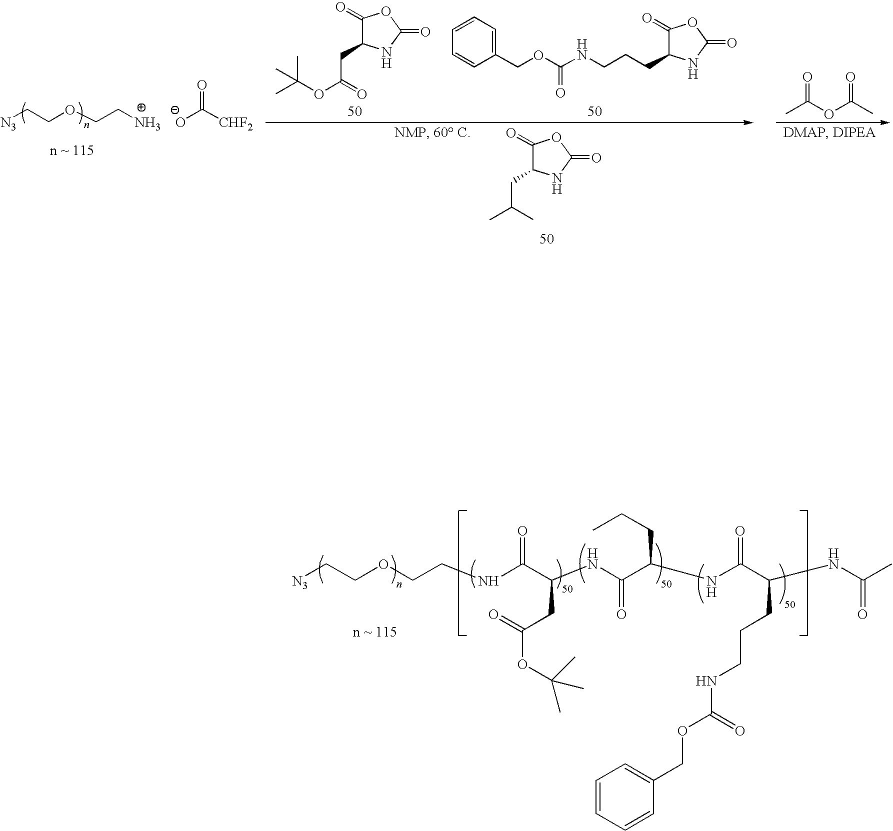

N₃-PEG5k-NH₂/DFA salt, (0.5 g, 0.1 mmol) was weighed into an oven-dried, round-bottom flask, dissolved in toluene, and dried by azeotropic distillation. Excess toluene was removed under vacuum. Asp(O^{t}Bu) NCA (1.08 g, 5 mmol) was added to the flask, the flask was evacuated under reduced pressure, and subsequently backfilled with nitrogen gas (repeated twice). Dry N-methylpyrrolidone (NMP) (10.5 mL) was introduced by syringe and the solution was heated to 60° C. The reaction mixture was allowed to stir for 2 days at 60° C. under nitrogen gas. In an oven-dried 2-neck round-bottom flask, D-Leu NCA (0.79 g, 5 mmol) and Orn(Z) NCA (1.46 g, 5 mmol) were combined, 3 vacuum/N2 cycles were applied and the white powder was dissolved in 15 ml of dry NMP under nitrogen gas. This solution was then transferred to the polymerization by syringe and allowed to stir for an additional 4 days 15 h at 60° C. The solution was cooled to room temperature and DIPEA (1.0 mL), DMAP (100 mg), and acetic anhydride (1.0 mL) were added. Stirring was continued for 1 hour at room temperature. The polymer was precipitated into diethyl ether and isolated by filtration. The solid was redissolved in dichloromethane and precipitated into diethyl ether. The product was isolated by filtration and dried in vacuo to give 2.39 g (75% yield) of the block copolymer as an off-white powder. ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 20

### Synthesis of N₃-PEG5K-b-P(Asp(O^{t}Bu)₇₅-b-P(D-Leu₅₀-co-Orn(Z)₅₀)-Ac

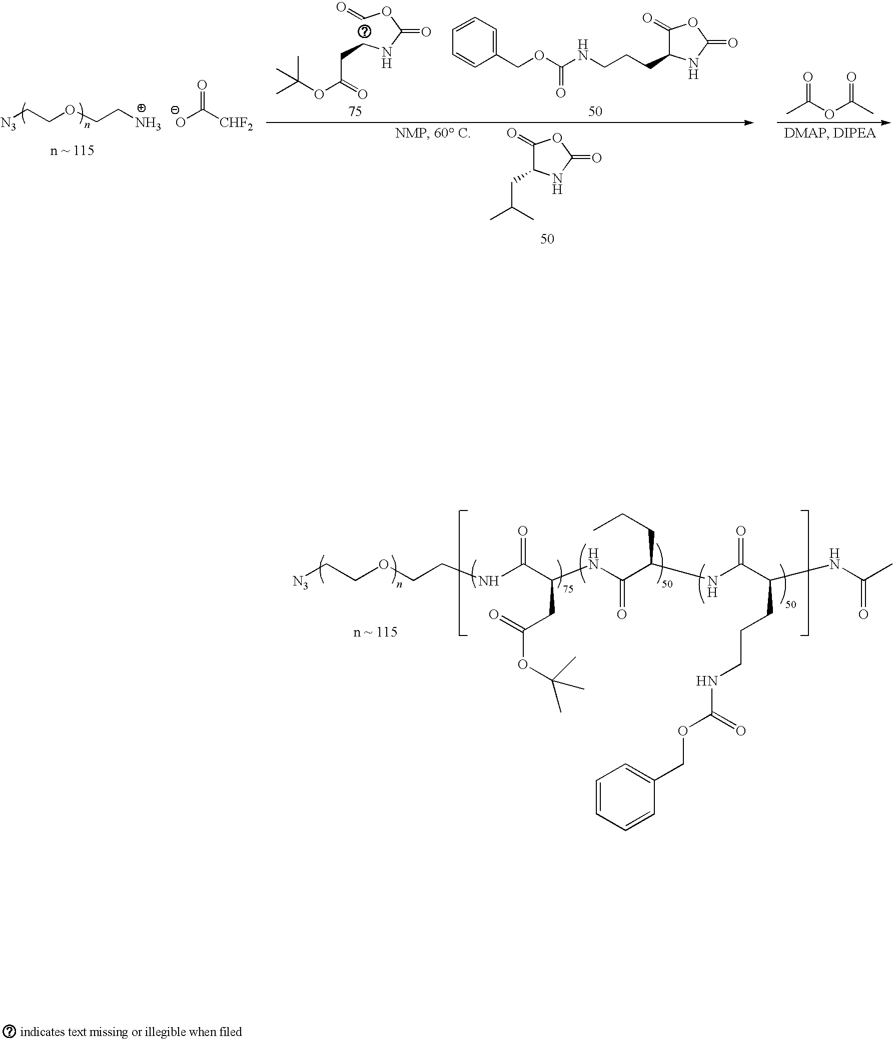

N₃-PEG5K-b-P(Asp(O^{t}Bu)₇₅-b-P(D-Leu₅₀-co-Orn(Z)₅₀)-Ac was synthesized as described in Example 19 from N₃-PEG-NH₂/DFA salt, 5 kDa (0.5 g, 0.1 mmol), Asp(O^{t}Bu) NCA (1.61 g, 7.5 mmol), D-Leu NCA (0.79 g, 5 mmol), Orn(Z) NCA (1.46 g, 5 mmol) and 36 mL of NMP (21 mL of NMP for the second block and 15 mL for the third block). The block copolymer was isolated as an off-white powder (2.7 g, 75% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 21

### Synthesis of N₃-PEG5K-b-P(Asp(O^{t}Bu)₁₀₀-b-P(D-Leu₅₀-co-Orn(Z)₅₀)-Ac

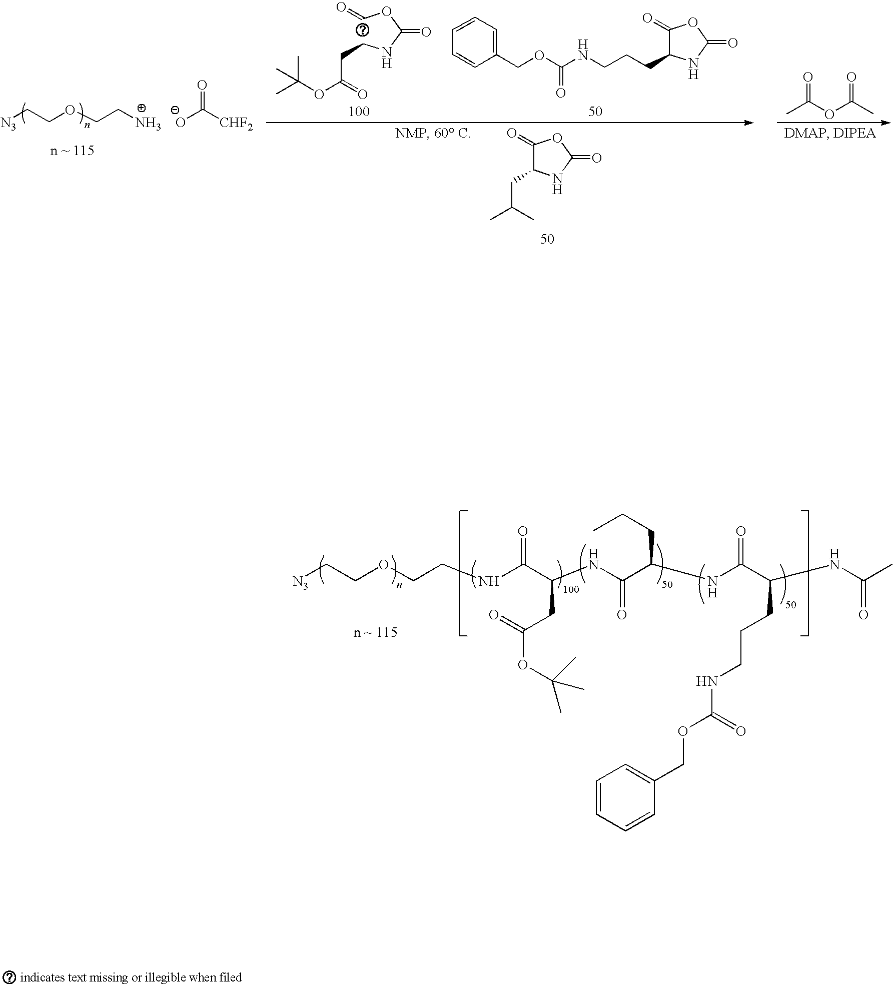

N₃-PEG5K-b-P(Asp(O^{t}Bu)₁₀₀-b-P(D-Leu₅₀-co-Orn(Z)₅₀)-Ac was synthesized as described in Example 19 from N₃-PEG-NH₂/DFA salt, 5 kDa (0.5 g, 0.1 mmol), Asp(O^{t}Bu) NCA (2.15 g, 10 mmol), D-Leu NCA (0.79 g, 5 mmol), Orn(Z) NCA (1.46 g, 5 mmol) and 41 mL of NMP (26 mL of NMP for the second block and 15 mL for the third block). The block copolymer was isolated as an off-white powder (1.86 g, 46% yield). ¹H NMR (d₆-DMSO) δ 8.44-7.58, 7.38-7.08, 5.04-4.89, 4.63-4.38, 4.35-4.14, 3.50, 3.05-2.88, 2.75-2.61, 2.48, 1.75-1.15, 0.95-0.71 ppm

### Example 22

### Synthesis of N₃-PEG5K-b-P(Asp(OBzl)₅₀)-Ac

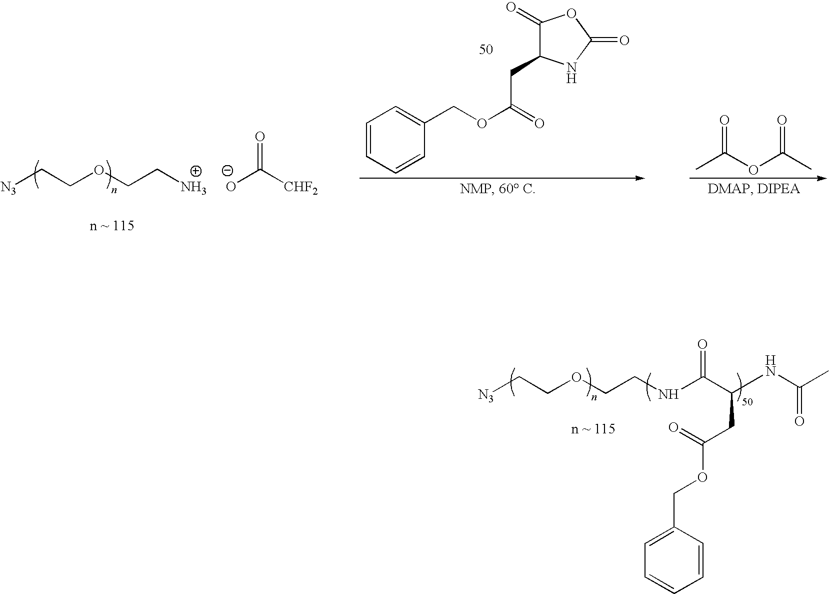

N₃-PEG5k-NH₂/DFA salt, (1 g, 0.2 mmol) was weighed into an oven-dried, round-bottom flask, dissolved in toluene, and dried by azeotropic distillation. Excess toluene was removed under vacuum. Asp(O^{t}Bu) NCA (2.49 g, 10 mmol) was added to the flask, the flask was evacuated under reduced pressure, and subsequently backfilled with nitrogen gas (repeated twice). Dry N-methylpyrrolidone (NMP) (17.5 mL) was introduced by syringe and the solution was heated to 60° C. The reaction mixture was allowed to stir for 2 days at 60° C. under nitrogen gas. The solution was cooled to room temperature and DIPEA (1.0 mL), DMAP (100 mg), and acetic anhydride (1.0 mL) were added. Stirring was continued for 1 hour at room temperature. The polymer was then placed in a 3500 g/mol molecular weight cut-off dialysis bag, dialyzed three times against 0.1 N methanol, three times against deionized water and freeze-dried. A white solid was obtained (2.03 g, 66% yield). ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 23

### Synthesis of N₃-PEG5K-b-P(Asp(OBzl)₇₅)-Ac

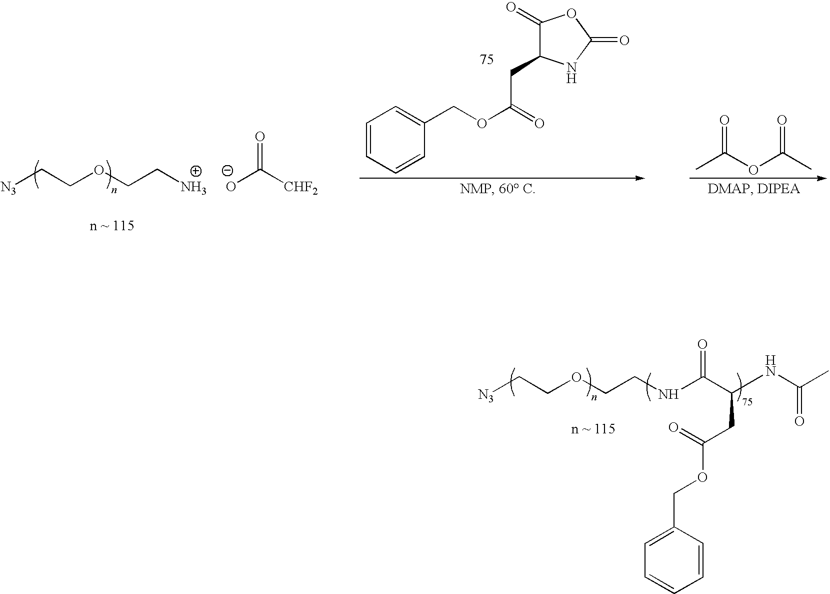

N₃-PEG5K-b-P(Asp(OBzl)₇₅)-Ac was synthesized as described in Example 22 from N₃-PEG-NH₂/DFA salt, 5 kDa (1 g, 0.2 mmol), Asp(O^{t}Bu) NCA (3.74 g, 15 mmol) and 48 mL of NMP. The block copolymer was isolated as an off-white powder. ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 24

### Synthesis of N₃-PEG5K-b-P(Asp(OBzl)₁₀₀)-Ac

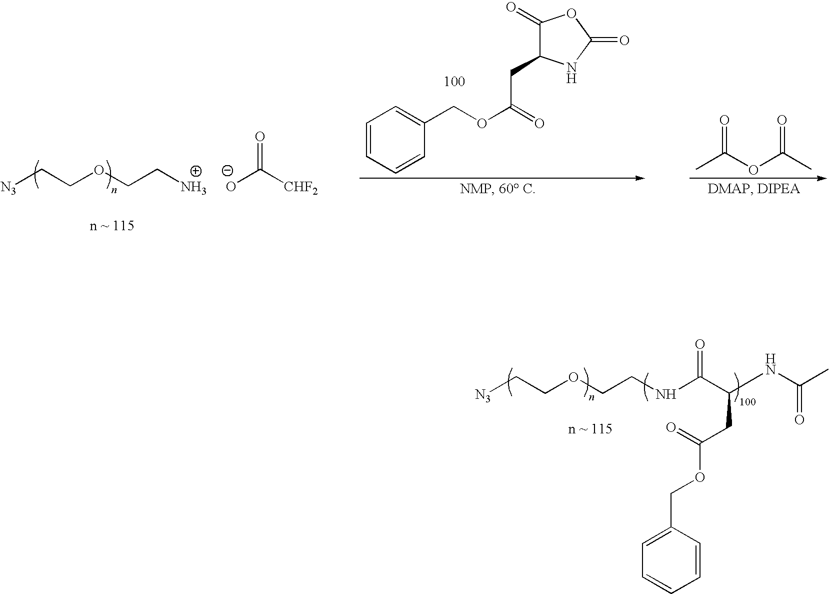

N₃-PEG5K-b-P(Asp(OBzl)₁₀₀)-Ac was synthesized as described in Example 22 from N₃-PEG-NH₂/DFA salt, 5 kDa (1 g, 0.2 mmol), Asp(O^{t}Bu) NCA (4.98 g, 20 mmol) and 60 mL of NMP. The block copolymer was isolated as an off-white powder. ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 25

### Synthesis of N₃-PEG5K-b-P(Asp(OBzl)₂₅-co-D-Asp(OBzl)₂₅)-Ac

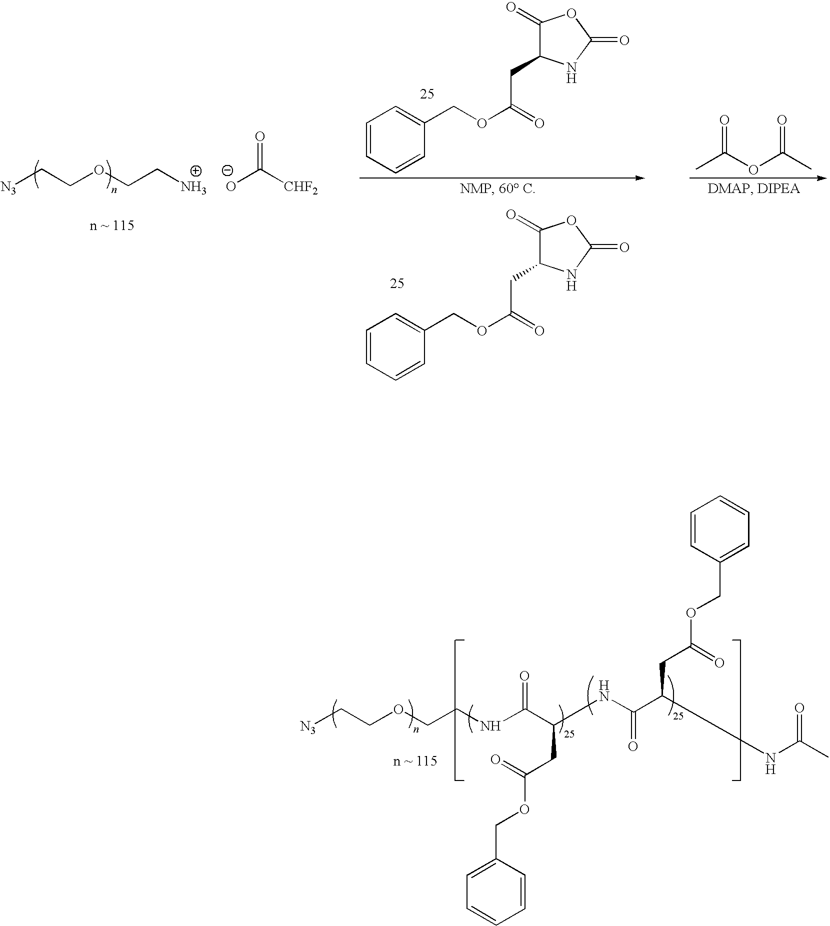

N₃-PEG5K-b-P(Asp(OBzl)₂₅-co-D-Asp(OBzl)₂₅)-Ac was synthesized as described in Example 22 from N₃-PEG-NH₂/DFA salt, 5 kDa (1 g, 0.2 mmol), Asp(O^{t}Bu) NCA (1.25 g, 5 mmol), D-Asp(O^{t}Bu) NCA (1.25 g, 5 mmol) and 18 mL of NMP. The block copolymer was isolated as an off-white powder. ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 26

### Synthesis of N₃-PEG5K-b-P(Asp(OBzl)₃₇-co-D-Asp(OBzl)₃₇)-Ac

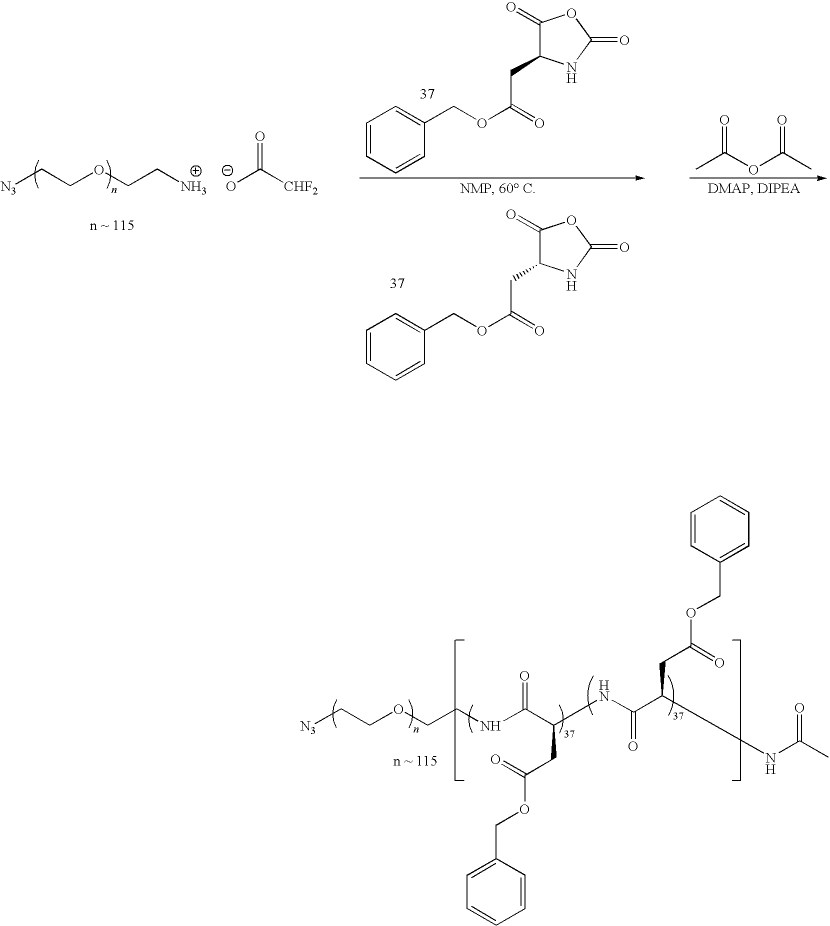

N₃-PEG5K-b-P(Asp(OBzl)₃₇-co-D-Asp(OBzl)₃₇)-Ac was synthesized as described in Example 22 from N₃-PEG-NH₂/DFA salt, 5 kDa (1 g, 0.2 mmol), Asp(O^{t}Bu) NCA (1.84 g, 7.4 mmol), D-Asp(O^{t}Bu) NCA (1.84 g, 7.4 mmol) and 47 mL of NMP. The block copolymer was isolated as an off-white powder. ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 27

### Synthesis of N₃-PEG5K-b-P(Asp(OBzl)₅₀-co-D-Asp(OBzl)₅₀)-Ac

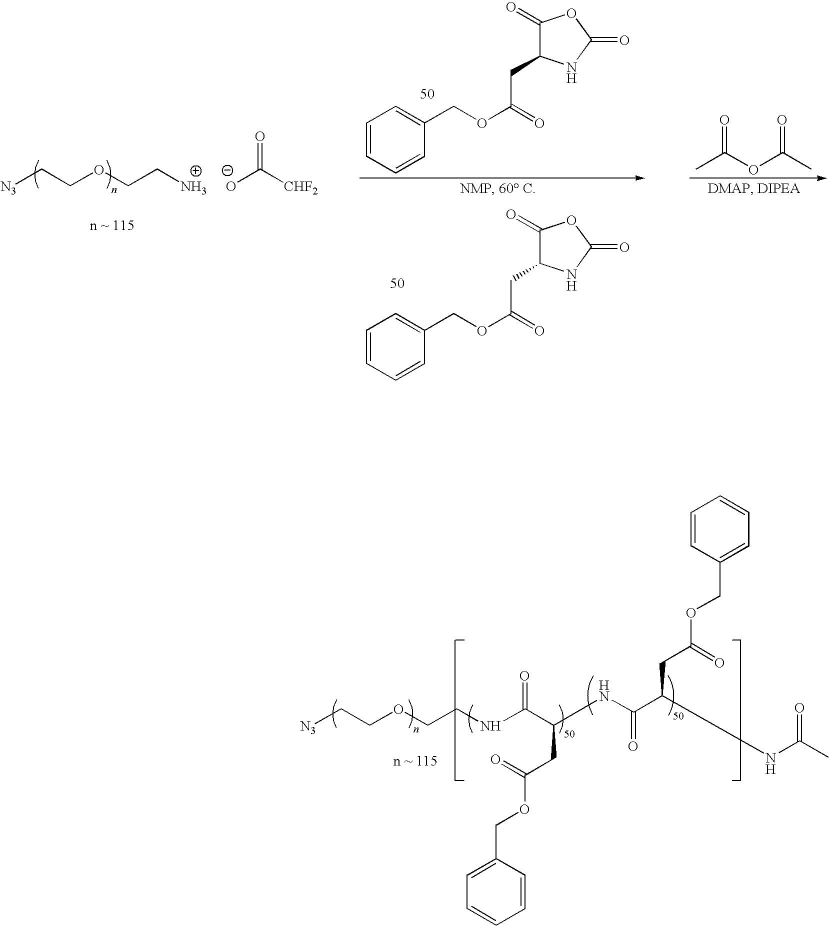

N₃-PEG5K-b-P(Asp(OBzl)₅₀-co-D-Asp(OBzl)₅₀)-Ac was synthesized as described in Example 22 from N₃-PEG-NH₂/DFA salt, 5 kDa (1 g, 0.2 mmol), Asp(O^{t}Bu) NCA (2.49 g, 10 mmol), D-Asp(O^{t}Bu) NCA (2.49 g, 10 mmol) and 60 mL of NMP. The block copolymer was isolated as an off-white powder. ¹H NMR (d₆-DMSO) δ 8.54-8.09, 7.44-7.17, 5.23-4.88, 4.63-4.43, 3.63, 3.25, 2.89-2.69, 2.67-2.54 ppm.

### Example 28

### Synthesis of N₃-PEG5K-b-P(Orn(Z)₅₀)-Ac

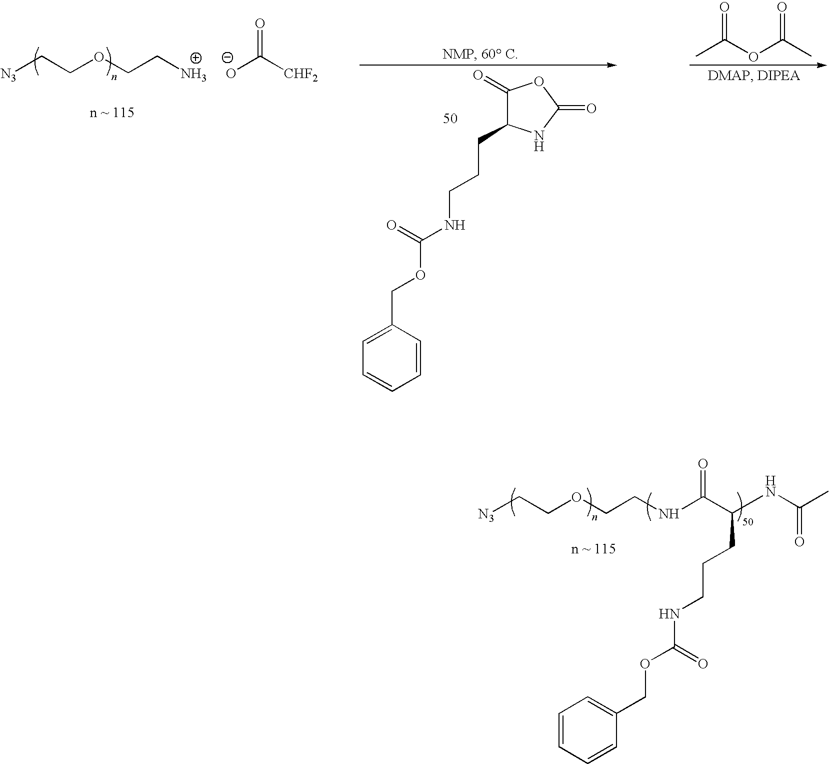

N₃-PEG12k-NH₂/DFA salt, (1 g, 0.2 mmol) was weighed into an oven-dried, round-bottom flask, dissolved in toluene, and dried by azeotropic distillation. Excess toluene was removed under vacuum. Orn(Z) NCA (2.92 g, 10 mmol) was added to the flask, the flask was evacuated under reduced pressure, and subsequently backfilled with nitrogen gas. Dry N-methylpyrrolidone (NMP) (20 mL) was introduced by syringe and the solution was heated to 60° C. The reaction mixture was allowed to stir for 4 days at 60° C. under nitrogen gas. The solution was cooled to room temperature and DIPEA (2.0 mL), DMAP (100 mg), and acetic anhydride (2.0 mL) were added. Stirring was continued for 1 hour at room temperature. The polymer was precipitated into diethyl ether (cooled down to −20° C.) and isolated by filtration. The product was isolated by filtration and dried in vacuo to give the block copolymer as an off-white powder.

### Example 29

### Synthesis of N₃-PEG5K-b-P(Orn(Z)₁₀₀)-Ac

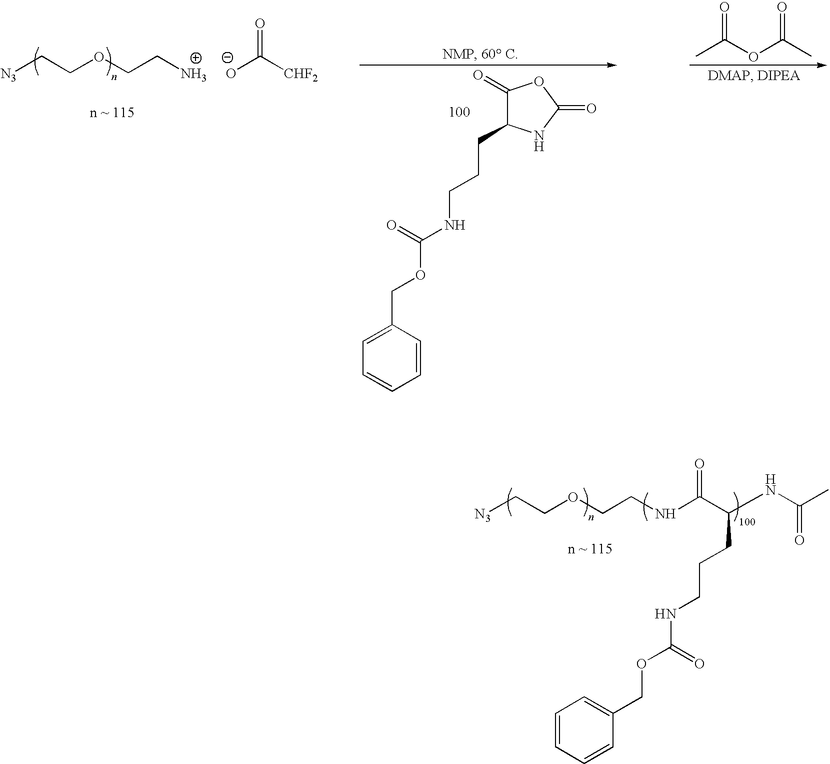

N₃-PEG5K-b-P(Orn(Z)₁₀₀)-Ac was synthesized as described in Example 28 from N₃-PEG-NH₂/DFA salt, 5 kDa (1 g, 0.2 mmol), Orn(Z)) NCA (5.85 g, 20 mmol) and 68 mL of NMP. The block copolymer was isolated as an off-white powder.

### Example 30

### Synthesis of N₃-PEG5K-b-P(Orn₅₀)-Ac

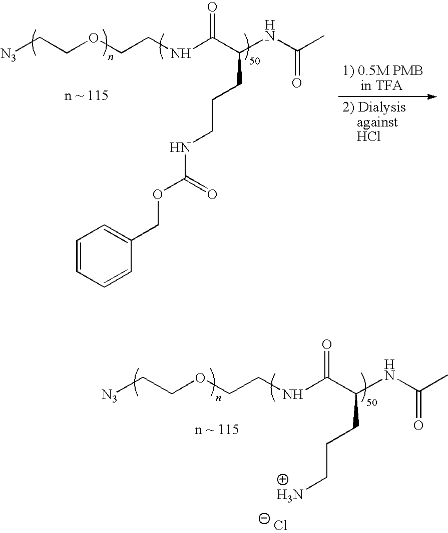

N₃-PEG5K-b-P(Orn(Z)₅₀)-Ac (1.5 g, 86 μmol) was dissolved in 37 mL of a 0.5 M solution of pentamethylbenzene (PMB) in trifluoroacetic acid (TFA). The reaction was allowed to stir for 3 hours at room temperature with a white precipitate forming after approximately 1 hour. The solution was placed into a 2000 g/mol molecular weight cut-off dialysis bag and dialyzed twice against 0.1 N MeOH, twice against deionized water and freeze-dried to yield a white powder (0.49 g, 45% yield).

### Example 31

### Synthesis of N₃-PEG5K-b-P(Orn₁₀₀)-Ac

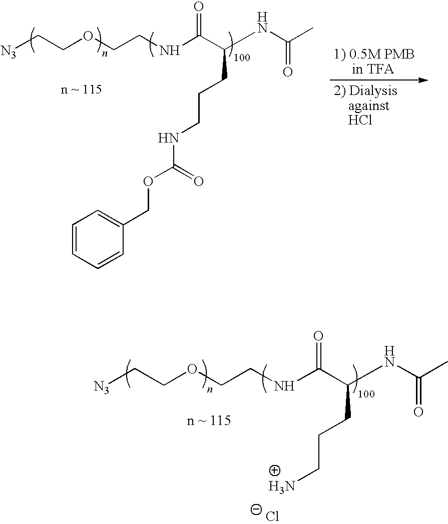

N₃-PEG5K-b-P(Orn(Z)₁₀₀)-Ac (1.5 g, 86 μmol) was dissolved in 37 mL of a 0.5 M solution of pentamethylbenzene (PMB) in trifluoroacetic acid (TFA). The reaction was allowed to stir for 3 hours at room temperature with a white precipitate forming after approximately 1 hour. The solution was placed into a 2000 g/mol molecular weight cut-off dialysis bag and dialyzed twice against 0.1 N MeOH, twice against deionized water and freeze-dried to yield a white powder (0.50 g, 48% yield).

### Example 32

### Synthesis of N₃-PEG5K-b-P(Asp(OBzl)₂₅-co-Asp(O^{t}Bu)₂₅)-Ac

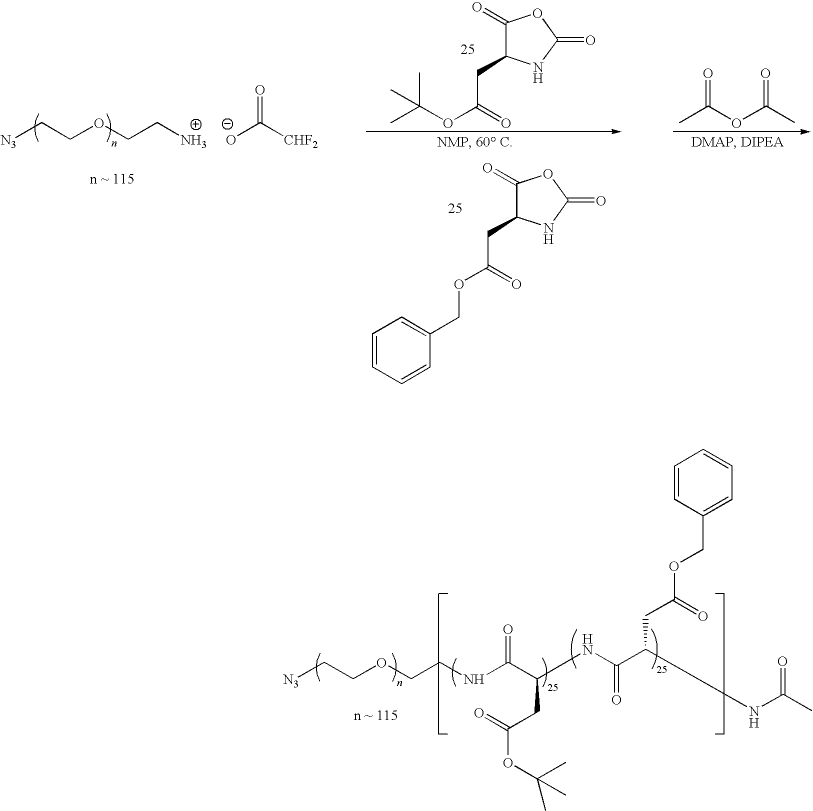

N₃-PEG5K-b-P(Asp(OBzl)₂₅-co-D-Asp(^{t}Bu)₂₅)-Ac was synthesized as described in Example 22 from N₃-PEG-NH₂/DFA salt, 5 kDa (1 g, 0.2 mmol), Asp(O^{t}Bu) NCA (1.25 g, 5 mmol), D-Asp(O^{t}Bu) NCA (1.08 g, 5 mmol) and 17 mL of NMP. The block copolymer was isolated as an off-white powder (1.81 g, 63% yield). ¹H NMR (d₆-DMSO) δ 8.50-7.67, 7.48-7.14, 5.18-4.91, 4.73-4.45, 3.71-3.38, 2.90-2.22, 1.52-1.12 ppm

### Example 33

### Synthesis of N₃-PEG5K-b-P(Asp(OBzl)₅₀-co-Asp(O^{t}Bu)₅₀)-Ac

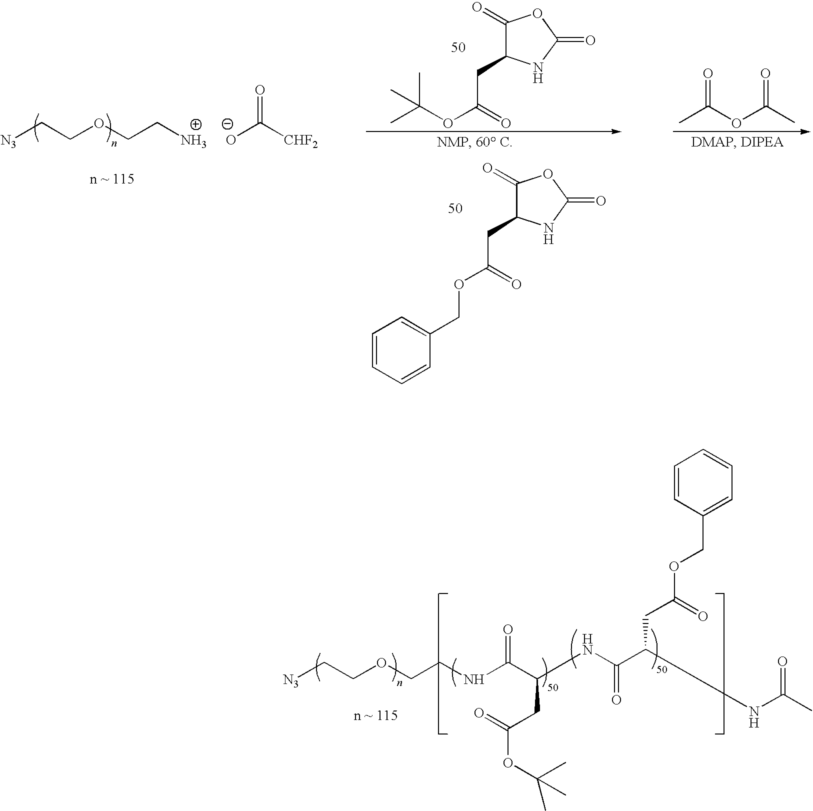

N₃-PEG5K-b-P(Asp(OBzl)₂₅-co-D-Asp(^{t}Bu)₂₅)-Ac was synthesized as described in Example 22 from N₃-PEG-NH₂/DFA salt, 5 kDa (1 g, 0.2 mmol), Asp(O^{t}Bu) NCA (2.49 g, 10 mmol), D-Asp(O^{t}Bu) NCA (2.15 g, 10 mmol) and 60 mL of NMP. The block copolymer was isolated as an off-white powder (2.74 g, 57% yield). ¹H NMR (d₆-DMSO) δ 8.50-7.67, 7.48-7.14, 5.18-4.91, 4.73-4.45, 3.71-3.38, 2.90-2.22, 1.52-1.12 ppm

### Example 34

### Synthesis of N₃-PEG5K-b-P(Asp(OBzl)₂₅-co-Asp(Morph)₂₅)-Ac

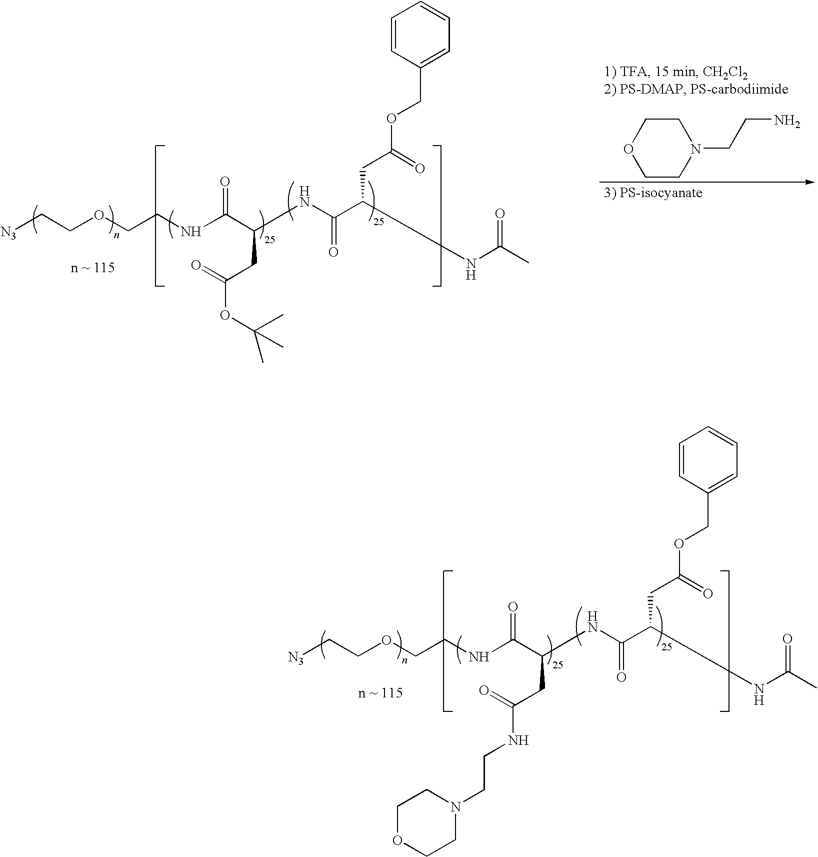

N₃-PEG5K-b-P(Asp(OBzl)₂₅-co-Asp(O^{t}Bu)₂₅)-Ac (1 g, 69.4 μmol) was dissolved in 5 mL of dichloromethane and 5 mL of trifluoroacetic acid (TFA), after which the solution was precipitated into 100 mL of cold ether (−20° C.). The precipitated was redissolved in 10 mL of dichloromethane and reprecipitated into 100 mL of cold ether (−20° C.). After filtration, the product was dried overnight in a vacuum oven. The polymer (250 mg, 0.019 mmol) was weighed into a 50 mL flask, along with PS-DMAP (1.47 mmol/g resin, 0.33 g, 0.48 mmol) and PS carbodiimide (1.33 mmol/g resin, 1.80 g, 2.4 mmol). 4-(2-Aminoethyl)morpholine (0.25 mL, 1.92 mmol) and DMF (dry, 15 mL) were syringed in the flask and the reaction was left at room temperature overnight. The following day, MP-isocyanate resin (1.11 mmol/g, 2.59 g, 2.875 mmol) was introduced in the reaction media and allowed to react to remove the excess 4-(2-aminoethyl)morpholine for 4 hours. The resin was removed from the reaction by filtration through a Whatman paper no. 1 and the solution was used as such for further polymer modification (Example 36).

### Example 35

### Synthesis of N₃-PEG5K-b-P(Asp(OBzl)₅₀-co-Asp(Morph)₅₀)-Ac

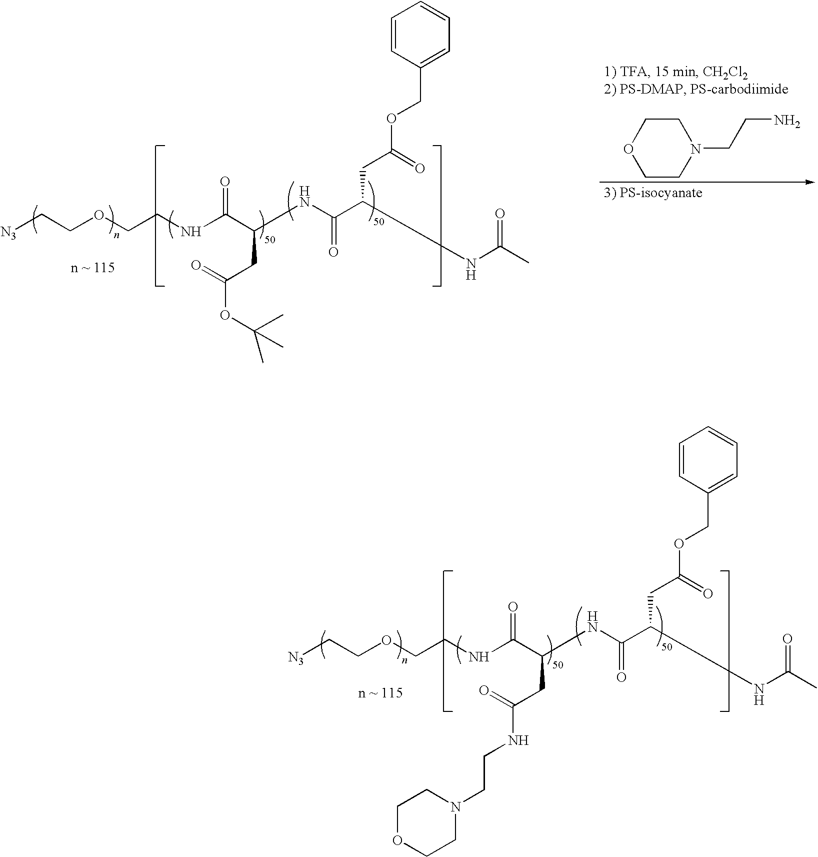

N₃-PEG5K-b-P(Asp(OBzl)₅₀-co-Asp(Morph)₅₀)-Ac was synthesized as in Example 34 from N₃-PEG5K-b-P(Asp(OBzl)₅₀-co-Asp(O^{t}Bu)₅₀)-Ac (0.25 g, 12 μmol), TFA (5 mL), PS-DMAP (0.41 g, 0.595 mmol), PS-carbodiimide (2.24 g, 2.98 mmol), 4-(2-aminoethyl)morpholine (0.31 mL, 2.38 mmol), MP-isocyanate (3.22 g, 3.57 mmol), DMF (15 mL). The final solution was used as such for further modification (Example 37)

### Example 36

### Synthesis of N₃-PEG5K-b-P(Asp(DET)₂₅-co-Asp(Morph)₂₅)-Ac

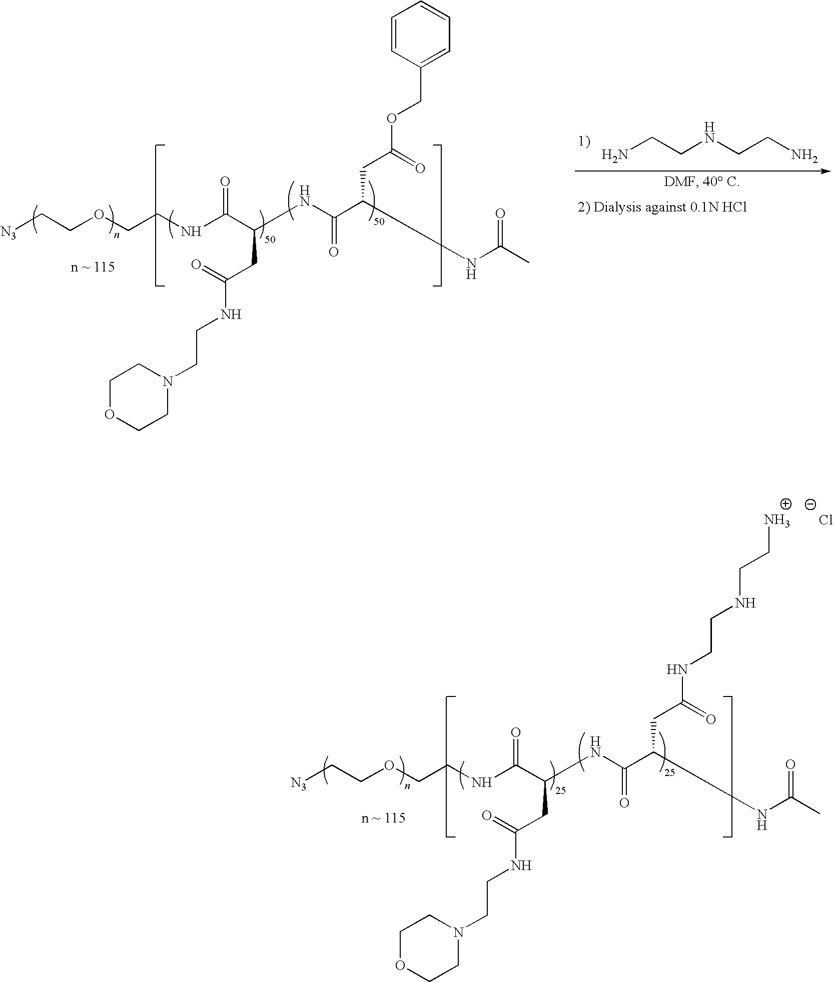

N₃-PEG5K-b-P(Asp(OBzl)₂₅-co-Asp(Morph)₂₅)-Ac (0.25 g, 16.1 μmol) was introduced into an oven-dried two-neck flask and three vacuum/N₂ cycles were done. Diethylenetriamine (DET, vacuum distilled from CaH₂, 2 mL, 18.6 mmol) and dry DMF (20 mL) were syringed in the reaction flask. The reaction was stirred at 40° C. overnight under inert atmosphere. The reaction solution was then introduced into a 3500 molecular weight cut-off dialysis bag and dialyzed three times against 0.1 M HCl and three times against deionized water. The solution was filtered through a 0.45 μm filter and the solution was freeze-dried. A white fluffy solid was recovered. ¹H NMR (D₂O) δ 4-3.33, 3.33-2.58 ppm

### Example 37

### Synthesis of N₃-PEG5K-b-P(Asp(DET)₅₀-co-Asp(Morph)₅₀)-Ac

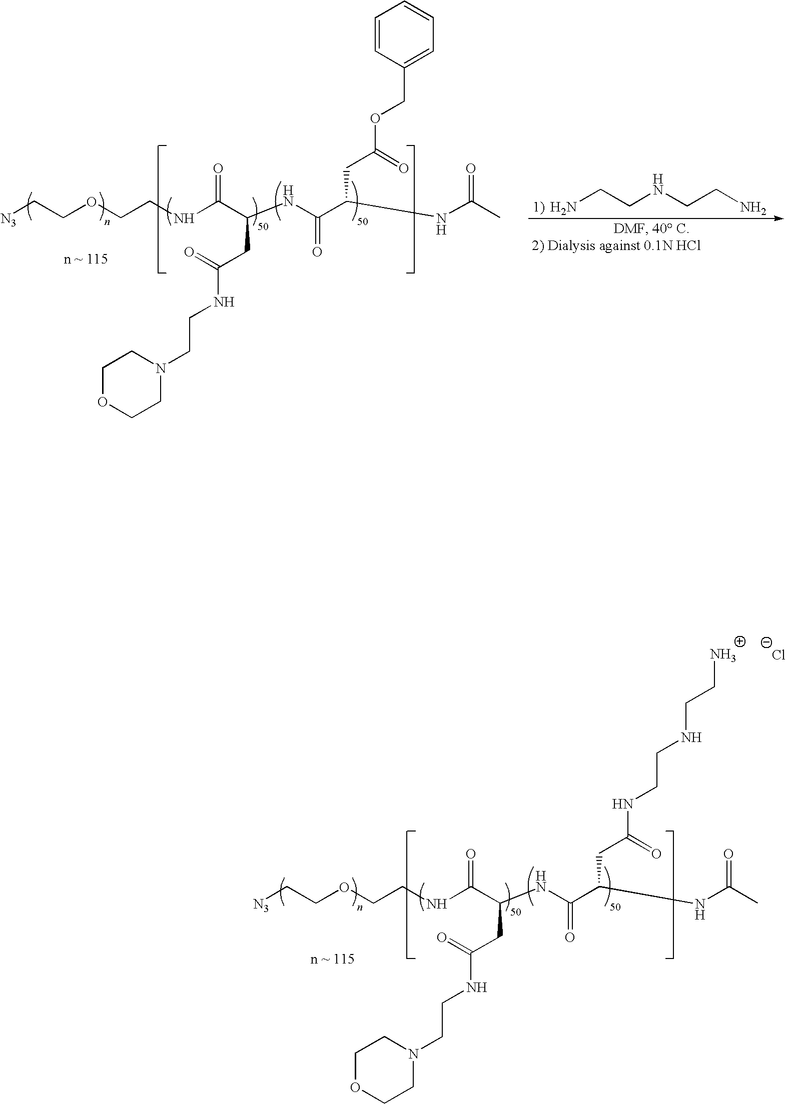

N₃-PEG5K-b-P(Asp(DET)₅₀-co-Asp(Morph)₅₀)-Ac was made as described in Example 36 from N₃-PEG5K-b-P(Asp(OBzl)₅₀-co-Asp(Morph)₅₀)-Ac (0.25 g, 9.6 μmol), diethylenetriamine (2 mL, 18.6 mmol) and DMF (20 mL). A white fluffy solid was recovered. ¹H NMR (D₂O) δ 4-3.33, 3.33-2.58 ppm

### Example 38

### Synthesis of N3-PEG12K-b-P(Asp(DET)₅₀-co-D-Asp(DET)₅₀)-Ac

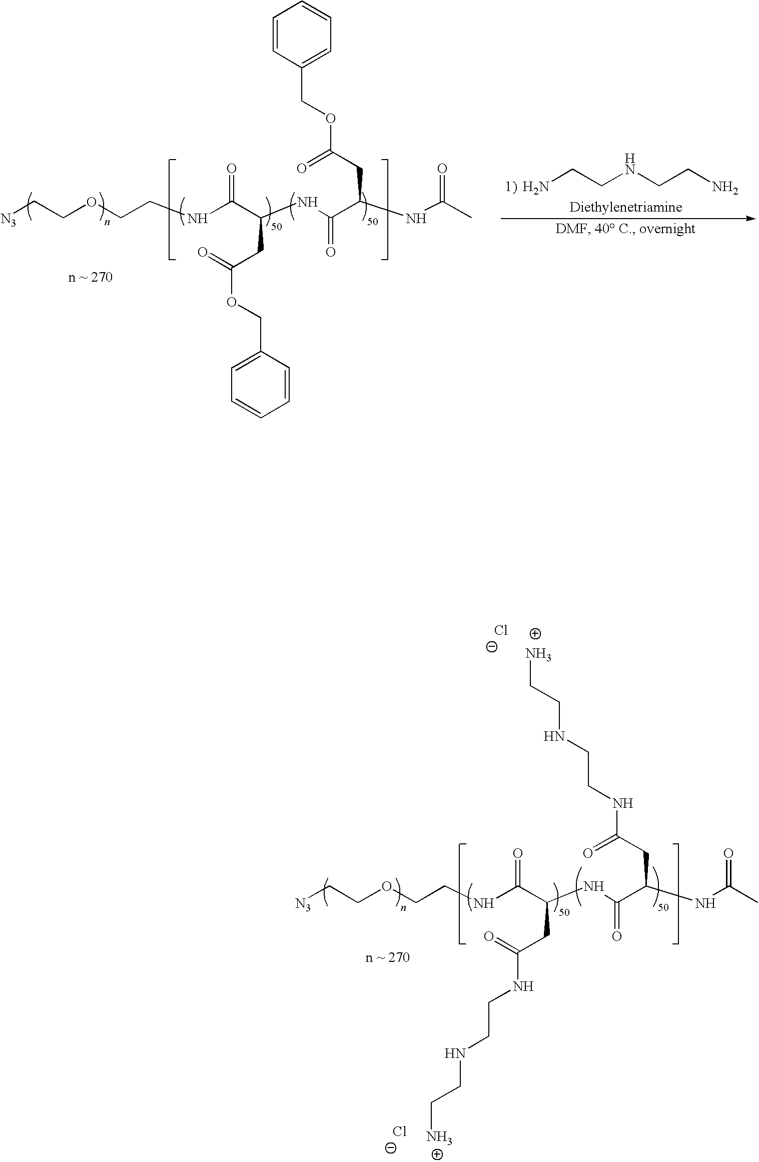

N₃-PEG12K-b-P(Asp(OBzl)₅₀-co-D-Asp(AspOBzl)₅₀)-Ac (0.631 g, 19.7 μmol) was introduced into an oven-dried two-neck flask and three vacuum/N₂ cycles were done. Diethylenetriamine (DET, vacuum distilled from CaH₂, 4 mL, 37.2 mmol) and dry DMF (0.4 mL) were syringed in the reaction flask. The reaction was stirred at 40° C. overnight under inert atmosphere. The reaction solution was then introduced into a 3500 molecular weight cut-off dialysis bag and dialyzed three times against 0.1 M HCl and three times against deionized water. The solution was filtered through a 0.45 μm filter and the solution was freeze-dried. A white fluffy solid was recovered (0.311 g, 45% yield). ¹H NMR (D₂O) δ 3.90-3.85, 3.83-3.63, 3.61-3.35, 3.35-2.60 ppm

### Example 39

### Synthesis of N3-PEG12K-b-P(Asp(TET)₅₀-co-D-Asp(TET)₅₀)-Ac

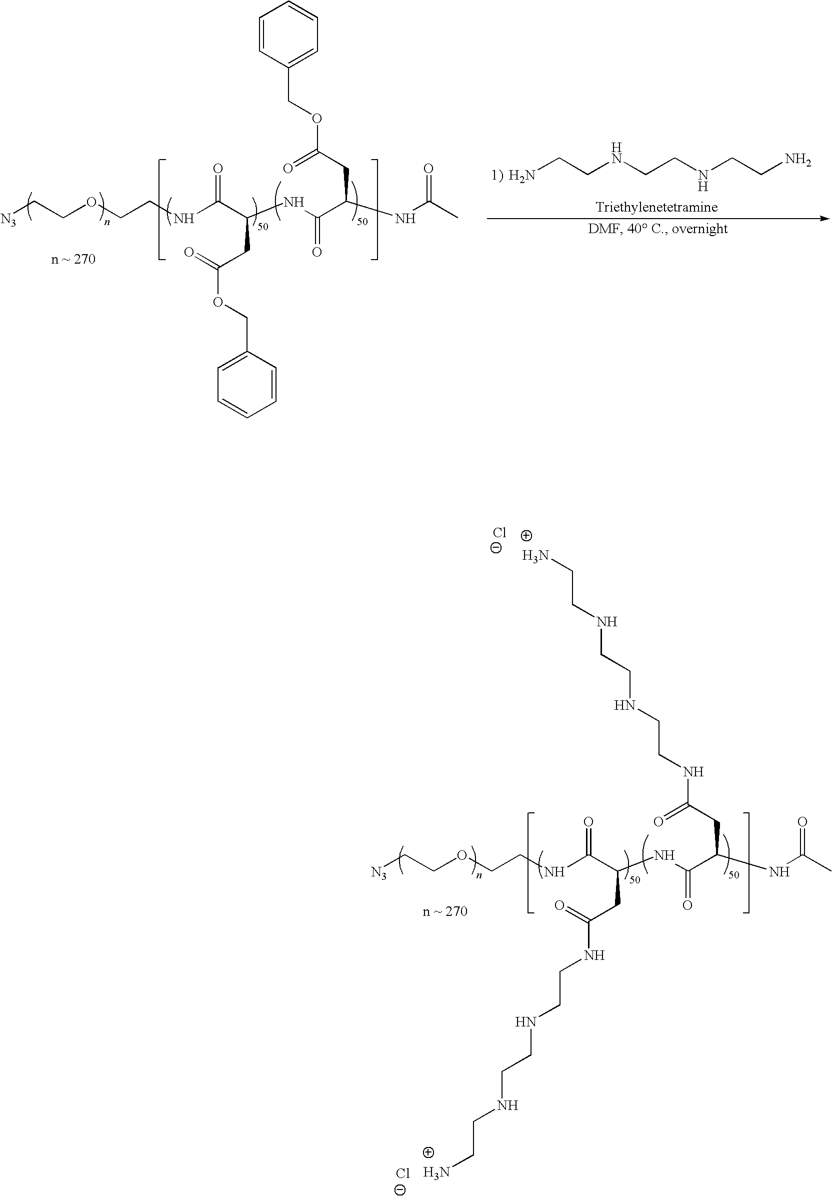

N₃-PEG12K-b-P(Asp(TET)₅₀-co-D-Asp(TET)₅₀)-Ac was synthesized as described in Example 38 from N₃-PEG12K-b-P(Asp(OBzl)₅₀-co-D-Asp(AspOBzl)₅₀)-Ac (0.557 g, 17.4 μmol), triethylenetetramine (TET, 5 mL, 33.3 mmol) and DMF (dry, 10 mL). A white fluffy powder was recovered (0.219 g, 32% yield). ¹H NMR (D₂O) δ 3.90-3.85, 3.83-3.63, 3.61-3.35, 3.35-2.60 ppm

### Example 40

### Synthesis of N₃-PEG12K-b-P(Asp(TEP)₅₀-co-D-Asp(TEP)₅₀)-Ac

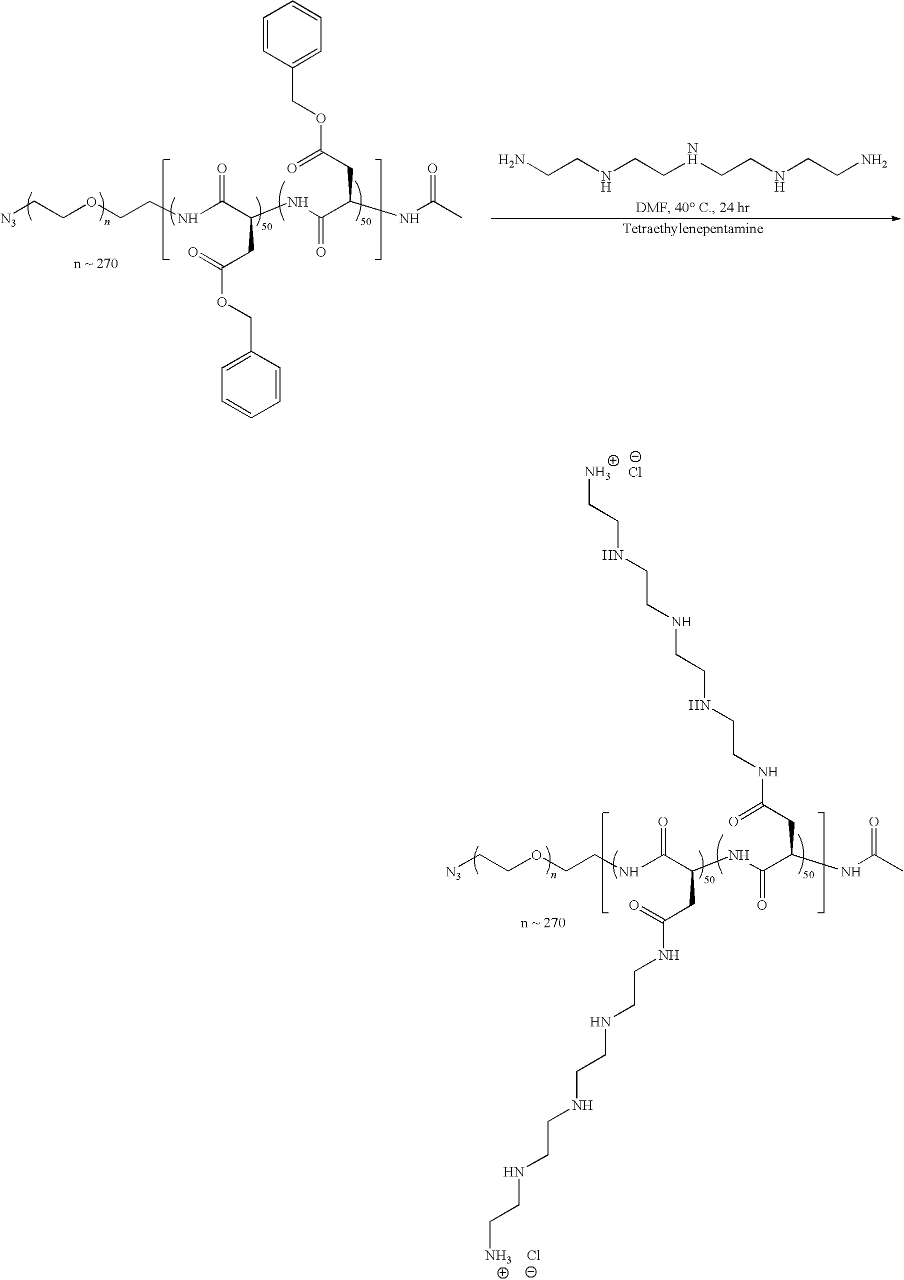

N₃-PEG12K-b-P(Asp(TEP)₅₀-co-D-Asp(TEP)₅₀)-Ac was synthesized as described in Example 38 from N₃-PEG12K-b-P(Asp(OBzl)₅₀-co-D-Asp(AspOBzl)₅₀)-Ac (0.58 g, 18.1 μmol), tetraethylenepentamine (TEP, 7 mL, 36.6 mmol) and DMF (dry, 10 mL). A white fluffy powder was recovered (0.184 g, 23% yield). ¹H NMR (D₂O) δ 3.90-3.85, 3.83-3.43, 3.43-3.02, 3.02-2.58 ppm

### Example 41

### Synthesis of N₃-PEG12K-b-P(Asp(PEH)₅₀-co-D-Asp(PEH)₅₀)-Ac

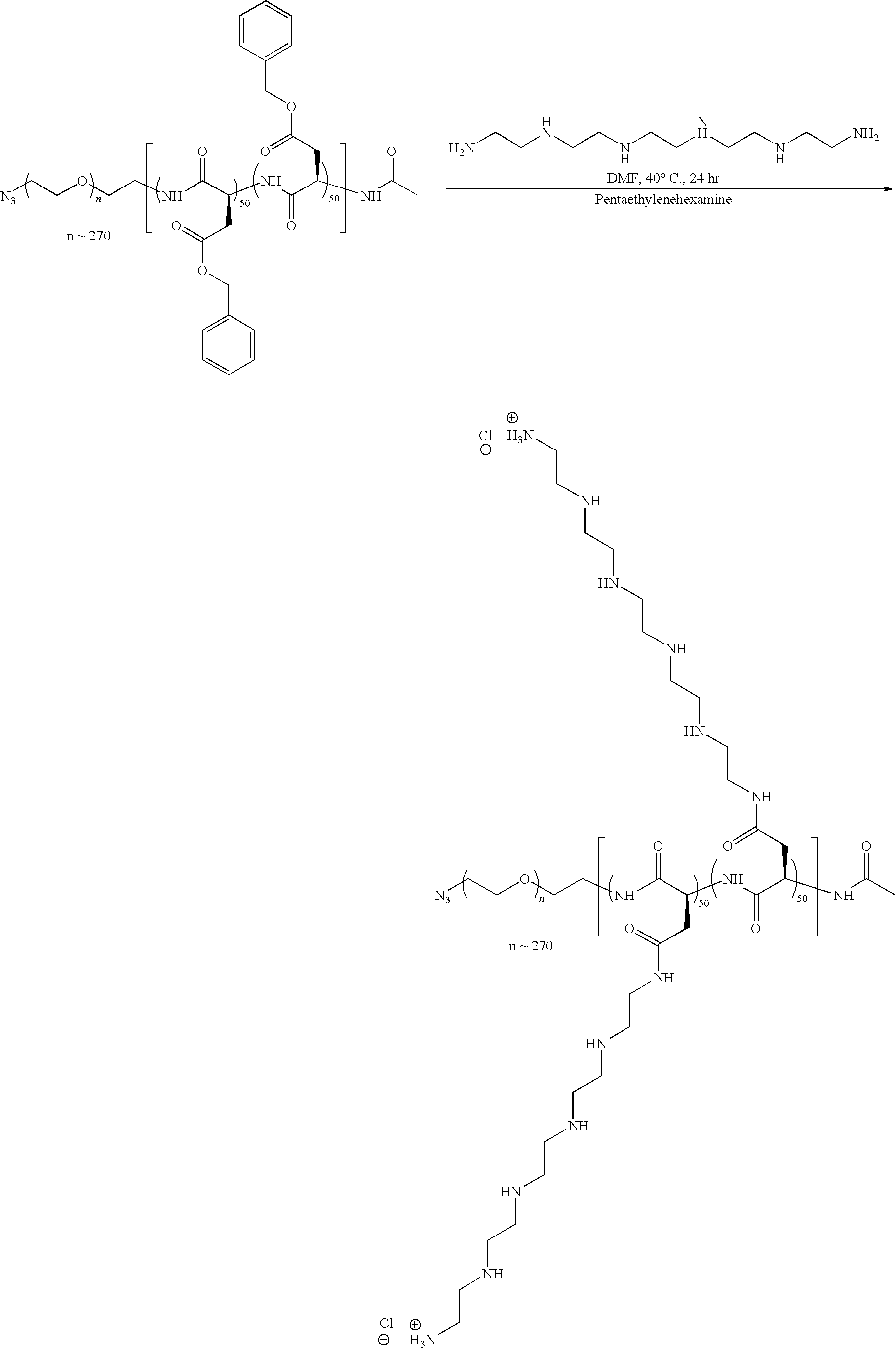

N₃-PEG12K-b-P(Asp(PEH)₅₀-co-D-Asp(PEH)₅₀)-Ac was synthesized as described in Example 38 from N₃-PEG12K-b-P(Asp(OBzl)₅₀-co-D-Asp(AspOBzl)₅₀)-Ac (0.56 g, 17.5 μmol), pentaethylenehexamine (PEH, 8 mL, 34.4 mmol) and DMF (dry, 10 mL). A white fluffy powder was recovered. ¹H NMR (D₂O) δ 3.90-3.85, 3.83-3.43, 3.43-3.02, 3.02-2.58 ppm

### Example 42

### Synthesis of N₃-PEG12K-b-P(Asp(Tris)₅₀-co-D-Asp(Tris)₅₀)-Ac

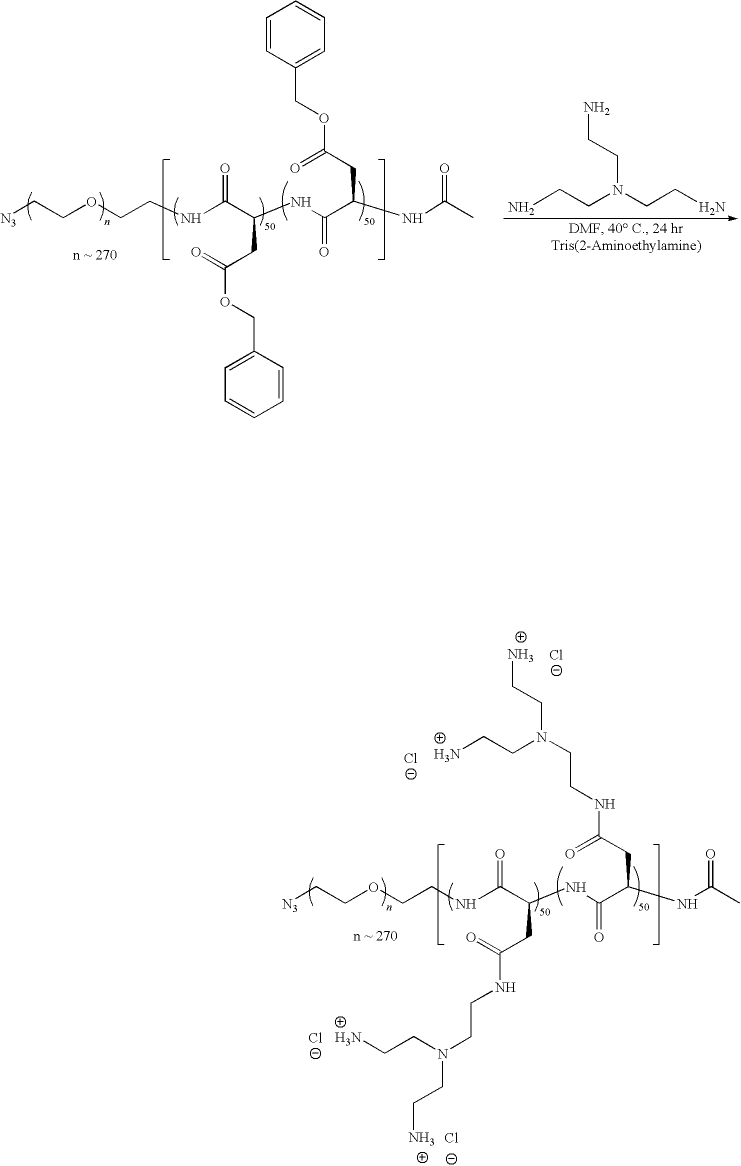

N₃-PEG12K-b-P(Asp(Tris)₅₀-co-D-Asp(Tris)₅₀)-Ac was synthesized as described in Example 38 from N₃-PEG12K-b-P(Asp(OBzl)₅₀-co-D-Asp(AspOBzl)₅₀)-Ac (0.542 g, 16.9 μmol), tris(2-aminoethylamine) (Tris, 8 mL, 34.4 mmol) and DMF (dry, 4 mL). A white fluffy powder was recovered. (0.209 g, 31% yield)

### Example 43

### Synthesis of N₃-PEG12K-b-P(Asp(Pip)₅₀-co-D-Asp(Pip)₅₀)-Ac

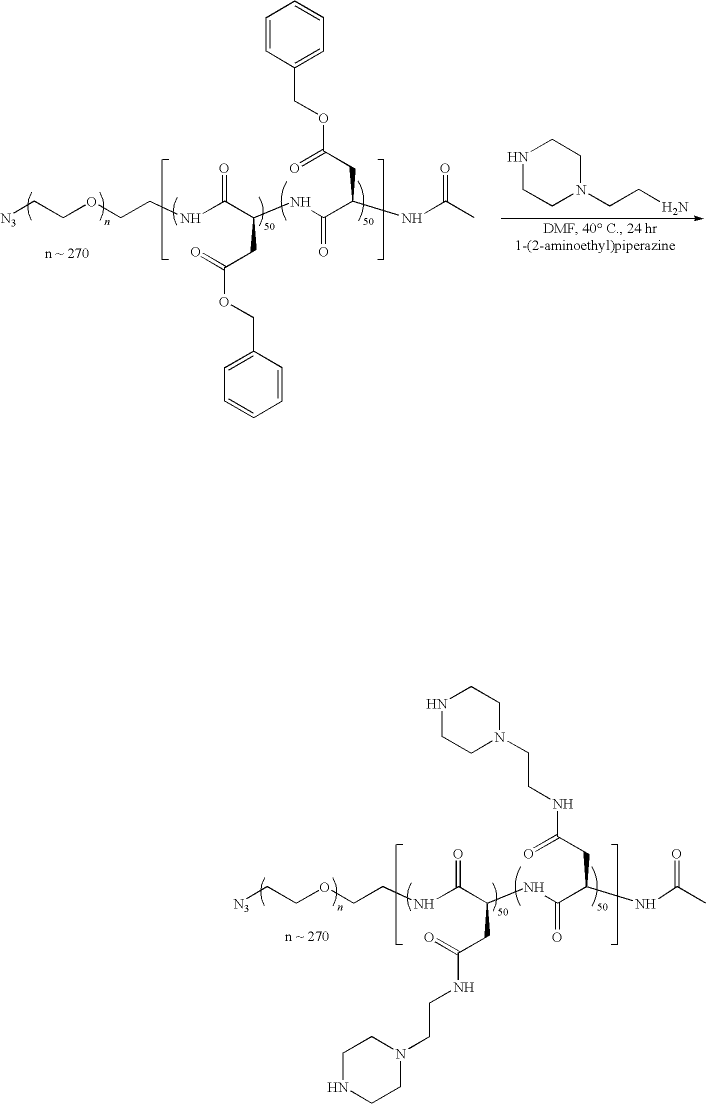

N₃-PEG12K-b-P(Asp(Pip)₅₀-co-D-Asp(Pip)₅₀)-Ac was synthesized as described in Example 38 from N₃-PEG12K-b-P(Asp(OBzl)₅₀-co-D-Asp(AspOBzl)₅₀)-Ac (0.55 g, 16.9 μmol), piperazine (Pip, 8.8 mL, 67.1 mmol) and DMF (dry, 4 mL). A white fluffy powder was recovered. (0.343 g, 58.6% yield) ¹H NMR (D₂O) δ 3.90-3.85, 3.83-3.43, 3.43-3.02, 3.02-2.58 ppm

### Example 44

### Synthesis of N₃-PEG12K-b-P(Asp(DEDET)₅₀-co-D-Asp(DEDET)₅₀)-Ac

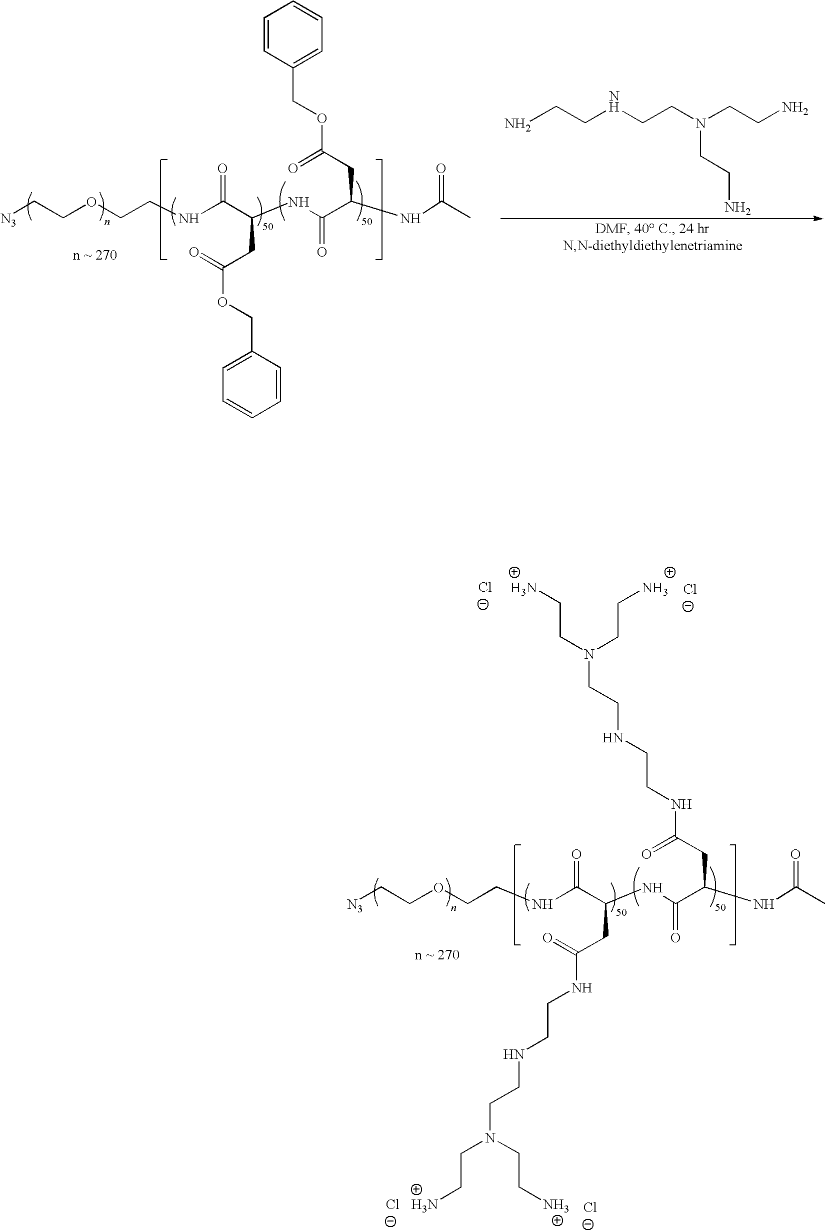

N₃-PEG12K-b-P(Asp(DEDET)₅₀-co-D-Asp(DEDET)₅₀)-Ac was synthesized as described in Example 38 from N₃-PEG12K-b-P(Asp(OBzl)₅₀-co-D-Asp(AspOBzl)₅₀)-Ac (0.55 g, 16.9 μmol), N,N-diethyldiethylenetriamine (DEDET, 5.3 mL, 28.8 mmol) and DMF (dry, 4 mL). A white fluffy powder was recovered. (0.160 g, 36% yield) ¹H NMR (D₂O)

### Example 45

### Synthesis of N₃-PEG12K-b-P(Asp(OBzl)₉₀-co-DLeu₁₀)-Ac

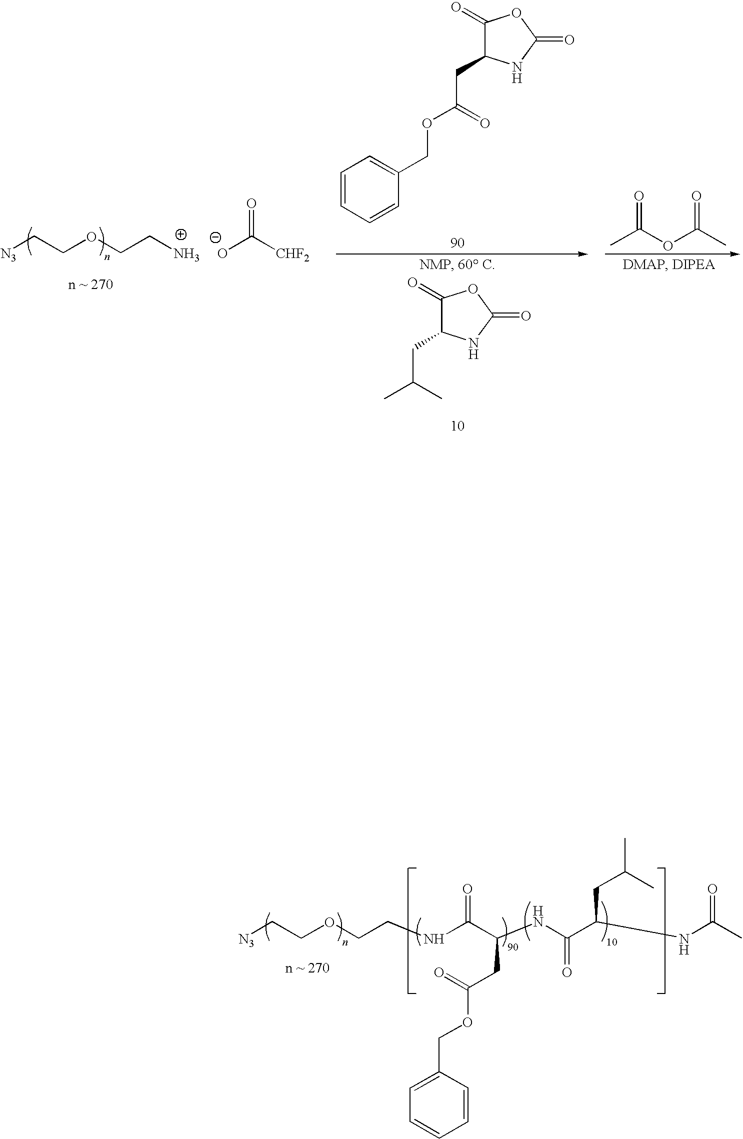

N₃-PEG12k-NH₂/DFA salt, (2 g, 0.17 mmol) was weighed into an oven-dried, round-bottom flask, dissolved in toluene, and dried by azeotropic distillation. Excess toluene was removed under vacuum. Asp(OBzl) NCA (3.90 g, 15.7 mmol) and D-Leu NCA (0.27 g, 1.74 mmol) was added to the flask, the flask was evacuated under reduced pressure, and subsequently backfilled with nitrogen gas (repeated twice). Dry N-methylpyrrolidone (NMP) (40 mL) was introduced by syringe and the solution was heated to 60° C. The reaction mixture was allowed to stir for 3 days at 60° C. under nitrogen gas. The solution was cooled to room temperature and DIPEA (2.0 mL), DMAP (200 mg), and acetic anhydride (2.0 mL) were added. Stirring was continued for 1 hour at room temperature. The polymer was then placed in a 3500 g/mol molecular weight cut-off dialysis bag, dialyzed three times against 0.1 N HCl in methanol, three times against deionized water and freeze-dried. A white solid was obtained (2.441 g, 45% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 46

### Synthesis of N₃-PEG12K-b-P(Asp(OBzl)₇₀-co-DLeu₃₀)-Ac

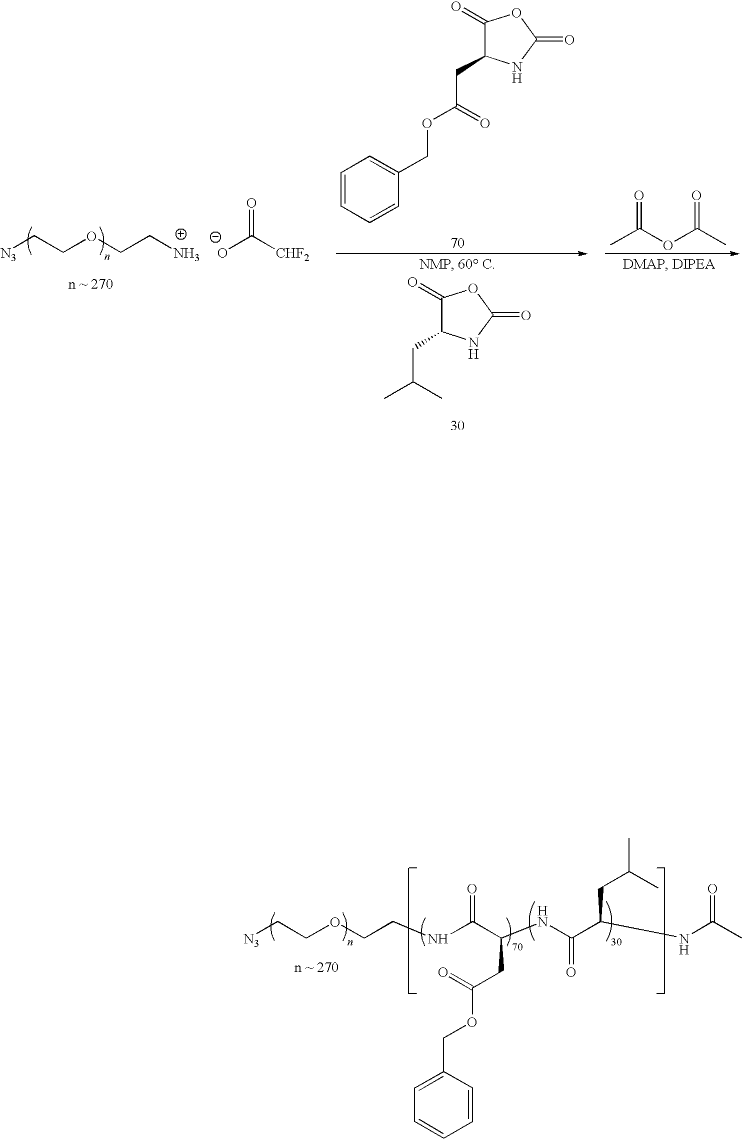

N₃-PEG12K-b-P(Asp(OBzl)₇₀-co-DLeu₃₀)-Ac was synthesized as described in Example 45 from N₃-PEG-NH₂/DFA salt, 12 kDa (2 g, 0.17 mmol), Asp(OBzl) NCA (3.03 g, 12.2 mmol), D-Leu NCA (0.82 g, 5.2 mmol) and 40 mL of NMP. The block copolymer was isolated as a white powder (3.395 g, 67% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 47

### Synthesis of N₃-PEG12K-b-P(Asp(OBzl)₅₀-co-DLeu₅₀)-Ac

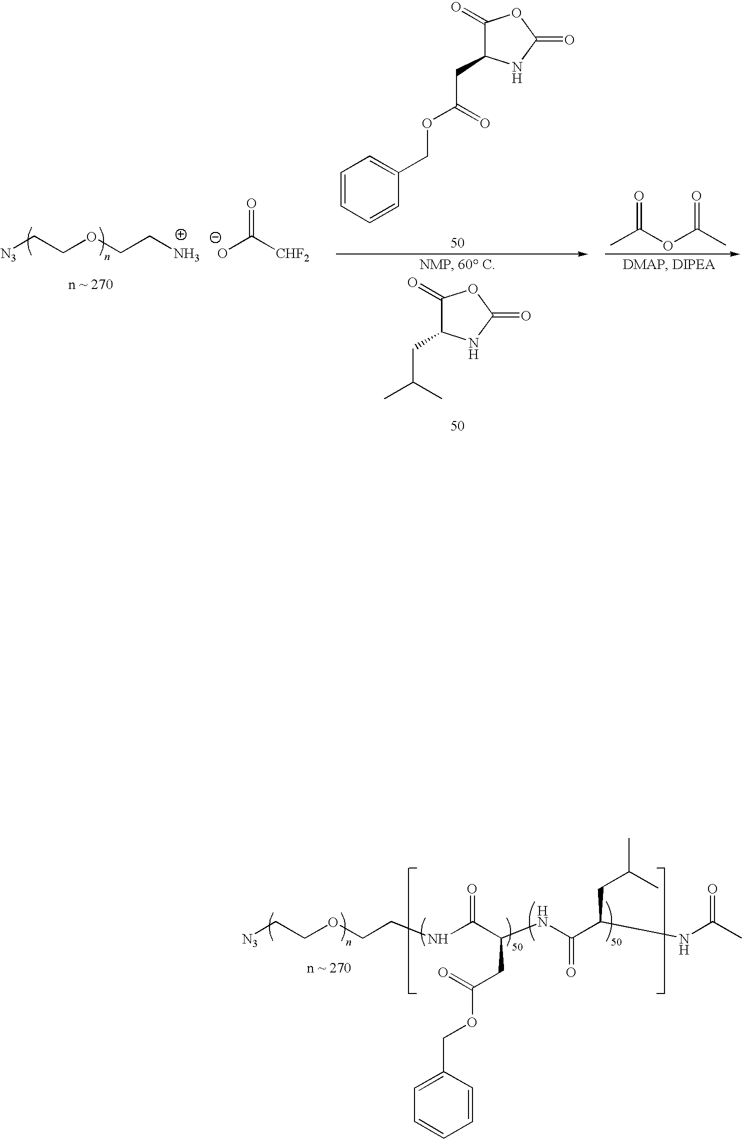

N₃-PEG12K-b-P(Asp(OBzl)₅₀-co-DLeu₅₀)-Ac was synthesized as described in Example 45 from N₃-PEG-NH₂/DFA salt, 12 kDa (2 g, 0.17 mmol), Asp(OBzl) NCA (2.17 g, 8.7 mmol), D-Leu NCA (1.37 g, 8.7 mmol) and 37 mL of NMP. The block copolymer was isolated as a white powder (2.887 g, 60.5% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 48

### Synthesis of N₃-PEG12K-b-P(Asp(OBzl)₁₈₀-co-DLeu₂₀)-Ac

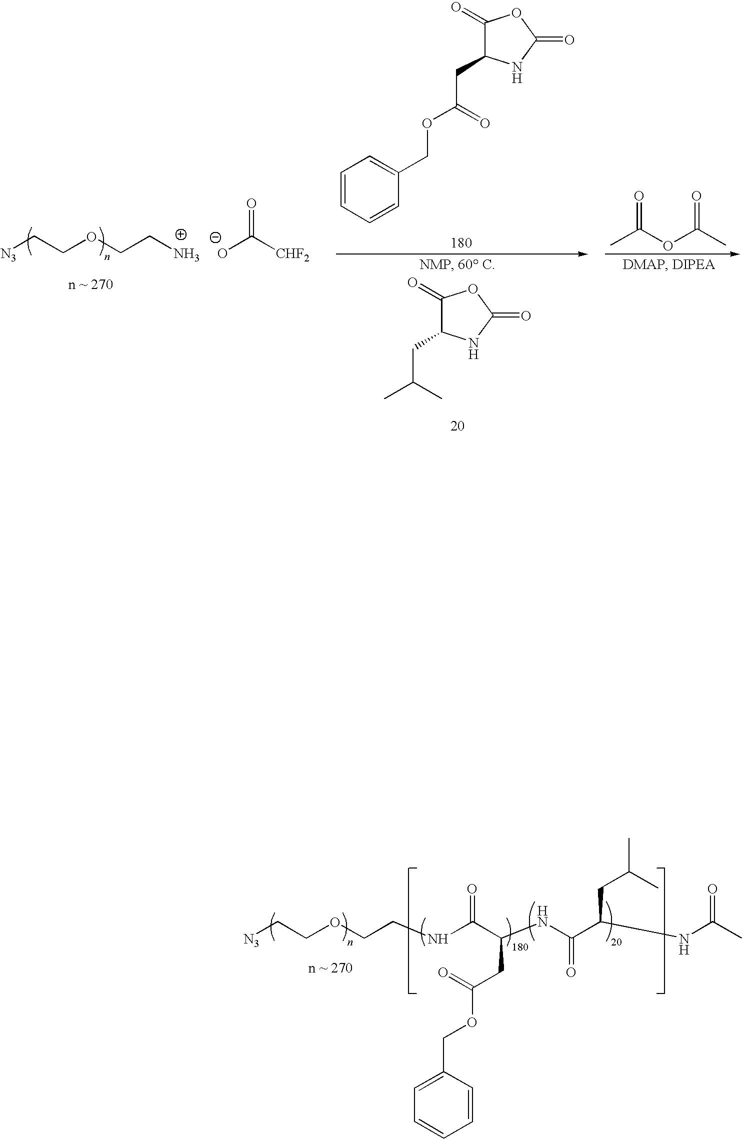

N₃-PEG12K-b-P(Asp(OBzl)₁₈₀-co-DLeu₂₀)-Ac was synthesized as described in Example 45 from N₃-PEG-NH₂/DFA salt, 12 kDa (1 g, 0.087 mmol), Asp(OBzl) NCA (3.90 g, 15.6 mmol), D-Leu NCA (0.27 g, 17.4 mmol) and 35 mL of NMP. The block copolymer was isolated as a white powder (1.685 g, 38% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 49

### Synthesis of N₃-PEG12K-b-P(Asp(OBzl)₁₄₀-co-DLeu₆₀)-Ac

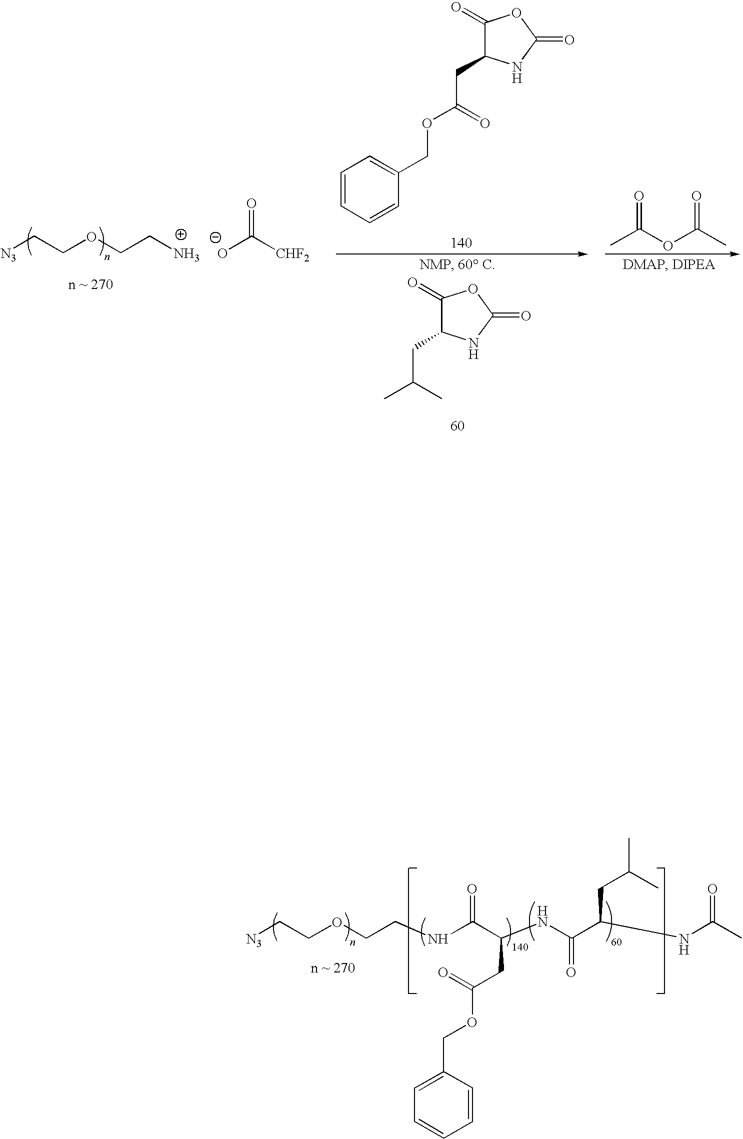

N₃-PEG12K-b-P(Asp(OBzl)₁₄₀-co-DLeu₆₀)-Ac was synthesized as described in Example 45 from N₃-PEG-NH₂/DFA salt, 12 kDa (1 g, 0.087 mmol), Asp(OBzl) NCA (3.03 g, 12.2 mmol), D-Leu NCA (0.82 g, 5.2 mmol) and 40 mL of NMP. The block copolymer was isolated as a white powder (1.784 g, 44% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm.

### Example 50

### Synthesis of N₃-PEG12K-b-P(Asp(OBzl)₁₀₀-co-DLeu₁₀₀)-Ac

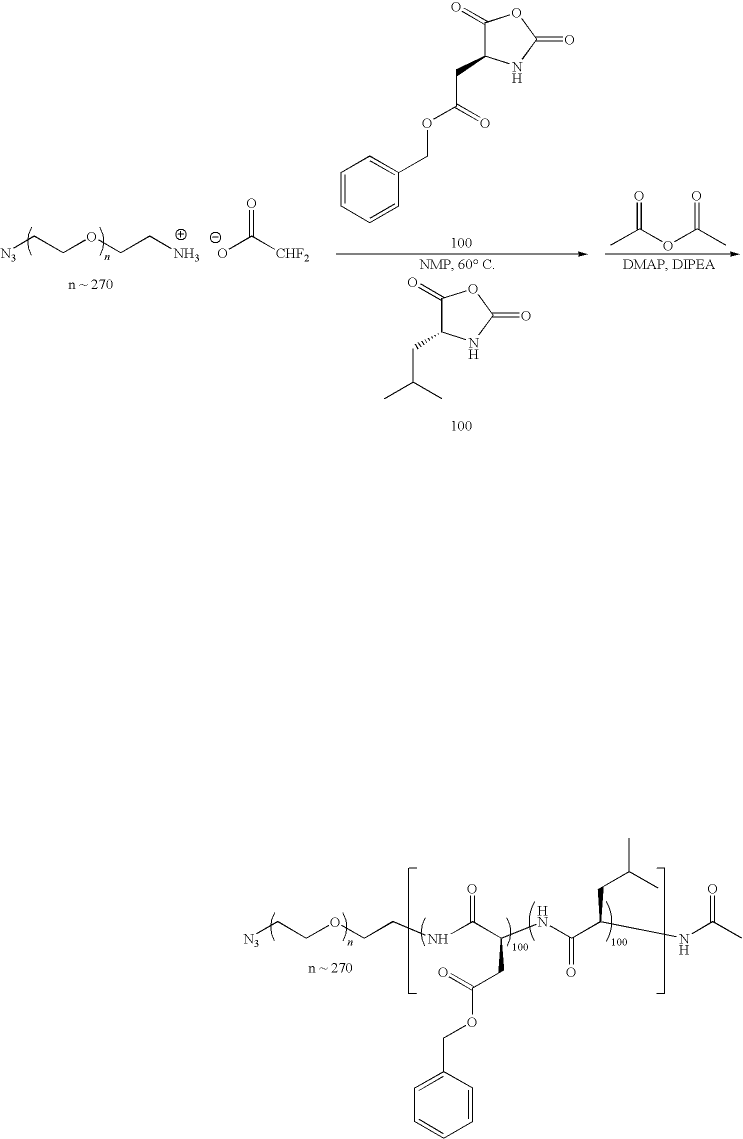

N₃-PEG12K-b-P(Asp(OBzl)₁₀₀-co-DLeu₁₀₀)-Ac was synthesized as described in Example 45 from N₃-PEG-NH₂/DFA salt, 12 kDa (1 g, 0.087 mmol), Asp(OBzl) NCA (2.17 g, 8.7 mmol), D-Leu NCA (1.37 g, 8.7 mmol) and 30 mL of NMP. The block copolymer was isolated as a white powder (2.792 g, 74% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 51

### Synthesis of N₃-PEG12K-b-P(Asp(OBzl)₁₉₀-co-DLeu₁₀)-Ac

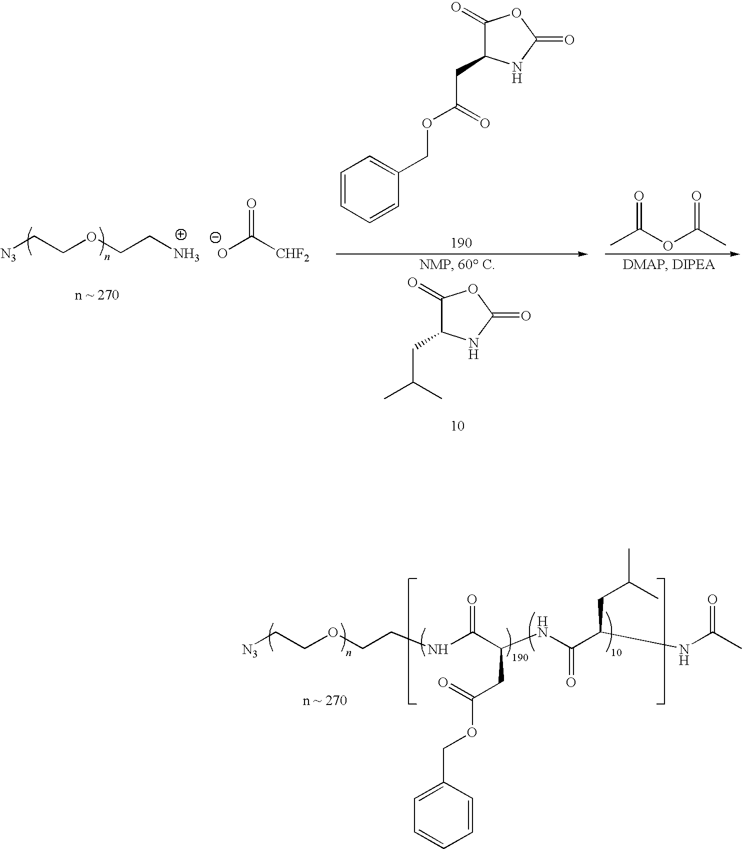

N₃-PEG12K-b-P(Asp(OBzl)₁₉₀-co-DLeu₁₀)-Ac was synthesized as described in Example 45 from N₃-PEG-NH₂/DFA salt, 12 kDa (1 g, 0.087 mmol), Asp(OBzl) NCA (4.12 g, 16.5 mmol), D-Leu NCA (0.14 g, 0.87 mmol) and 35 mL of NMP. The block copolymer was isolated as a white powder (1.83 g, 40.7% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 52

### Synthesis of N₃-PEG12K-b-P(Asp(OBzl)₁₇₀-co-DLeu₃₀)-Ac

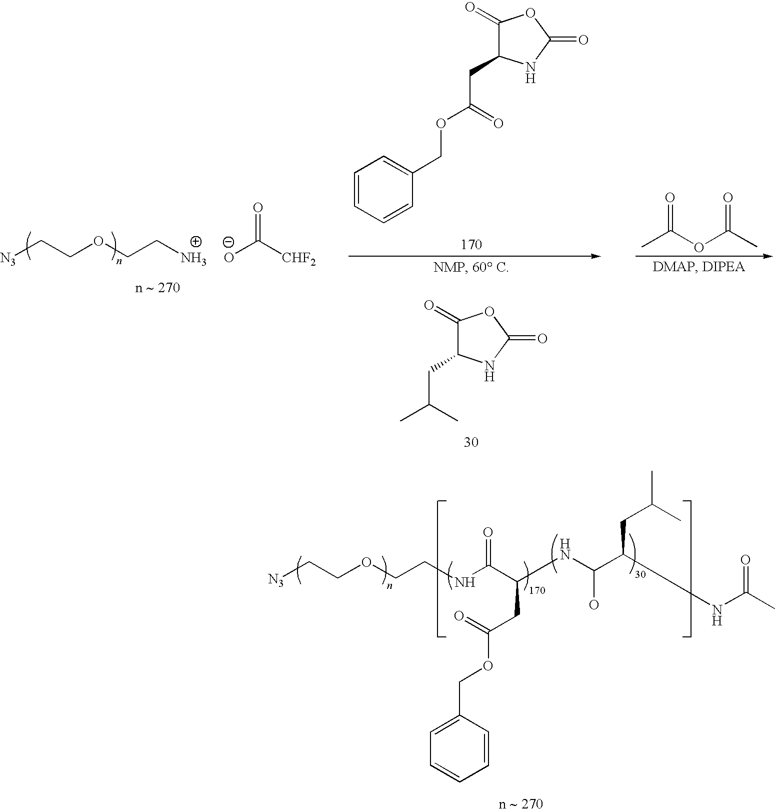

N₃-PEG12K-b-P(Asp(OBzl)₁₇₀-co-DLeu₃₀)-Ac was synthesized as described in Example 45 from N₃-PEG-NH₂/DFA salt, 12 kDa (1 g, 0.087 mmol), Asp(OBzl) NCA (3.68 g, 14.8 mmol), D-Leu NCA (0.41 g, 2.6 mmol) and 35 mL of NMP. The block copolymer was isolated as a white powder (1.38 g, 32% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 53

### Synthesis of N₃-PEG12K-b-P(Asp(OBzl)₁₅₀-co-DLeu₅₀)-Ac

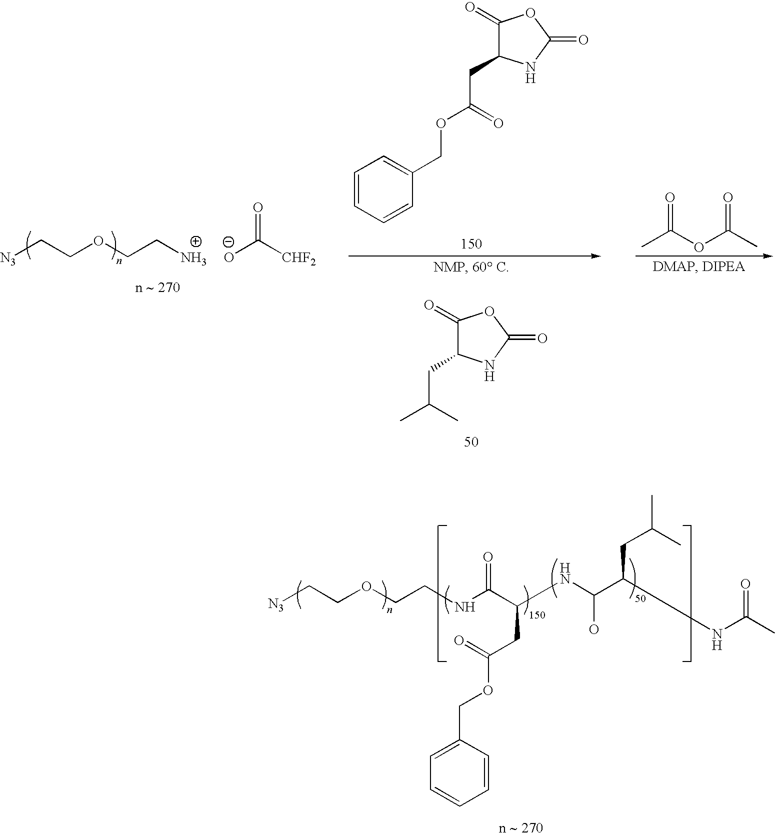

N₃-PEG12K-b-P(Asp(OBzl)₁₅₀-co-DLeu₅₀)-Ac was synthesized as described in Example 45 from N₃-PEG-NH₂/DFA salt, 12 kDa (1 g, 0.087 mmol), Asp(OBzl) NCA (3.25 g, 13 mmol), D-Leu NCA (0.68 g, 4.3 mmol) and 35 mL of NMP. The block copolymer was isolated as a white powder (1.82 g, 43.7% yield). ¹H NMR (d₆-DMSO) δ 8.43-8.07, 7.45-7.16, 5.01, 4.61, 4.3-4.1, 3.68-3.38, 2.94-2.75, 2.75-2.5, 1.57-1.33, 0.84-0.63 ppm

### Example 54

### Synthesis of N₃-PEG12K-b-P(Asp(DET)₉₀-co-DLeu₁₀)-Ac

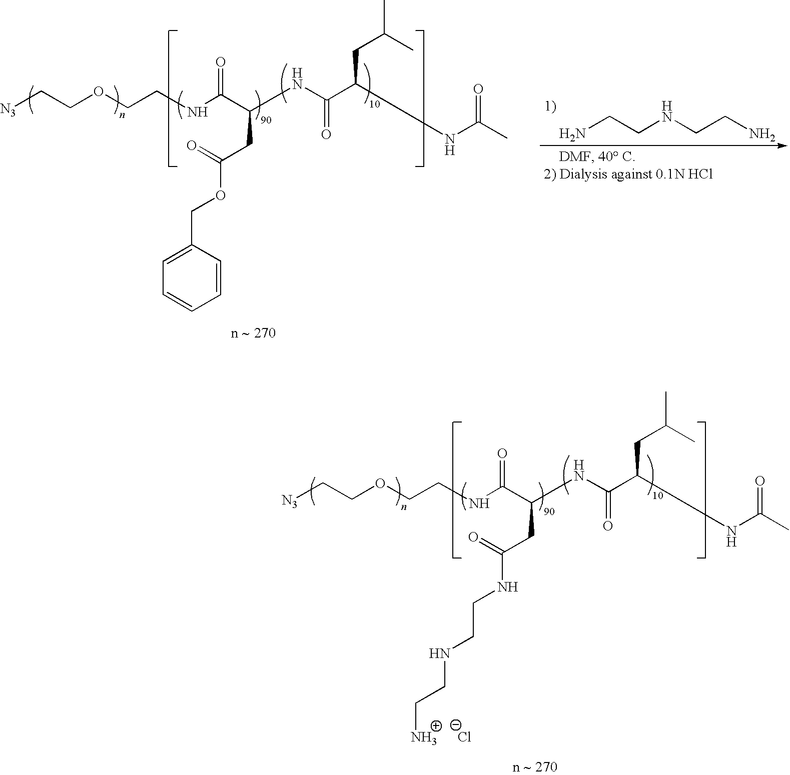

N₃-PEG12K-b-P(Asp(DET)₉₀-co-DLeu₁₀)-Ac was synthesized as described in Example 38 from N₃-PEG12K-b-P(Asp(OBzl)₉₀-co-DLeu₁₀)-Ac (1 g, 32.1 μmol), diethylenetriamine (DET, vacuum distilled from CaH₂, 5 mL, 46.5 mmol) and DMF (dry, 5 mL). A white fluffy powder was recovered. (0.4505 g, 41.3% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 55

### Synthesis of N₃-PEG12K-b-P(Asp(DET)₇₀-co-DLeu₃₀)-Ac

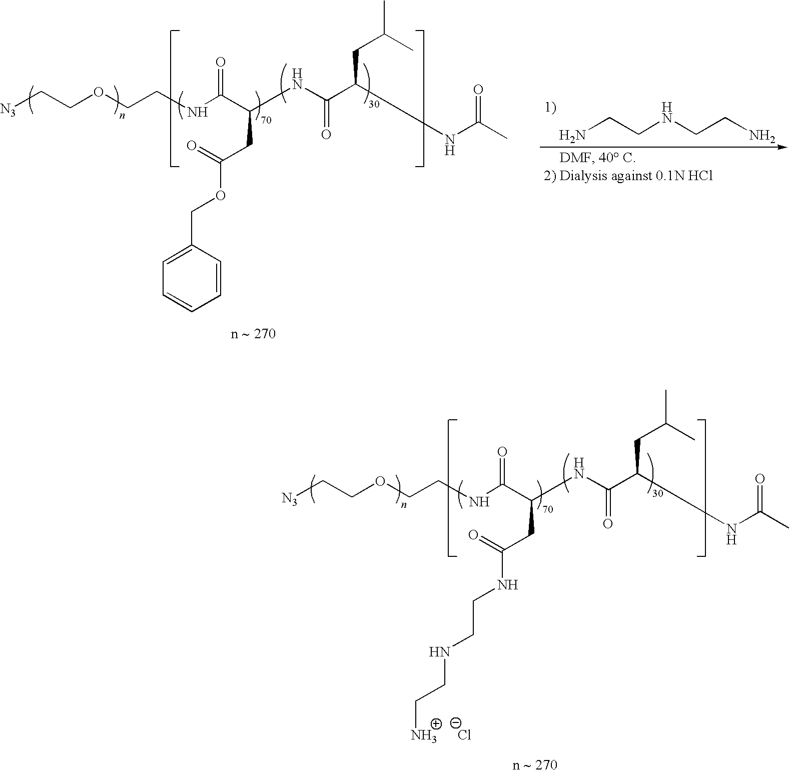

N₃-PEG12K-b-P(Asp(DET)₇₀-co-DLeu₃₀)-Ac was synthesized as described in Example 38 from N₃-PEG12K-b-P(Asp(OBzl)₇₀-co-DLeu₃₀)-Ac (1 g, 34.1 μmol), diethylenetriamine (DET, vacuum distilled from CaH₂, 5 mL, 46.5 mmol) and DMF (dry, 5 mL). A white fluffy powder was recovered. (0.5099 g, 47.4% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 56

### Synthesis of N₃-PEG12K-b-P(Asp(DET)₅₀-co-DLeu₅₀)-Ac

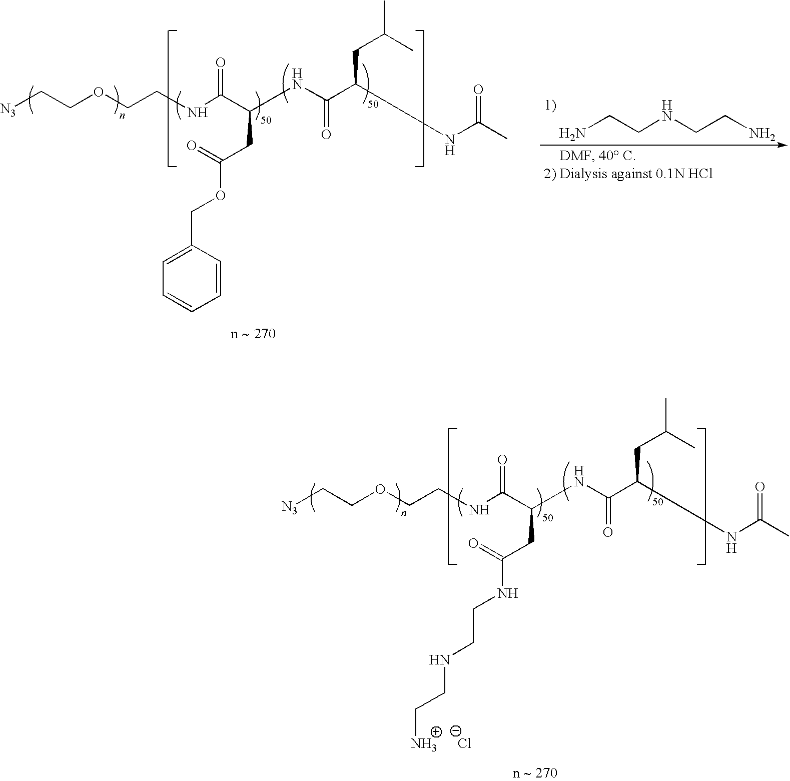

N₃-PEG12K-b-P(Asp(DET)₅₀-co-DLeu₅₀)-Ac was synthesized as described in Example 38 from N₃-PEG12K-b-P(Asp(OBzl)₅₀-co-DLeu₅₀)-Ac (1 g, 36.5 μmol), diethylenetriamine (DET, vacuum distilled from CaH₂, 5 mL, 46.5 mmol) and DMF (dry, 5 mL). A white fluffy powder was recovered. (0.789 g, 74.5% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 57

### Synthesis of N₃-PEG12K-b-P(Asp(DET)₁₈₀-co-DLeu₂₀)-Ac

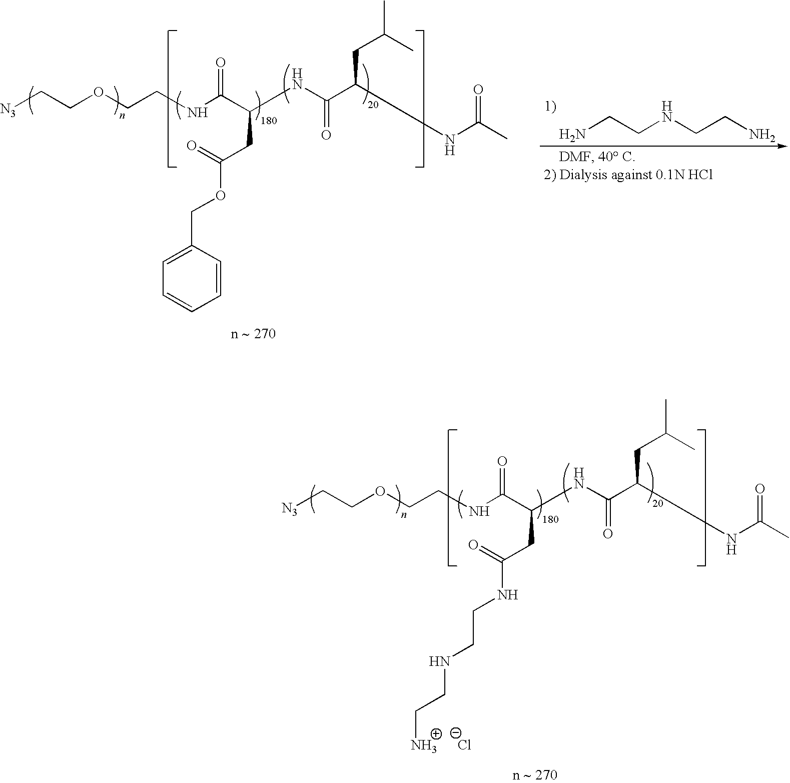

N₃-PEG12K-b-P(Asp(DET)₁₈₀-co-DLeu₂₀)-Ac was synthesized as described in Example 38 from N₃-PEG12K-b-P(Asp(OBzl)₁₈₀-co-DLeu₂₀)-Ac (1 g, 19.7 μmol), diethylenetriamine (DET, vacuum distilled from CaH₂, 5 mL, 46.5 mmol) and DMF (dry, 5 mL). A white fluffy powder was recovered. (0.4788 g, 43.0% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 58

### Synthesis of N₃-PEG12K-b-P(Asp(DET)₁₄₀-co-DLeu₆₀)-Ac

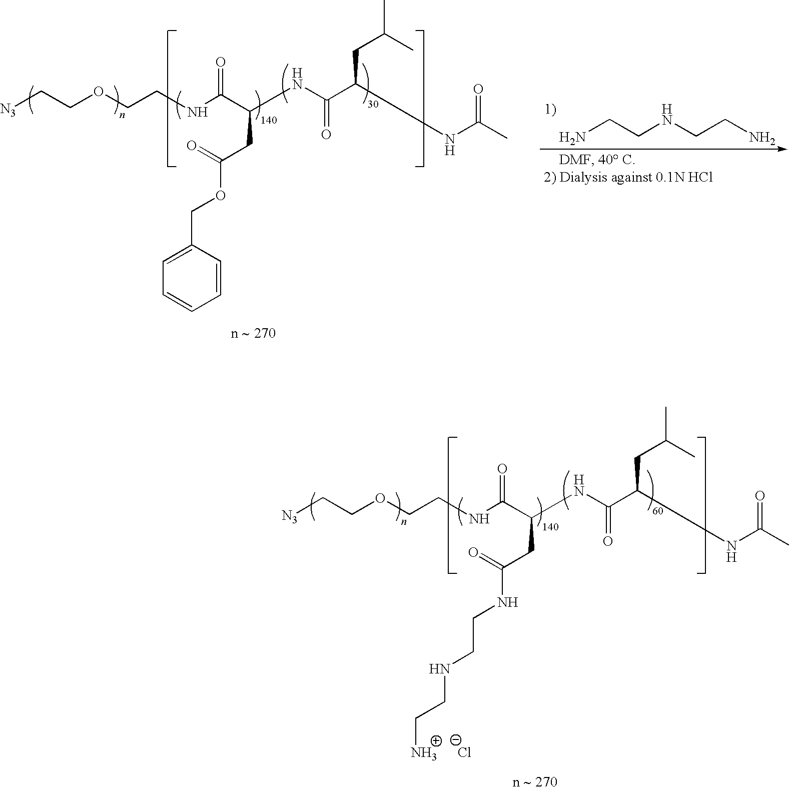

N₃-PEG12K-b-P(Asp(DET)₁₄₀-co-DLeu₆₀)-Ac was synthesized as described in Example 38 from N₃-PEG12K-b-P(Asp(OBzl)₁₄₀-co-DLeu₆₀)-Ac (1 g, 21.3 μmol), diethylenetriamine (DET, vacuum distilled from CaH₂, 5 mL, 46.5 mmol) and DMF (dry, 5 mL). A white fluffy powder was recovered. (0.5635 g, 51.5% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 59

### Synthesis of N₃-PEG12K-b-P(Asp(DET)₁₀₀-co-DLeu₁₀₀)-Ac

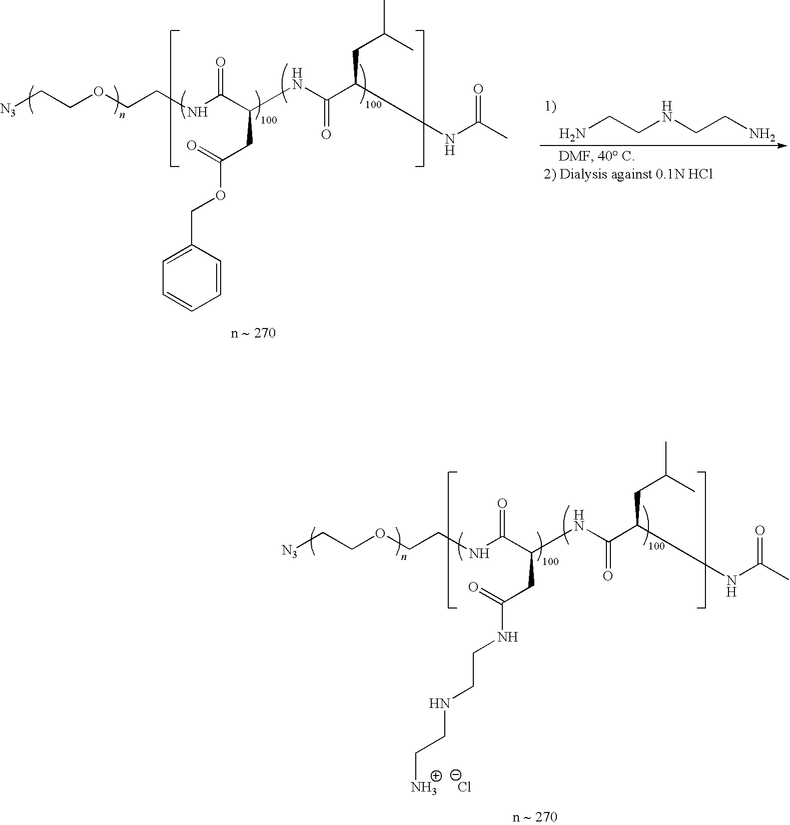

N₃-PEG12K-b-P(Asp(DET)₁₀₀-co-DLeu₁₀₀)-Ac was synthesized as described in Example 38 from N₃-PEG12K-b-P(Asp(OBzl)₁₀₀-co-DLeu₁₀₀)-Ac (1 g, 23.1 μmol), diethylenetriamine (DET, vacuum distilled from CaH₂, 5 mL, 46.5 mmol) and DMF (dry, 5 mL). A white fluffy powder was recovered. (0.8068 g, 75.1% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 60

### Synthesis of N₃-PEG12K-b-P(Asp(DET)₁₉₀-co-DLeu₁₀)-Ac

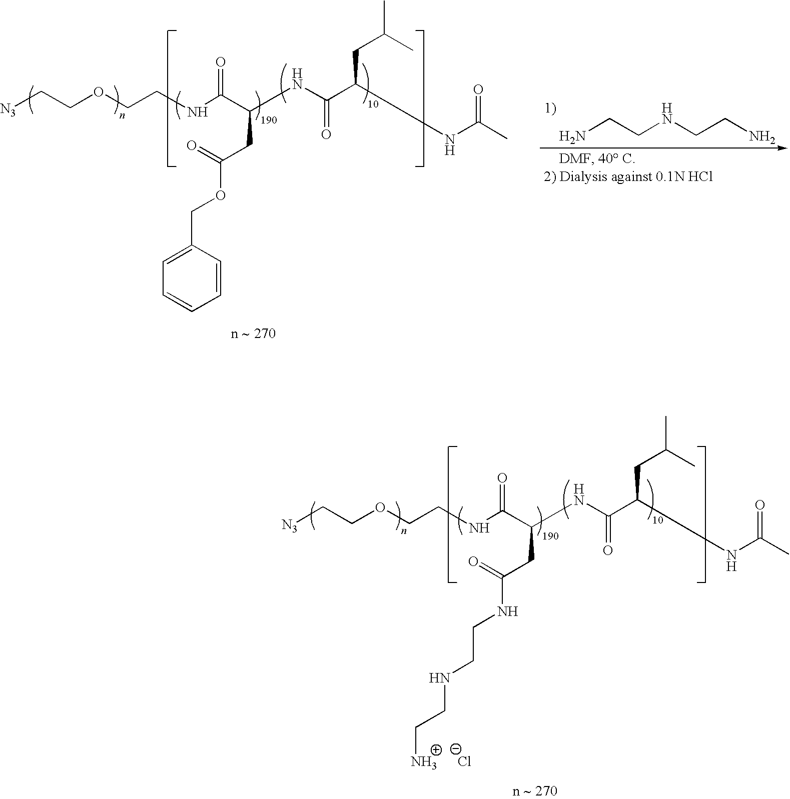

N₃-PEG12K-b-P(Asp(DET)₁₉₀-co-DLeu₁₀)-Ac was synthesized as described in Example 38 from N₃-PEG12K-b-P(Asp(OBzl)₁₉₀-co-DLeu₁₀)-Ac (1 g, 19.4 μmol), diethylenetriamine (DET, vacuum distilled from CaH₂, 19.8 mL, 184 mmol) and DMF (dry, 10 mL). A white fluffy powder was recovered. (0.528 g, 47.3% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 61

### Synthesis of N₃-PEG12K-b-P(Asp(DET)₁₇₀-co-DLeu₃₀)-Ac

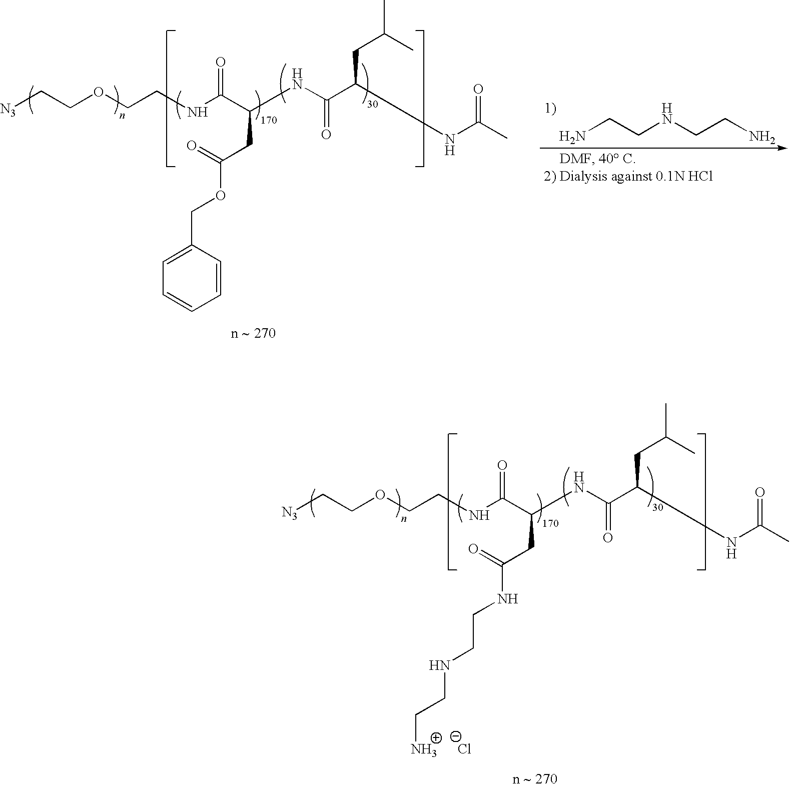

N₃-PEG12K-b-P(Asp(DET)₁₇₀-co-DLeu₃₀)-Ac was synthesized as described in Example 38 from N₃-PEG12K-b-P(Asp(OBzl)₁₇₀-co-DLeu₃₀)-Ac (0.998 g, 20.0 μmol), diethylenetriamine (DET, vacuum distilled from CaH₂, 18.3 mL, 170.3 mmol) and DMF (dry, 10 mL). A white fluffy powder was recovered. (0.501 g, 45.1% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 62

### Synthesis of N₃-PEG12K-b-P(Asp(DET)₁₆₀-co-DLeu₄₀)-Ac

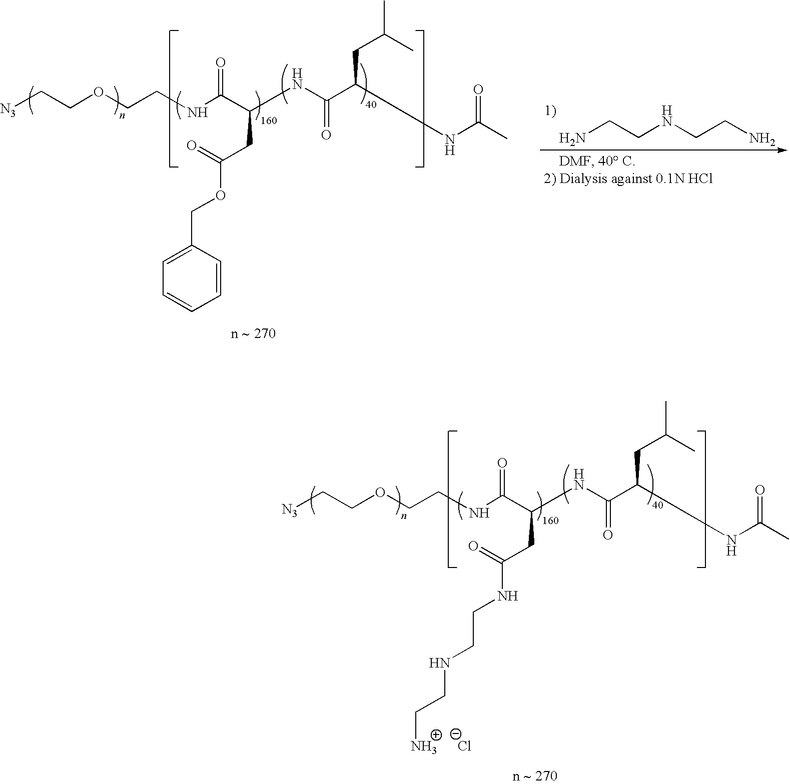

N₃-PEG12K-b-P(Asp(DET)₁₆₀-co-DLeu₄₀)-Ac was synthesized as described in Example 38 from N₃-PEG12K-b-P(Asp(OBzl)₁₆₀-co-DLeu₄₀)-Ac (0.997 g, 20.4 μmol), diethylenetriamine (DET, vacuum distilled from CaH₂, 17.6 mL, 163.8 mmol) and DMF (dry, 10 mL). A white fluffy powder was recovered. (0.241 g, 21.9% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 63

### Synthesis of N₃-PEG12K-b-P(Asp(DET)₁₅₀-co-DLeu₅₀)-Ac

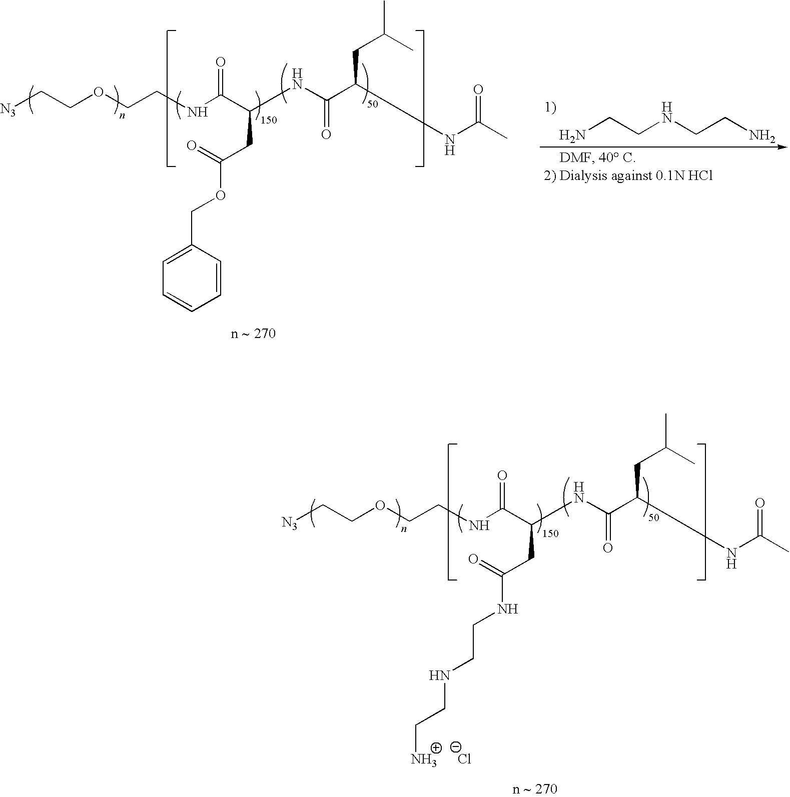

N₃-PEG12K-b-P(Asp(DET)₁₅₀-co-DLeu₅₀)-Ac was synthesized as described in Example 38 from N₃-PEG12K-b-P(Asp(OBzl)₁₅₀-co-DLeu₅₀)-Ac (0.996 g, 20.8 μmol), diethylenetriamine (DET, vacuum distilled from CaH₂, 16.8 mL, 156.3 mmol) and DMF (dry, 10 mL). A white fluffy powder was recovered. (0.600 g, 54.5% yield) ¹H NMR (D₂O) δ 4.40-4.16, 3.90-3.85, 3.85-3.43, 3.43-3.28, 3.28-3.11, 3.03-2.58, 1.74-1.39, 1.00-0.75 ppm

### Example 64

### Synthesis of UPAR-PEG12K-b-P(Asp(OBzl)₉₀-co-DLeu₁₀)-Ac

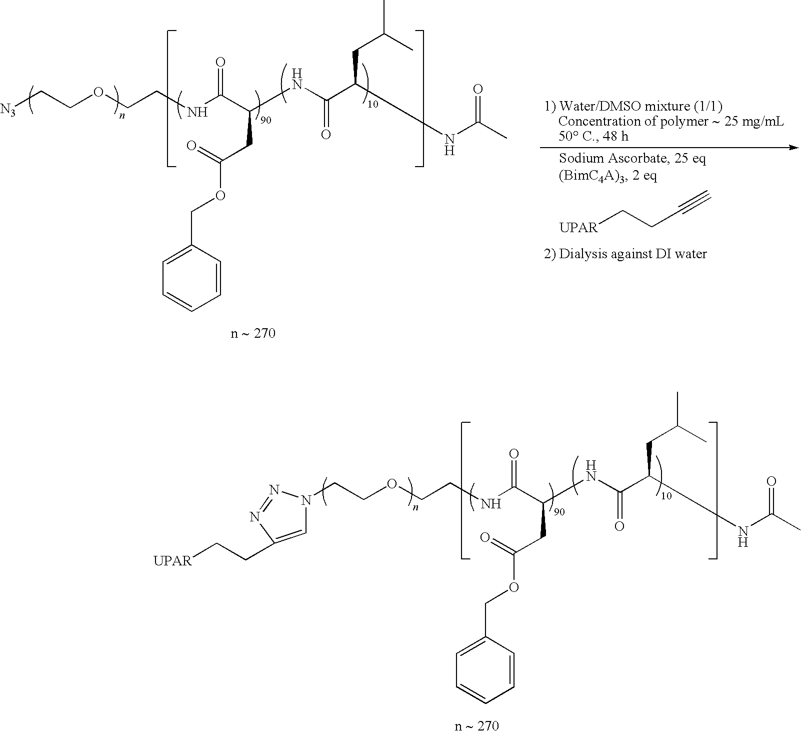

N₃-PEG12K-b-P(Asp(OBzl)₉₀-co-DLeu₁₀)-Ac (296.93 mg, 9.55 μmol), UPAR-Alkyne (12.27 mg, 12.9 μmol), sodium ascorbate (62.19 mg, 242 mmol), (BimC4A)3 (18.9 mg, 19.3 μmol), CuSO₄.5H₂O (2.4 mg, 9.6 μmol), DMSO (6 mL) and water (6 mL) were added into a 20 mL vial, capped and stirred for 48 hr at 50° C. The light brown solution was dialyzed (3500 MWCO bag) 3 times against DI water with EDTA (15 g/L) and 2 times against DI water. The solution was freeze-dried and an off-white powder was obtained. (275.01 mg, 90% yield). ¹H NMR (D₂O) δ 8.17, 7.84, 7.45-7.31, 4.61-4.23, 4.05-3.34, 2.98, 2.65, 2.46-2.26, 2.16-1.86, 1.86-1.50, 1.46-1.31, 0.96-0.78 ppm

### Example 65

### Synthesis of UPAR-PEG12K-b-P(Asp(DET)₉₀-co-DLeu₁₀)-Ac

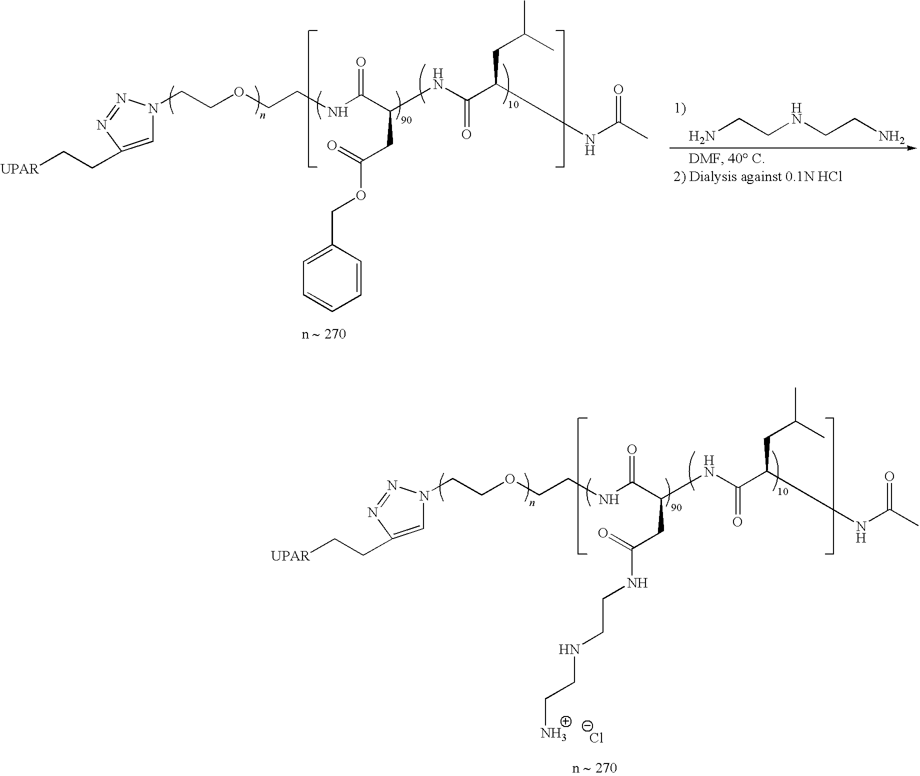

UPAR-PEG12K-b-P(Asp(DET)₉₀-co-DLeu₁₀)-Ac was synthesized as described in Example 38 from N₃-PEG12K-b-P(Asp(OBzl)₉₀-co-DLeu₁₀)-Ac (0.2461 g, 7.7 μmol), diethylenetriamine (DET, vacuum distilled from CaH₂, 3.71 mL, 34.5 mmol) and DMF (dry, 3.7 mL). A white fluffy powder was recovered. (0.264 g, 98% yield) ¹H NMR (D₂O) δ 8.42, 7.82, 4.58, 4.39-4.20, 4.01, 3.95-3.78, 3.78-3.66, 3.66-3.46, 3.46-3.31, 3.31-3.16, 3.09-2.56, 2.36-2.23, 2.10-1.86, 1.79-1.42, 0.95-0.79 ppm.

### Example 66

### Synthesis of UPAR-PEG12K-b-P(Asp(OBzl)₁₈₀-co-DLeu₂₀)-Ac

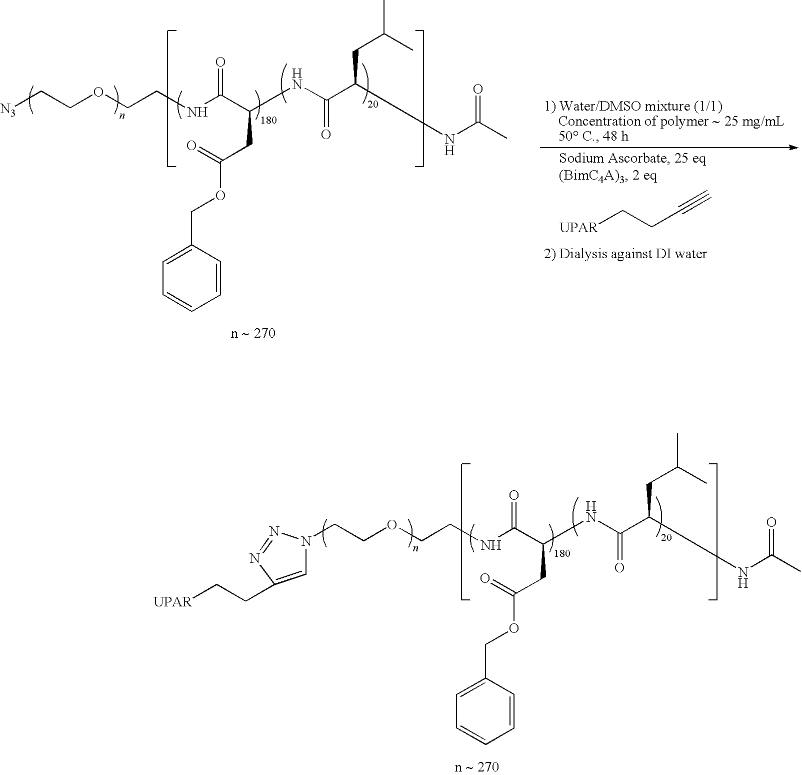

N₃-PEG12K-b-P(Asp(OBzl)₁₈₀-co-DLeu₂₀)-Ac (301.37 mg, 5.94 μmol), UPAR-Alkyne (7.93 mg, 8.3 μmol), sodium ascorbate (44.6 mg, 225 mmol), (BimC4A)3 (9.72 mg, 13.7 μmol), CuSO₄.5H₂O (1.5 mg, 6 μmol), DMSO (6 mL) and water (6 mL) were added into a 20 mL vial, capped and stirred for 48 hr at 50° C. The light brown solution was dialyzed (3500 MWCO bag) 3 times against DI water with EDTA (15 g/L) and 2 times against DI water. The solution was freeze-dried and an off-white powder was obtained. (280.02 mg, 91.3% yield). ¹H NMR (D₂O) δ 8.17, 7.84, 7.45-7.31, 4.61-4.23, 4.05-3.34, 2.98, 2.65, 2.46-2.26, 2.16-1.86, 1.86-1.50, 1.46-1.31, 0.96-0.78 ppm

### Example 67

### Synthesis of UPAR-PEG12K-b-P(Asp(DET)₁₈₀-co-DLeu₂₀)-Ac

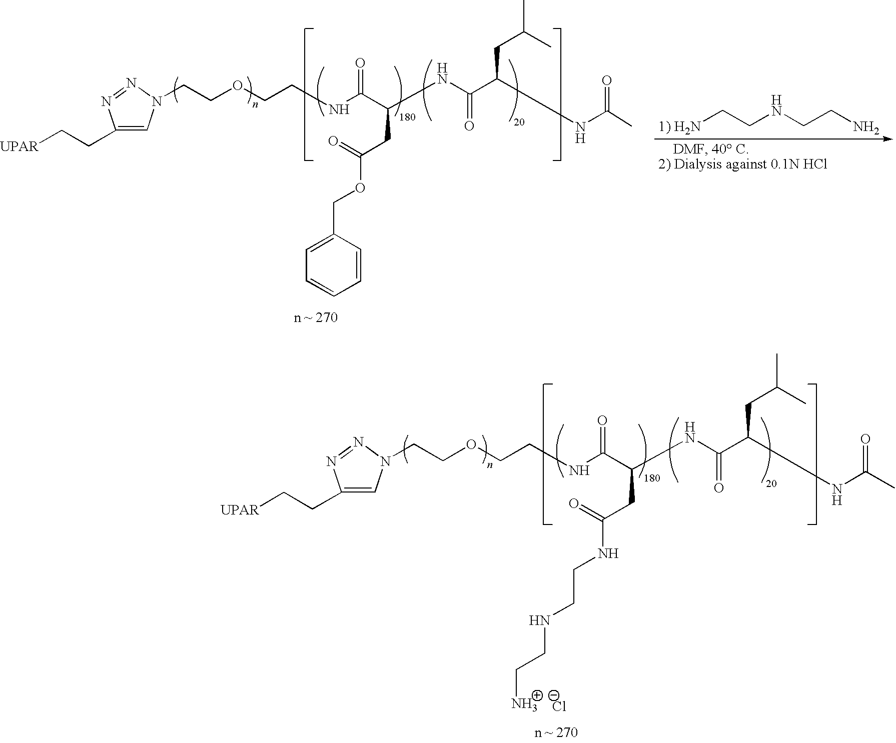

UPAR-PEG12K-b-P(Asp(DET)₁₈₀-co-DLeu₂₀)-Ac was synthesized as described in Example 38 from N₃-PEG12K-b-P(Asp(OBzl)₁₈₀-co-DLeu₂₀)-Ac (0.2529 g, 4.9 μmol), diethylenetriamine (DET, vacuum distilled from CaH₂, 4.7 mL, 43.7 mmol) and DMF (dry, 4.7 mL). A white fluffy powder was recovered. (0.253 g, 90% yield) ¹H NMR (D₂O) δ 8.42, 7.82, 4.58, 4.39-4.20, 4.01, 3.95-3.78, 3.78-3.66, 3.66-3.46, 3.46-3.31, 3.31-3.16, 3.09-2.56, 2.36-2.23, 2.10-1.86, 1.79-1.42, 0.95-0.79 ppm.

### Example 68

### Synthesis of UPAR-PEG12K-b-P(Asp(OBzl)₁₄₀-co-DLeu₆₀)-Ac

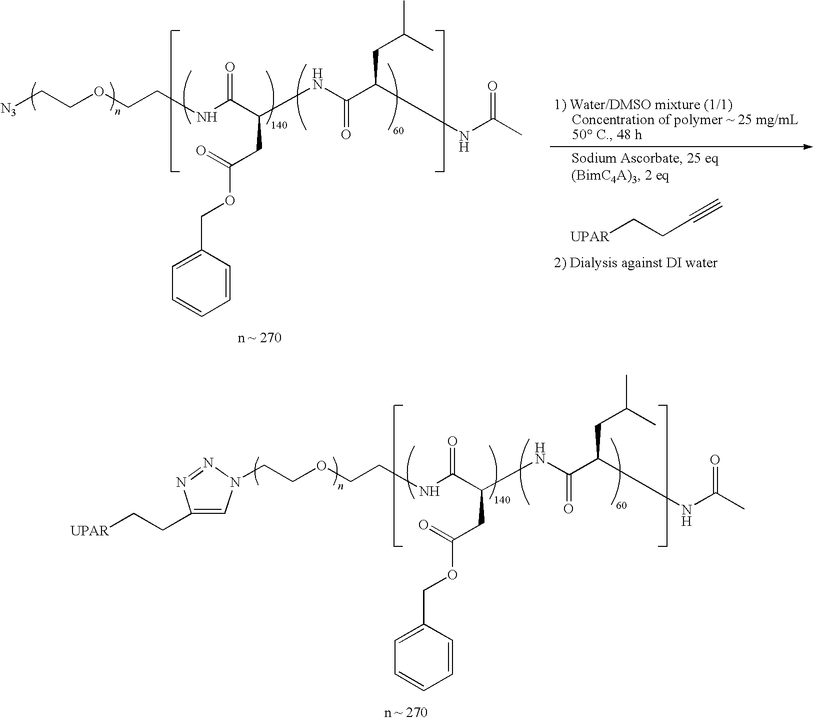

N₃-PEG12K-b-P(Asp(OBzl)₁₄₀-co-DLeu₆₀)-Ac (289.57 mg, 6.2 μmol), UPAR-Alkyne (10.07 mg, 10.6 μmol), sodium ascorbate (37.99 mg, 192 mmol), (BimC4A)3 (12.58 mg, 17.7 μmol), CuSO₄.5H₂O (1.6 mg, 6.4 μmol), DMSO (6 mL) and water (6 mL) were added into a 20 mL vial, capped and stirred for 48 hr at 50° C. The light brown solution was dialyzed (3500 MWCO bag) 3 times against DI water with EDTA (15 g/L) and 2 times against DI water. The solution was freeze-dried and an off-white powder was obtained. (278.43 mg, 94.2% yield). ¹H NMR (D₂O) δ 8.17, 7.84, 7.45-7.31, 4.61-4.23, 4.05-3.34, 2.98, 2.65, 2.46-2.26, 2.16-1.86, 1.86-1.50, 1.46-1.31, 0.96-0.78 ppm

### Example 69

### Synthesis of UPAR-PEG12K-b-P(Asp(DET)₁₄₀-co-DLeu₆₀)-Ac

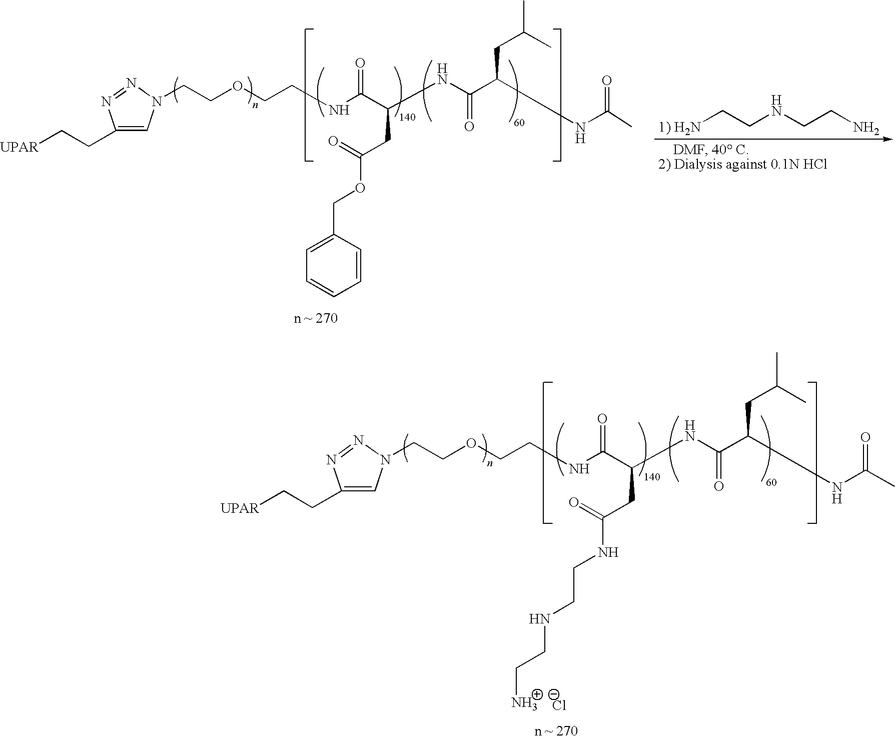

UPAR-PEG12K-b-P(Asp(DET)₁₄₀-co-DLeu₆₀)-Ac was synthesized as described in Example 38 from N₃-PEG12K-b-P(Asp(OBzl)₁₄₀-co-DLeu₆₀)-Ac (0.2767 g, 5.8 μmol), diethylenetriamine (DET, vacuum distilled from CaH₂, 4.3 mL, 40.0 mmol) and DMF (dry, 4.3 mL). A white fluffy powder was recovered. (0.265 g, 87.6% yield) ¹H NMR (D₂O) δ 8.42, 7.82, 4.58, 4.39-4.20, 4.01, 3.95-3.78, 3.78-3.66, 3.66-3.46, 3.46-3.31, 3.31-3.16, 3.09-2.56, 2.36-2.23, 2.10-1.86, 1.79-1.42, 0.95-0.79 ppm

### Example 70

### Synthesis of N3-PEG12K-b-P(Asp(FITC)₁-co-Asp(DET)₈₉-co-DLeu₁₀)-Ac

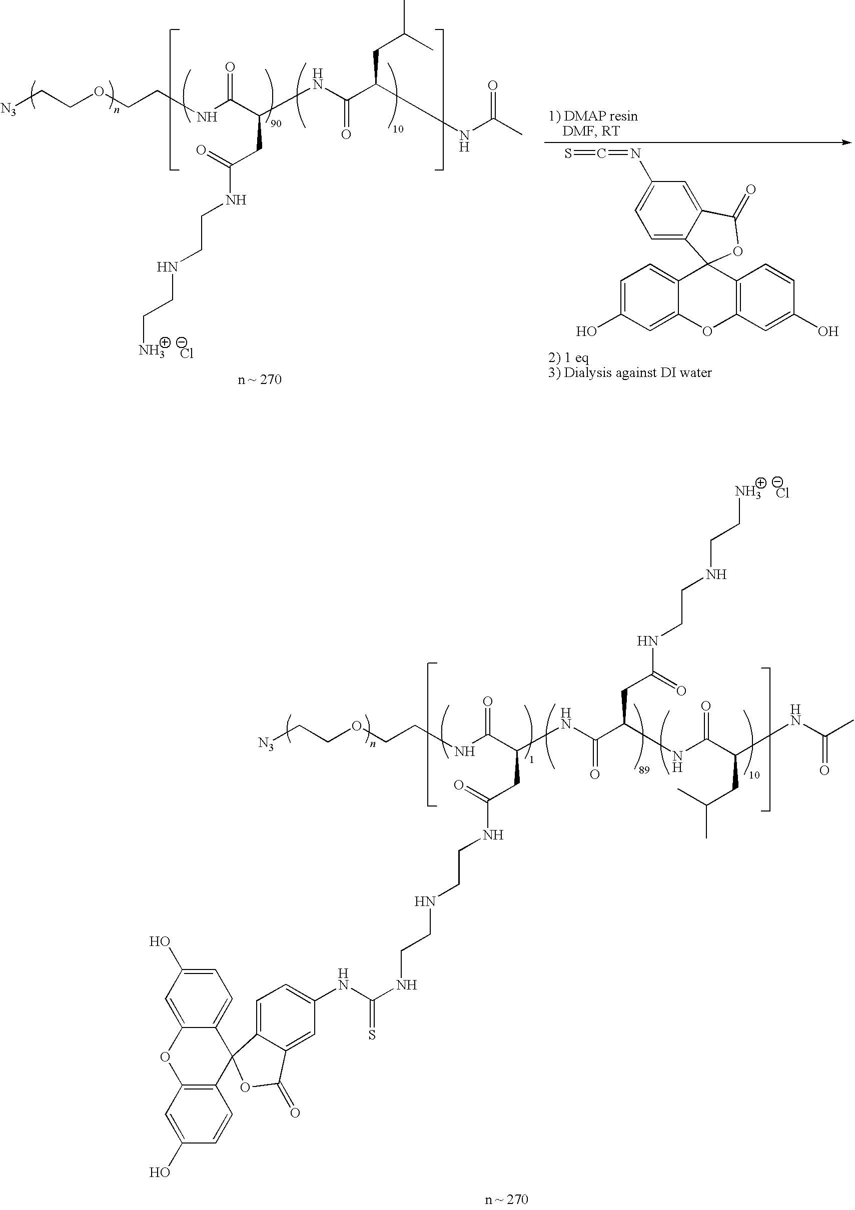

N₃-PEG12K-b-P(Asp(DET)₉₀-co-DLeu₁₀)-Ac (100 mg, 2.95 μmol) was weighed into an oven-dried two neck round bottom flask and three vacuum/N2 cycles were applied. DMAP resin (1.47 mmol DMAP/g resin, 4 mg, 5.88 μmol), FITC (1.15 mg, 2.95 μmol) and DMSO (4 mL) were introduced into the reaction flask and were left reacting at room temperature overnight. The solution was then filtered through a Whatman filter paper #2, placed in a 3500 molecular weight cut-off dialysis bag, dialyzed 5 times against deionized water. The solution was filtered through a 0.45 μm filter and freeze dried. The polymer was recovered as a yellow fluffy powder (35 mg, 35% yield).

### Example 71

### Synthesis of N3-PEG12K-b-P(Asp(FITC)₁-co-Asp(DET)₁₇₉-co-DLeu₂₀)-Ac

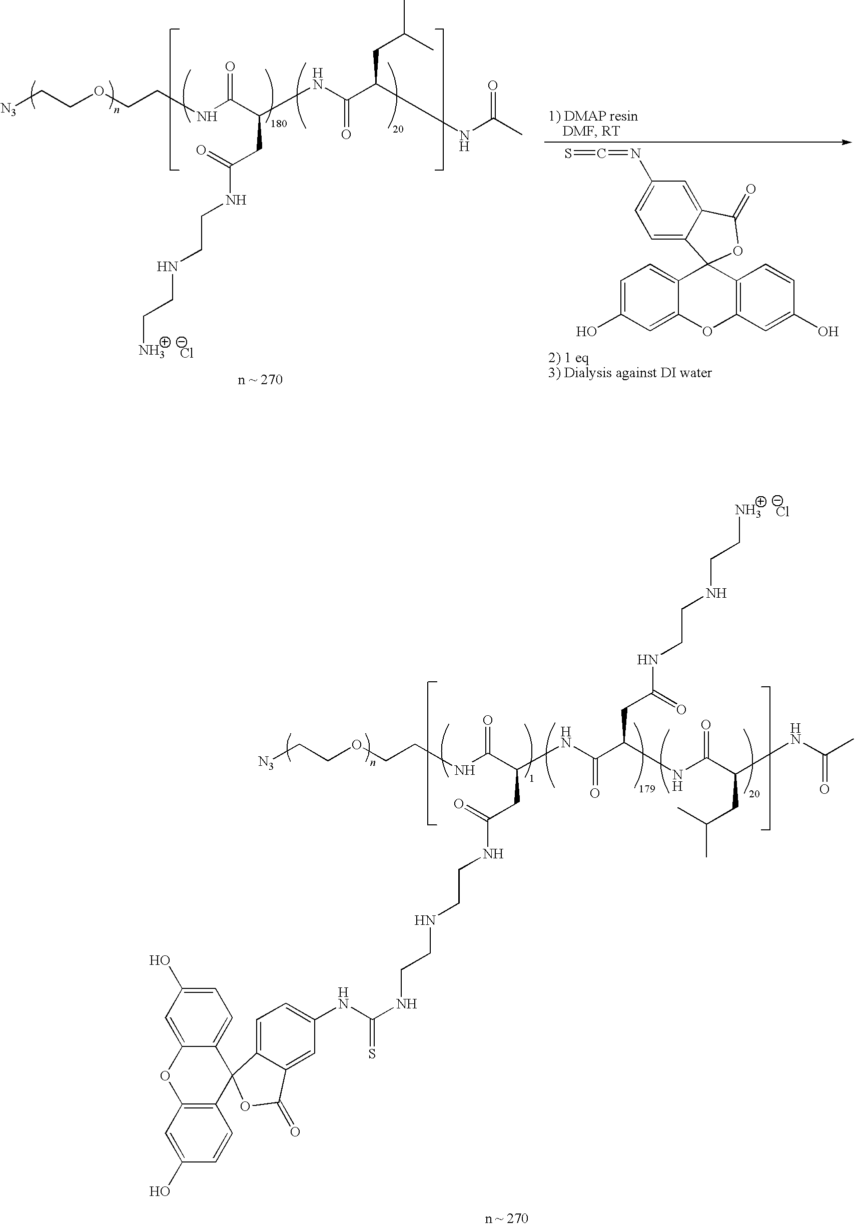

N₃-PEG12K-b-P(Asp(FITC)₁-co-Asp(DET)₁₇₉-co-DLeu₂₀)-Ac was synthesized as described in Example 70 with N3-PEG12K-b-P(Asp(DET)₁₈₀-co-DLeu₁₀)-Ac (100 mg, 1.77 μmol), DMAP resin (1.47 mmol DMAP/g resin, 2.4 mg, 3.55 μmol), FITC (0.69 mg, 1.77 μmol) and DMSO (4 mL). The polymer was recovered as a yellow fluffy powder (25 mg, 25% yield).

### Example 72

### Synthesis of N3-PEG12K-b-P(Asp(FITC)₁-co-Asp(DET)₁₃₉-co-DLeu₆₀)-Ac

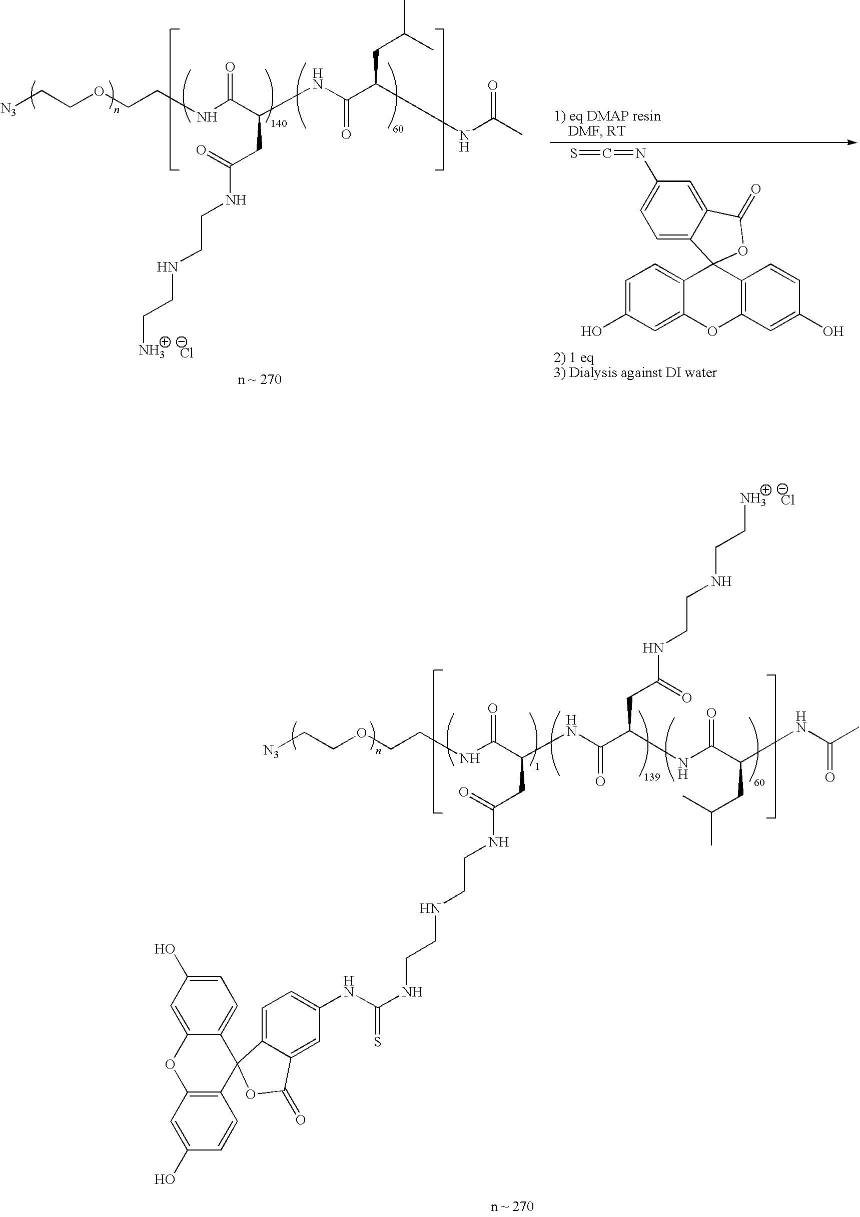

N₃-PEG12K-b-P(Asp(FITC)₁-co-Asp(DET)₁₃₉-co-DLeu₆₀)-Ac was synthesized as described in Example 70 with N3-PEG12K-b-P(Asp(DET)₁₄₀-co-DLeu₆₀)-Ac (100 mg, 1.94 μmol), DMAP resin (1.47 mmol DMAP/g resin, 2.6 mg, 3.89 μmol), FITC (0.76 mg, 1.94 μmol) and DMSO (4 mL). The polymer was recovered as a yellow fluffy powder (50.6 mg, 56% yield).

### Example 73

### Synthesis of N₃-PEG12k-b-P(D-Leu₁₀-co-Phe₁₀)-b-P(Asp(OBzl)₅₀-co-D-Asp(OBzl)₅₀)-Ac

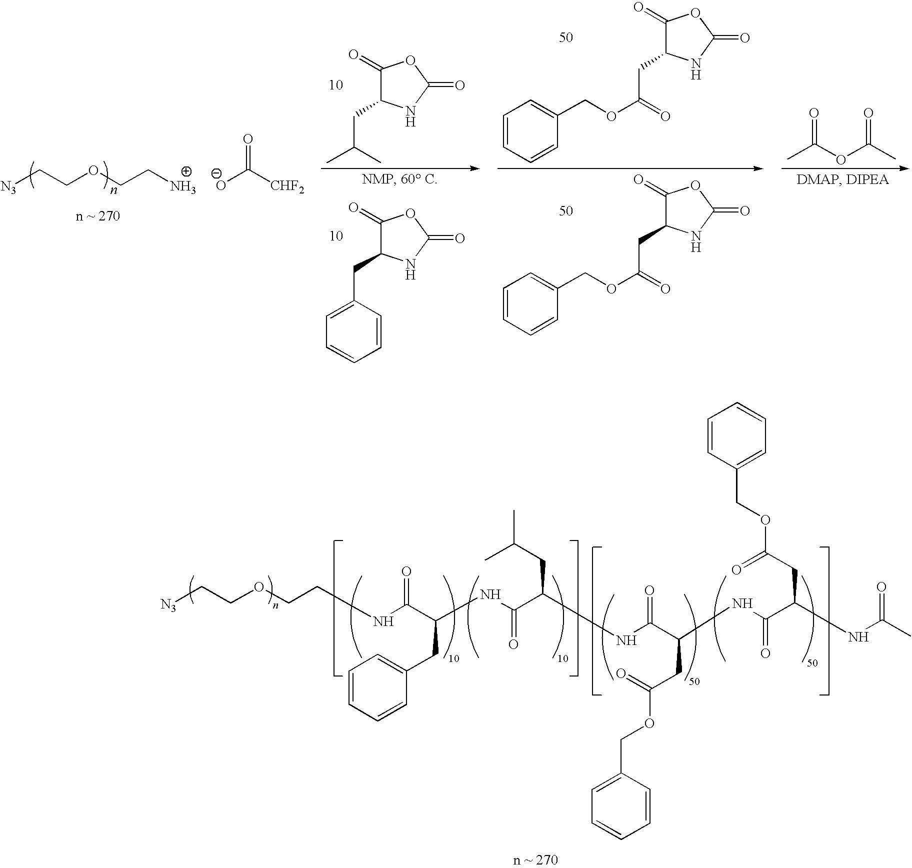

### Example 74

### Synthesis of N₃-PEG12k-b-P(D-Leu₁₀-co-Phe₁₀)-b-P(Asp(DET)₅₀-co-D-Asp(DET)₅₀)-Ac

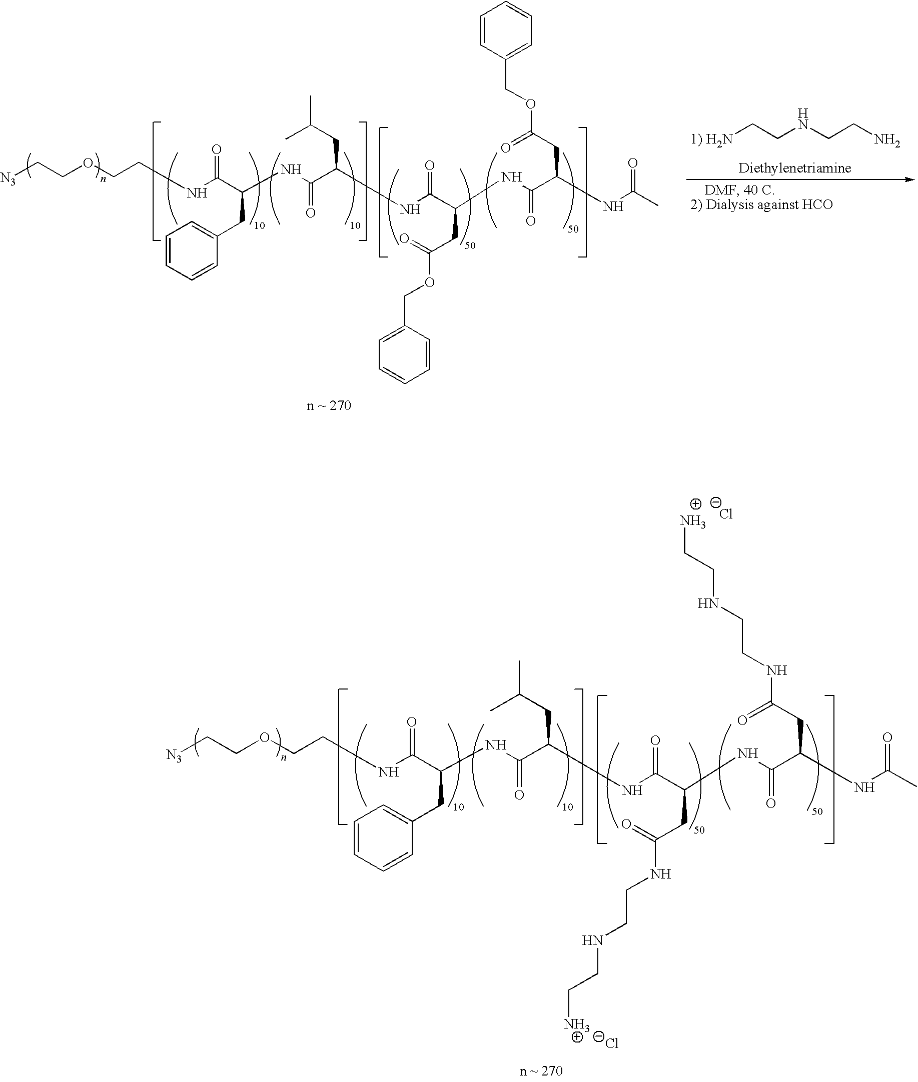

### Example 75

### Synthesis of UPAR-PEG12k-b-P(D-Leu₁₀-co-Phe₁₀)-b-P(Asp(OBzl)₅₀-co-D-Asp(OBzl)₅₀)-Ac

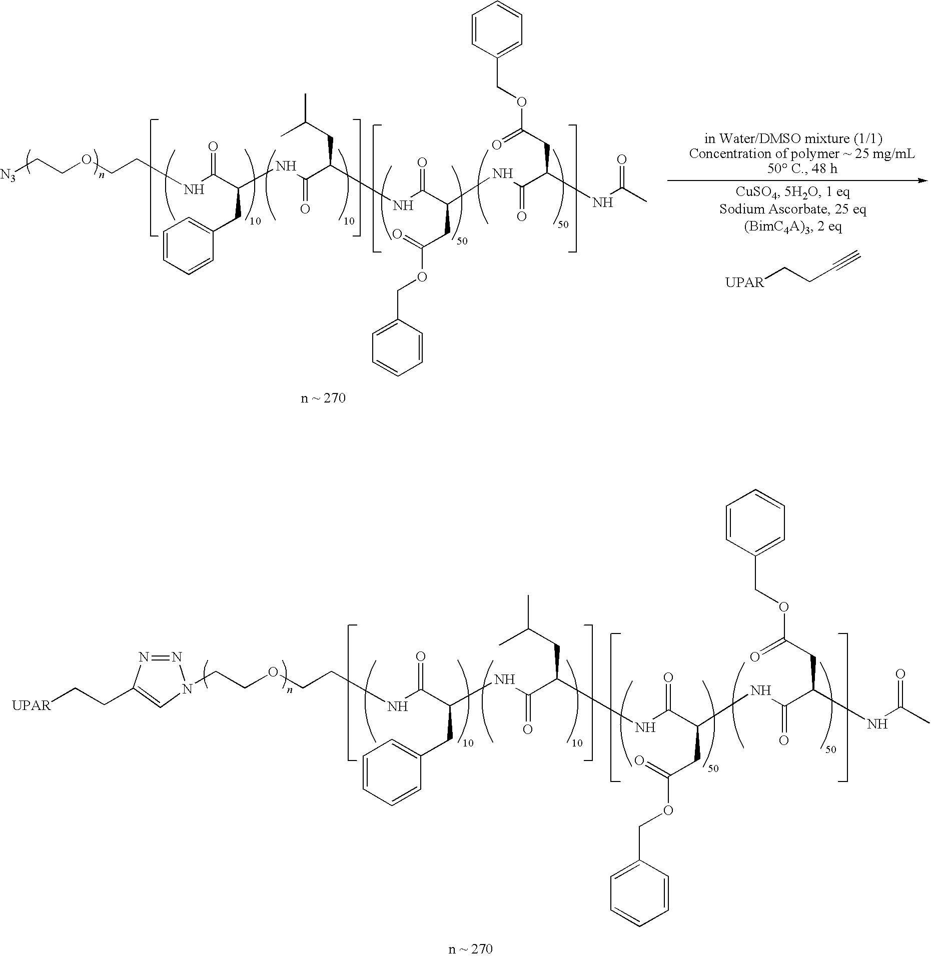

### Example 76

### Synthesis of UPAR-PEG12k-b-P(D-Leu₁₀-co-Phe₁₀)-b-P(Asp(DET)₅₀-co-D-Asp(DET)₅₀)-Ac

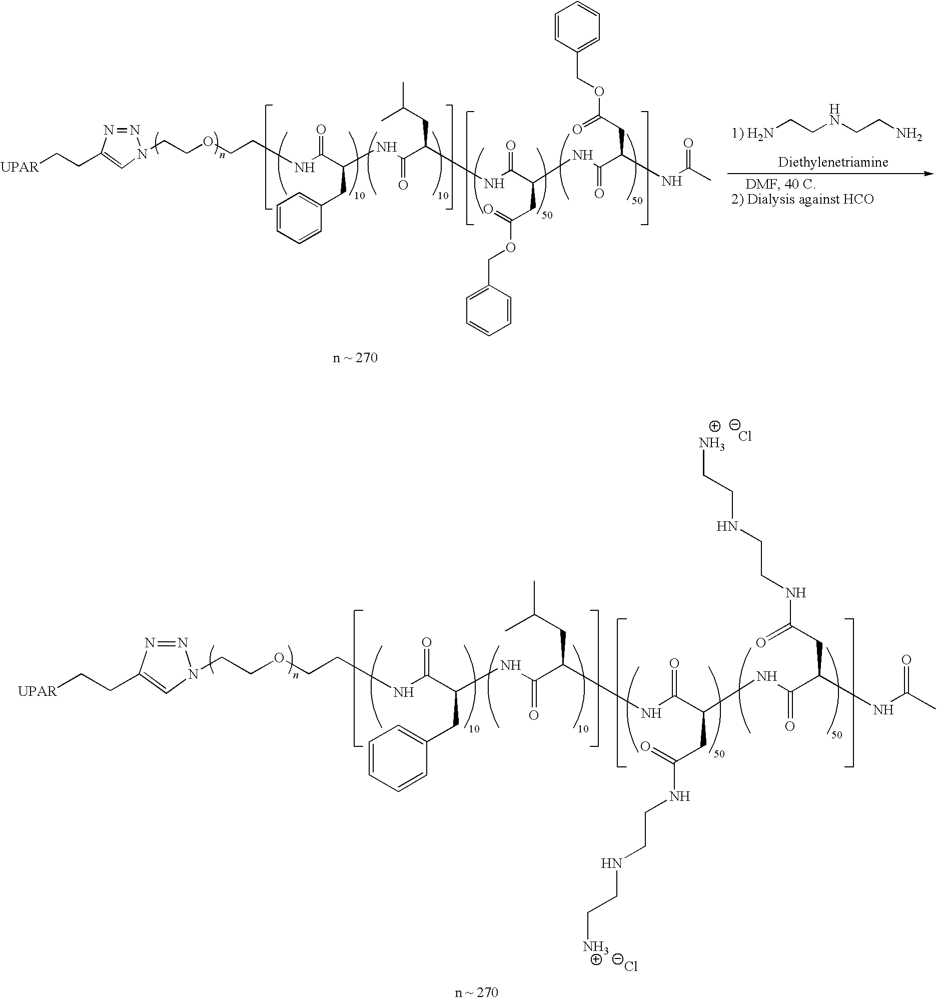

### Example 77

### Synthesis of Alkyne-P(D-Leu₁₀-co-Phe₁₀)-b-P(Asp(OBzl)₅₀-co-D-Asp(OBzl)₅₀)-b-P(D-Leu₁₀-co-Phe₁₀)-alkyne

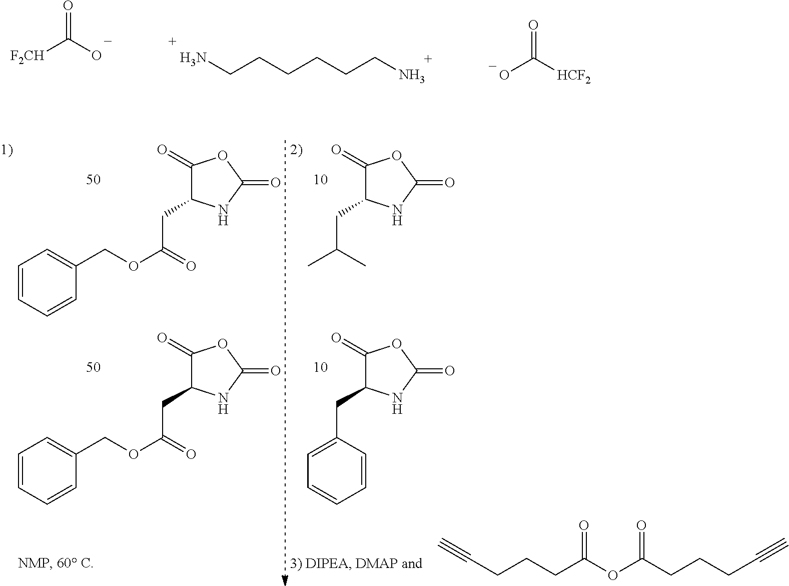

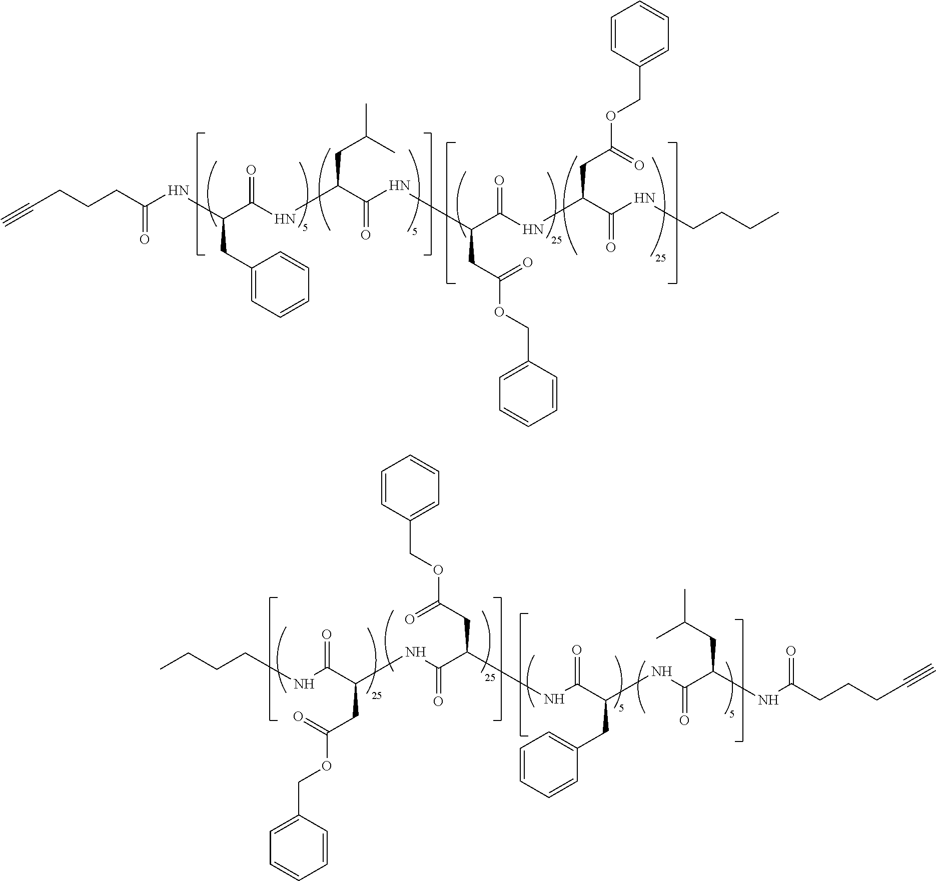

### Example 78

### Synthesis of N₃-PEG10k-b-P(D-Leu₁₀-co-Phe₁₀)-b-P(Asp(OBzl)₅₀-co-D-Asp(OBzl)₅₀)-b-P(D-Leu₁₀co-Phe₁₀)-b-PEG10k-N3

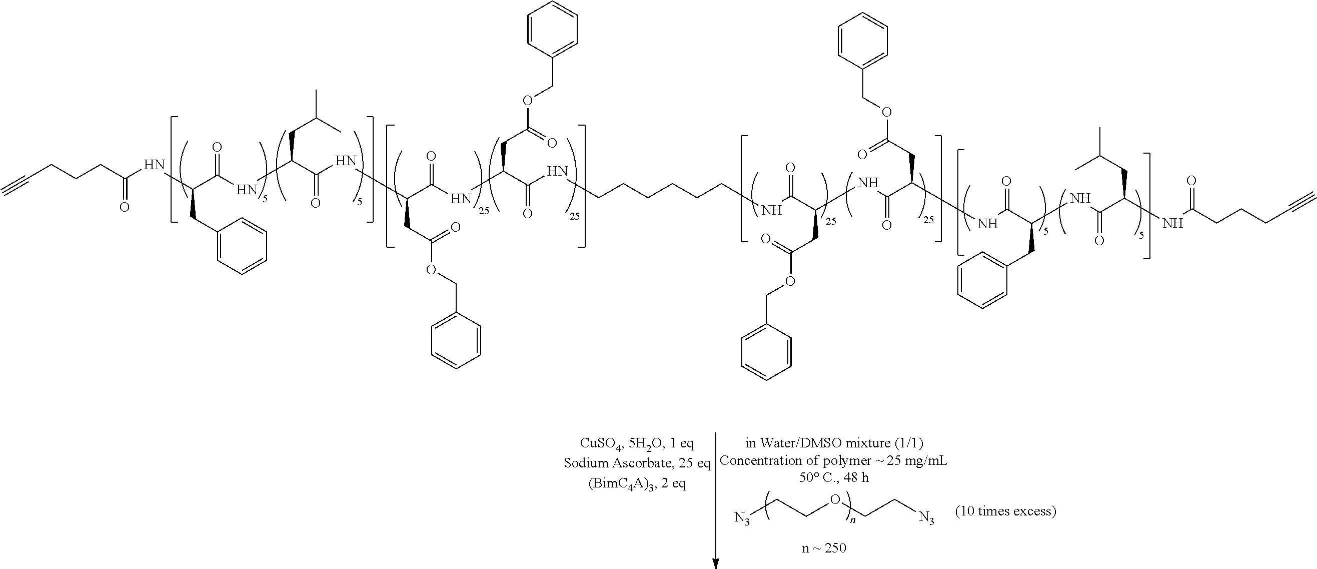

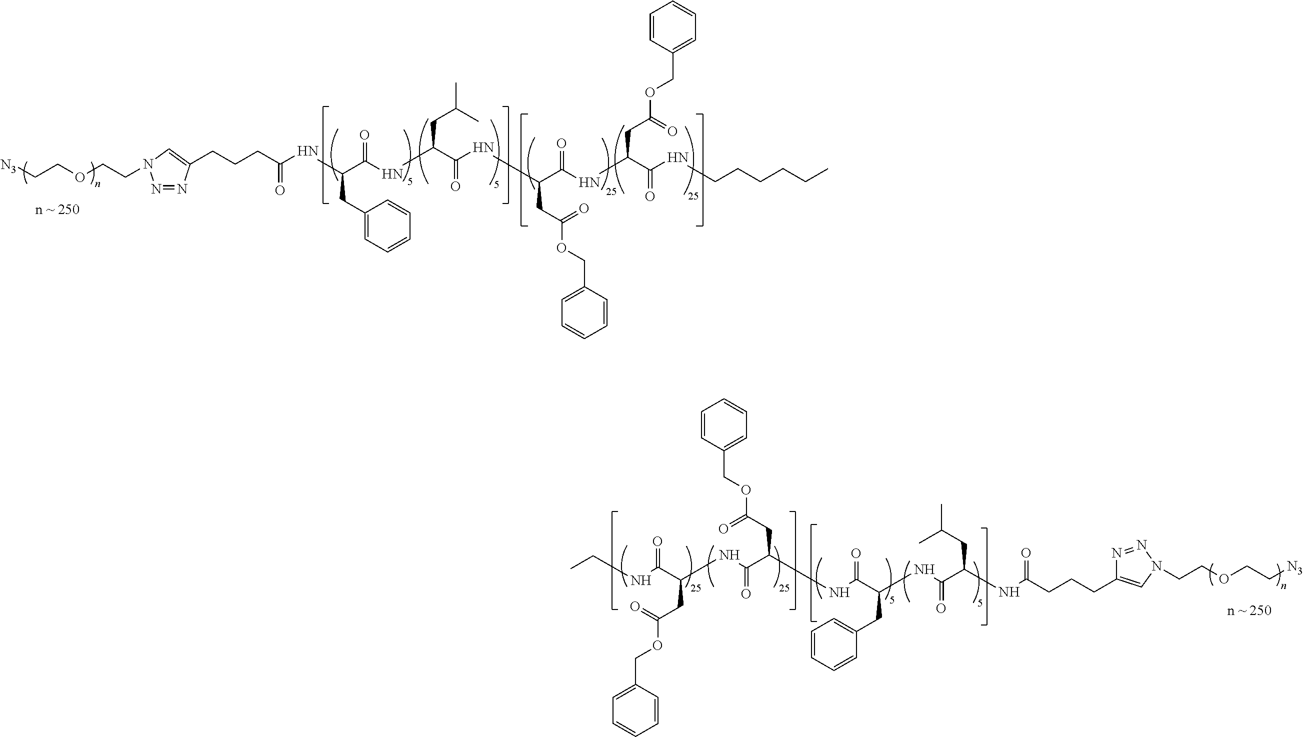

### Example 79

### N₃-PEG10k-b-P(D-Leu₁₀-co-Phe₁₀)-b-P(Asp(DET)₅₀-co-D-Asp(DET)₅₀)-b-P(D-Leu₁₀-co-Phe₁₀)-b-PEG10k-N3

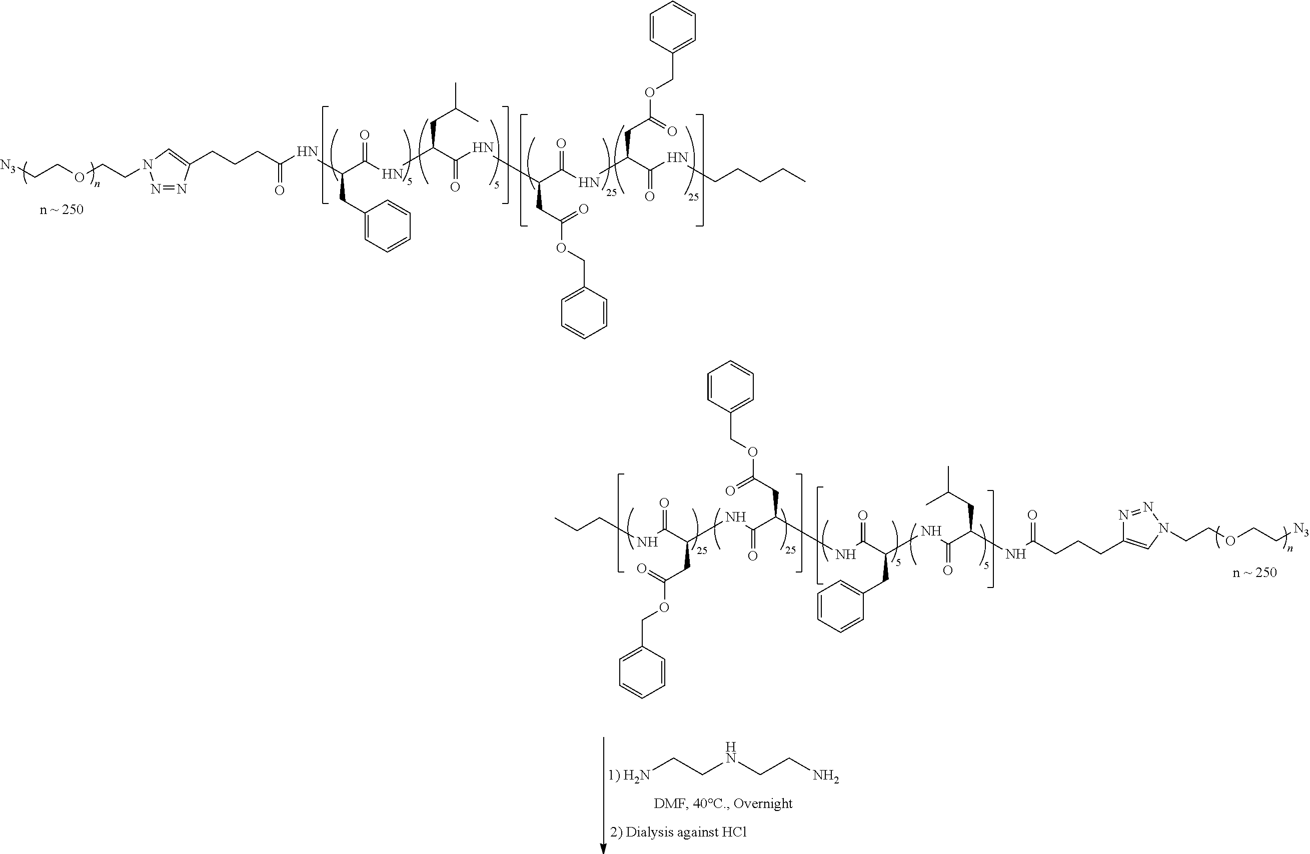

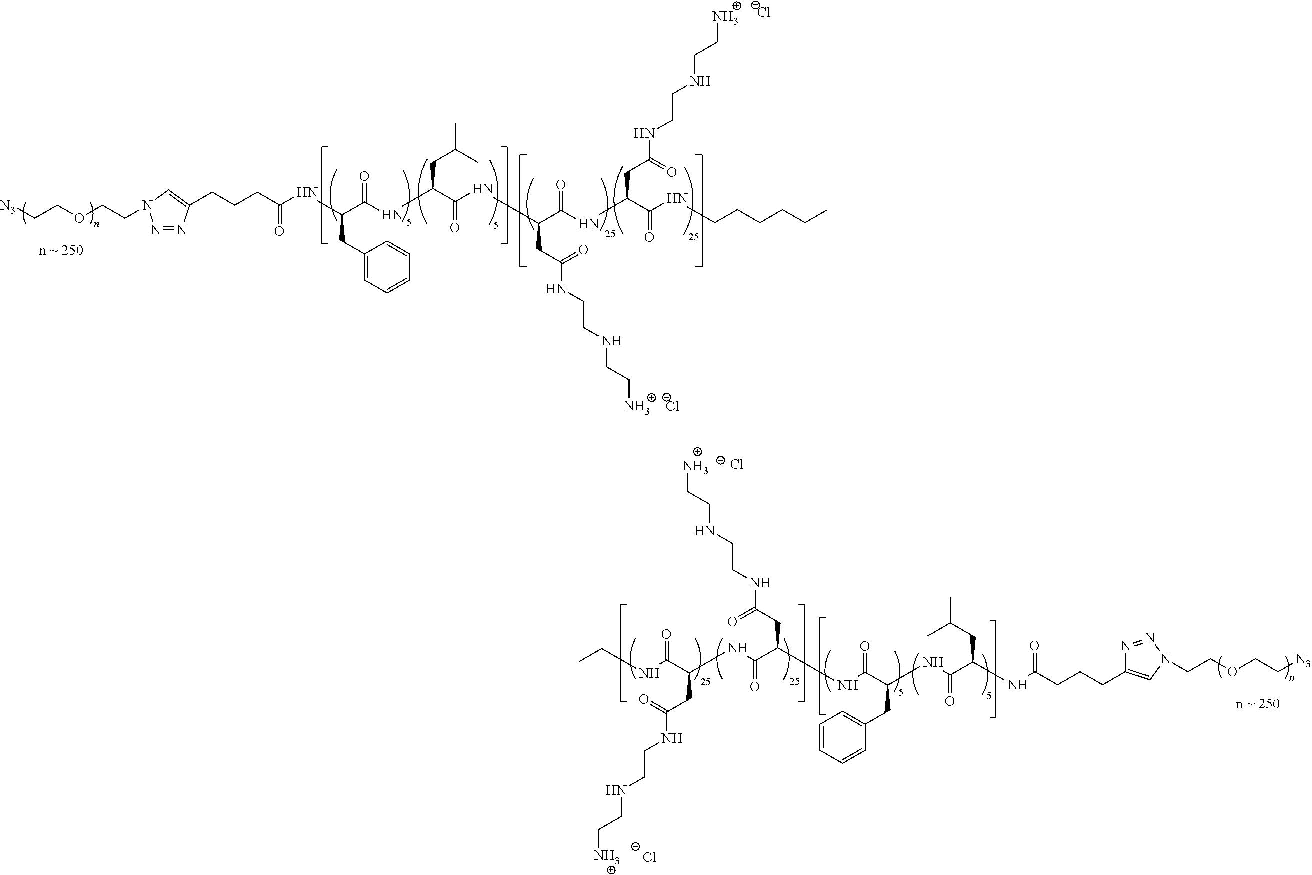

### Example 80

### Synthesis of UPAR-PEG10k-b-P(D-Leu₁₀-co-Phe₁₀)-b-P(Asp(OBzl)₅₀-co-D-Asp(OBzl)₅₀)-b-P(D-Leu₁₀-co-Phe₁₀)-b-PEG10k-UPAR

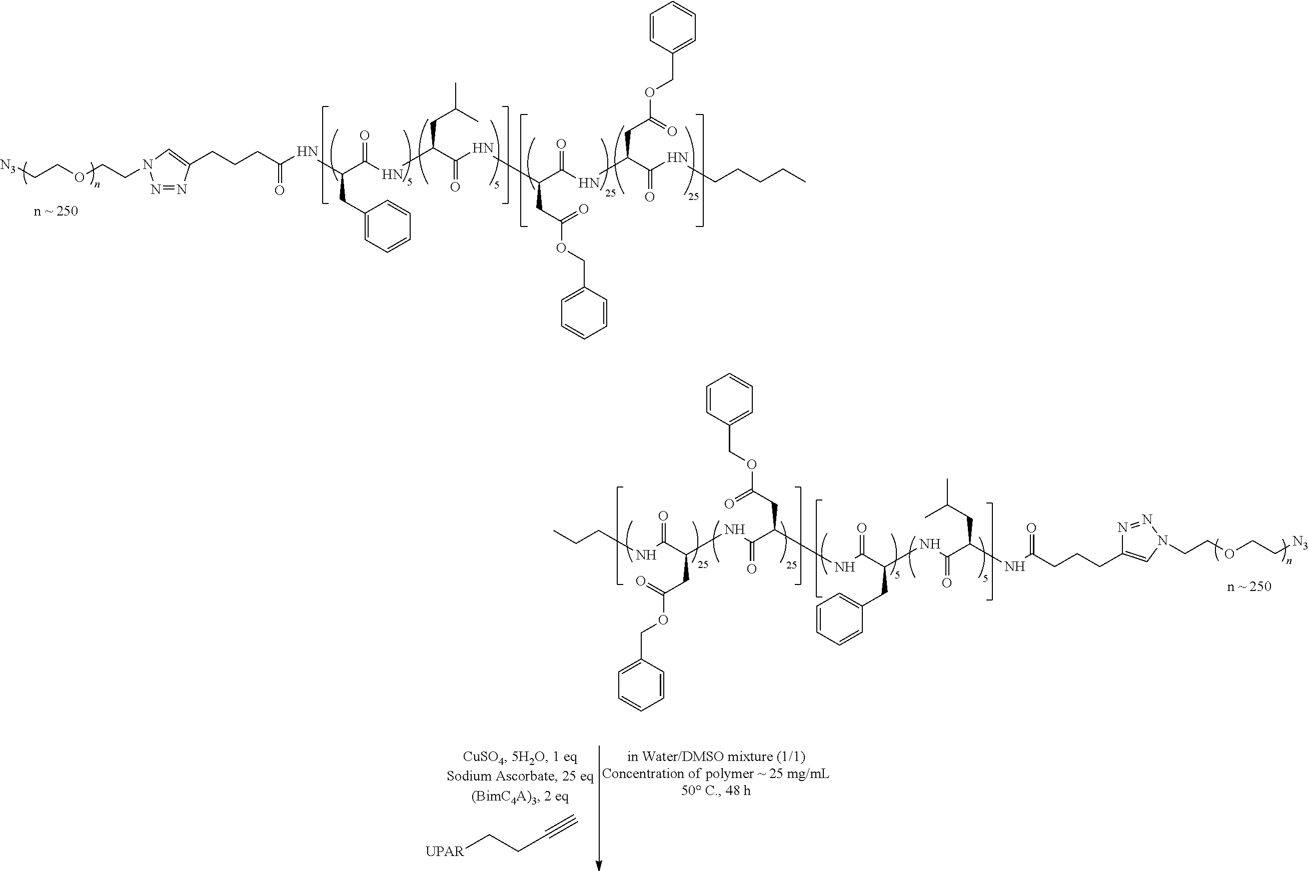

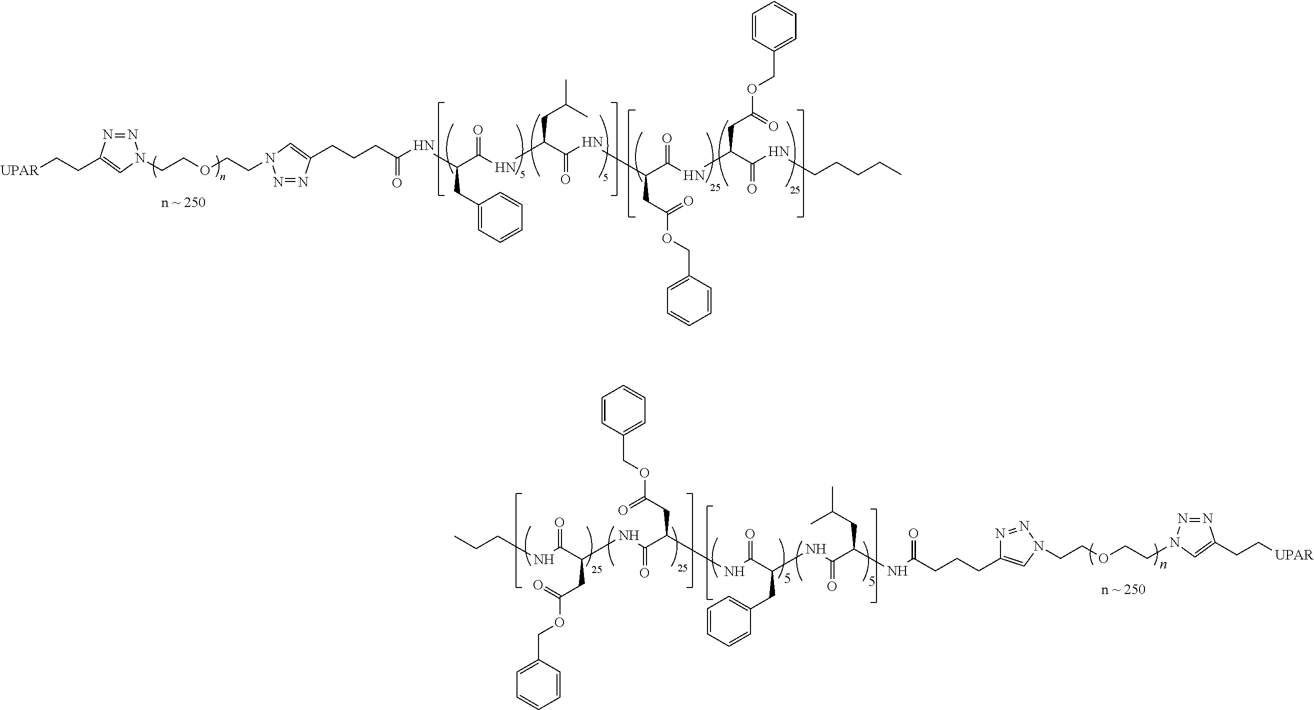

### Example 81

### Synthesis of UPAR-PEG10k-b-P(D-Leu₁₀-co-Phe₁₀)-b-P(Asp(DET)₅₀-co-D-Asp(DET)₅₀)-b-P(D-Leu₁₀-co-Phe₁₀)-b-PEG10k-UPAR

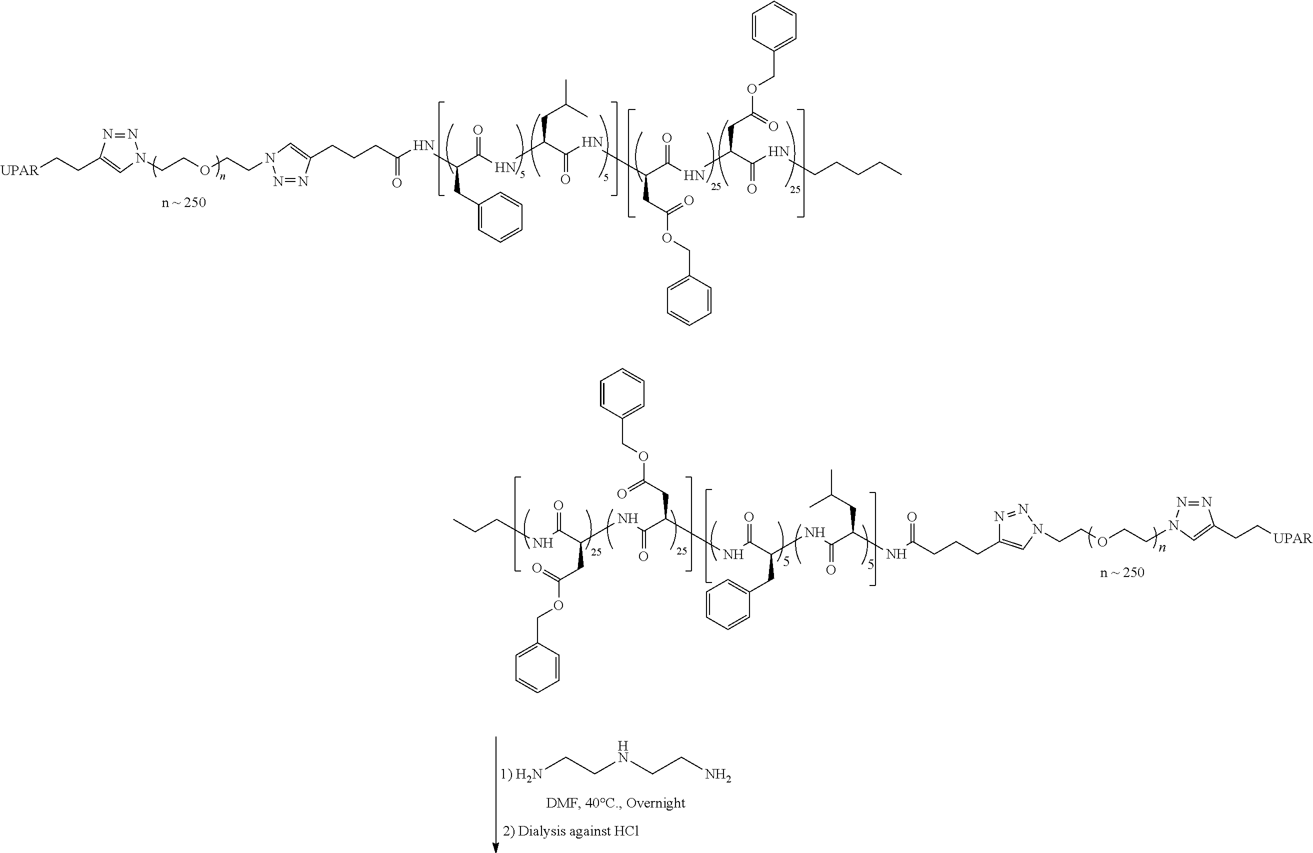

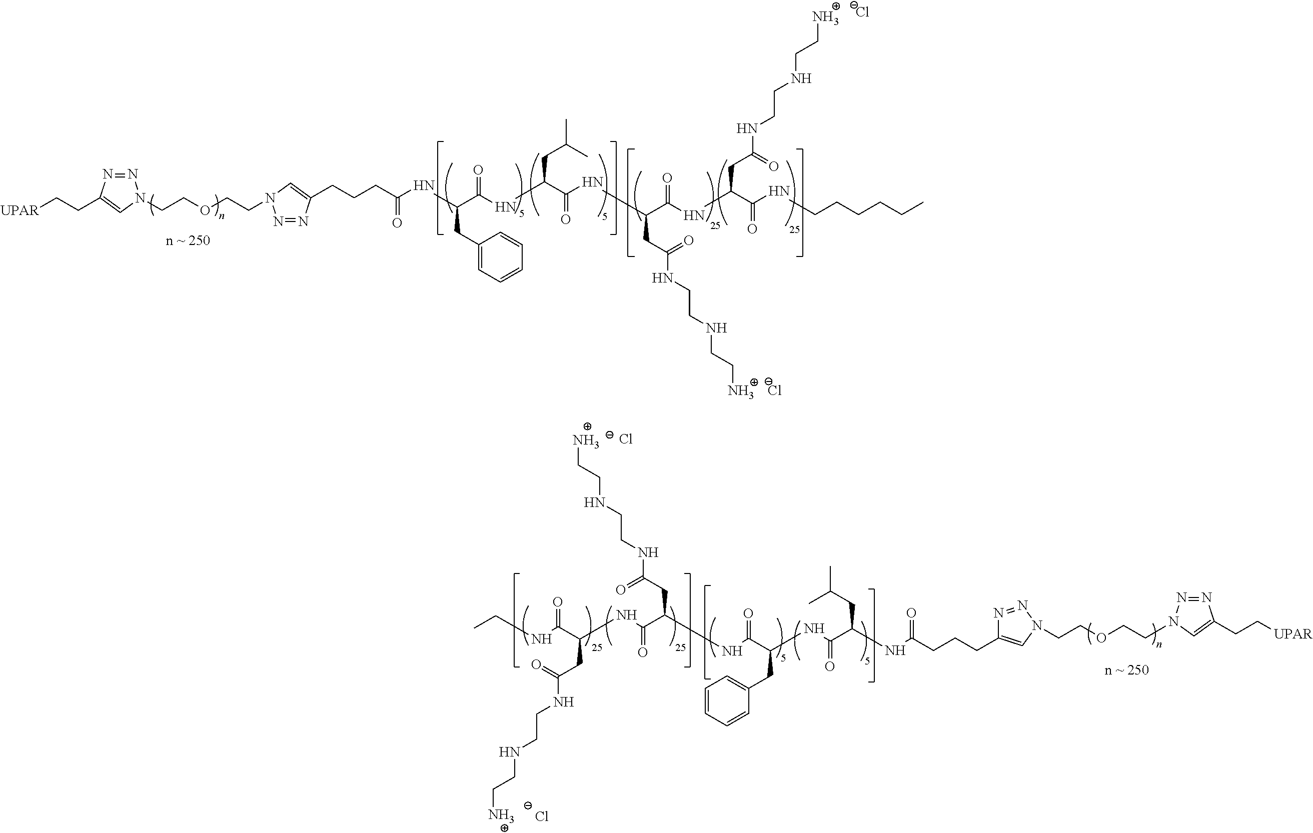

1. A diblock copolymer of formula I-b: 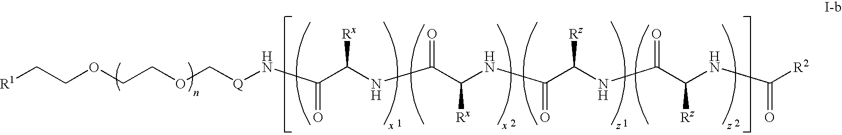
wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
Het is a bivalent 5-6 membered saturated, partially unsaturated, or aromatic ring having at least one nitrogen and 0-3 additional heteroatoms independently selected from nitrogen, oxygen, or sulfur;
R⁴ is R or N(R)₂;
each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
each Y is independently —O— or —S—;
p is 0-10;
t is 0-10; and
R³ is hydrogen, —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
-Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

2. A triblock copolymer of formula II-a: 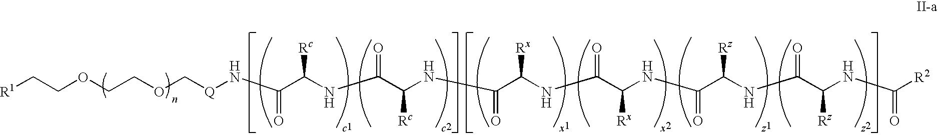
wherein:
n is 50-2500;
c¹ is 0 to 100;
c² is 0 to 100, provided that c¹ and c² are not simultaneously zero;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{c} is a natural or unnatural amino acid side-chain group that is capable of crosslinking;
R^{x} is a natural or unnatural amino acid side-chain group that is hydrophobic;
R^{z} is -L-R⁴ wherein:
L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
Het is a bivalent 5-6 membered saturated, partially unsaturated, or aromatic ring having at least one nitrogen and 0-3 additional heteroatoms independently selected from nitrogen, oxygen, or sulfur;
R⁴ is R or N(R)₂;
each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
each Y is independently —O— or —S—;
p is 0-10;
t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
-Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

3. A multiblock copolymer of formula III-a: 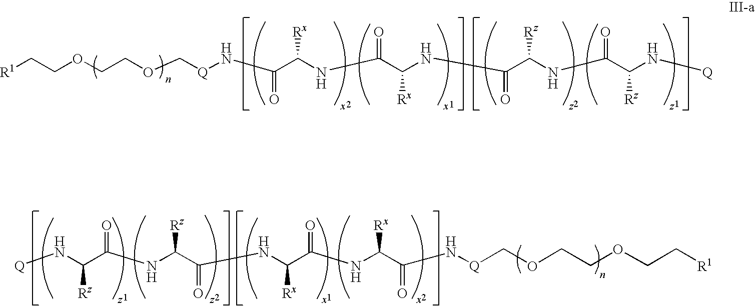
wherein:
n is 50-2500;
x¹ is 0 to 250;
x² is 0 to 250;
z¹ is 0 to 250, provided that x¹ and z¹ are not simultaneously zero;
z² is 0 to 250, provided that z¹ and z² are not simultaneously zero;
R^{x} is a natural or unnatural amino acid side-chain group that is hydrophobic;
R^{z} is -L-R⁴ wherein:
L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
Het is a bivalent 5-6 membered saturated, partially unsaturated, or aromatic ring having at least one nitrogen and 0-3 additional heteroatoms independently selected from nitrogen, oxygen, or sulfur;
R⁴ is R or N(R)₂;
each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
each Y is independently —O— or —S—;
p is 0-10;
t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
each Q is independently a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, 'SO—, —SO₂—, —NHSO₂—, —SO₂NH—, —NHC(O)—, —C(O)NH—, —OC(O)NH—, or —NHC(O)O—, wherein:
-Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur.

4. A multiblock copolymer of formula IV-a: 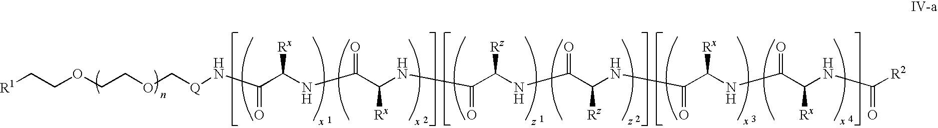
wherein:
n is 50-2500;
x¹ is 0 to 250;
x² is 0 to 250;
z¹ is 0 to 250, provided that x¹ and y¹ are not simultaneously zero;
z² is 0 to 250, provided that y¹ and y² are not simultaneously zero;
x³ is 0 to 250;
x⁴ is 0 to 250, provided that x³ and x⁴ are not simultaneously zero;
R^{x} is a natural or unnatural amino acid side-chain group that is hydrophobic;
R^{z} is -L-R⁴ wherein:
L is a bivalent, straight or branched, C₄₋₂₀ alkylene chain wherein at least one methylene unit of -L- is replaced by —C(O)NR— and 1-10 additional methylene units are independently replaced by —N(R)— or -Het-;
Het is a bivalent 5-6 membered saturated, partially unsaturated, or aromatic ring having at least one nitrogen and 0-3 additional heteroatoms independently selected from nitrogen, oxygen, or sulfur;
R⁴ is R or N(R)₂;
each R is hydrogen or C₁₋₆ aliphatic, or two R on the same nitrogen are taken together with the nitrogen to form a 5-6 membered heterocyclic ring having 1-3 heteroatoms independently selected from nitrogen, oxygen, or sulfur;
R¹ is —Z(CH₂CH₂Y)ₚ(CH₂)ₜR³, wherein:
Z is a valence bond, a bivalent triazolyl moiety, —O—, —S—, —C≡C—, or —CH₂—;
each Y is independently —O— or —S—;
p is 0-10;
t is 0-10; and
R³ is —N₃, —CN, a mono-protected amine, a di-protected amine, a protected aldehyde, a protected hydroxyl, a protected carboxylic acid, a protected thiol, a 9-30 membered crown ether, or an optionally substituted group selected from aliphatic, a 5-8 membered saturated, partially unsaturated, or aryl ring having 0-4 heteroatoms independently selected from nitrogen, oxygen, or sulfur, an 8-10 membered saturated, partially unsaturated, or aryl bicyclic ring having 0-5 heteroatoms independently selected from nitrogen, oxygen, or sulfur, or a detectable moiety or a targeting group;
Q is a valence bond or a bivalent, saturated or unsaturated, straight or branched C₁₋₁₂ alkylene chain, wherein 0-6 methylene units of Q are independently replaced by -Cy-, —O—, —NH—, —S—, —OC(O)—, —C(O)O—, —C(O)—, —SO—, —SO₂—, —NHSO₂—, —SO₂NH—, —NHC(O)—, —C(O)NH—, —OC(O)NH—, or —NHC(O)O—, wherein:
-Cy- is an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur;
R² is selected from an optionally substituted aliphatic group or a fusogenic peptide.

5-13. (canceled)

14. The copolymer of claim 1, wherein R^{x} is an amino acid side-chain group corresponding to that of leucine, norleucine, or phenylalanine

15-17. (canceled)

18. The copolymer of claim 1, wherein R² is methyl.

19. The copolymer of claim 1, wherein Q is —CH₂—.

20. The copolymer of claim 1, wherein R¹ is N₃.

21. The copolymer of claim 1, wherein R^{z} is selected from:

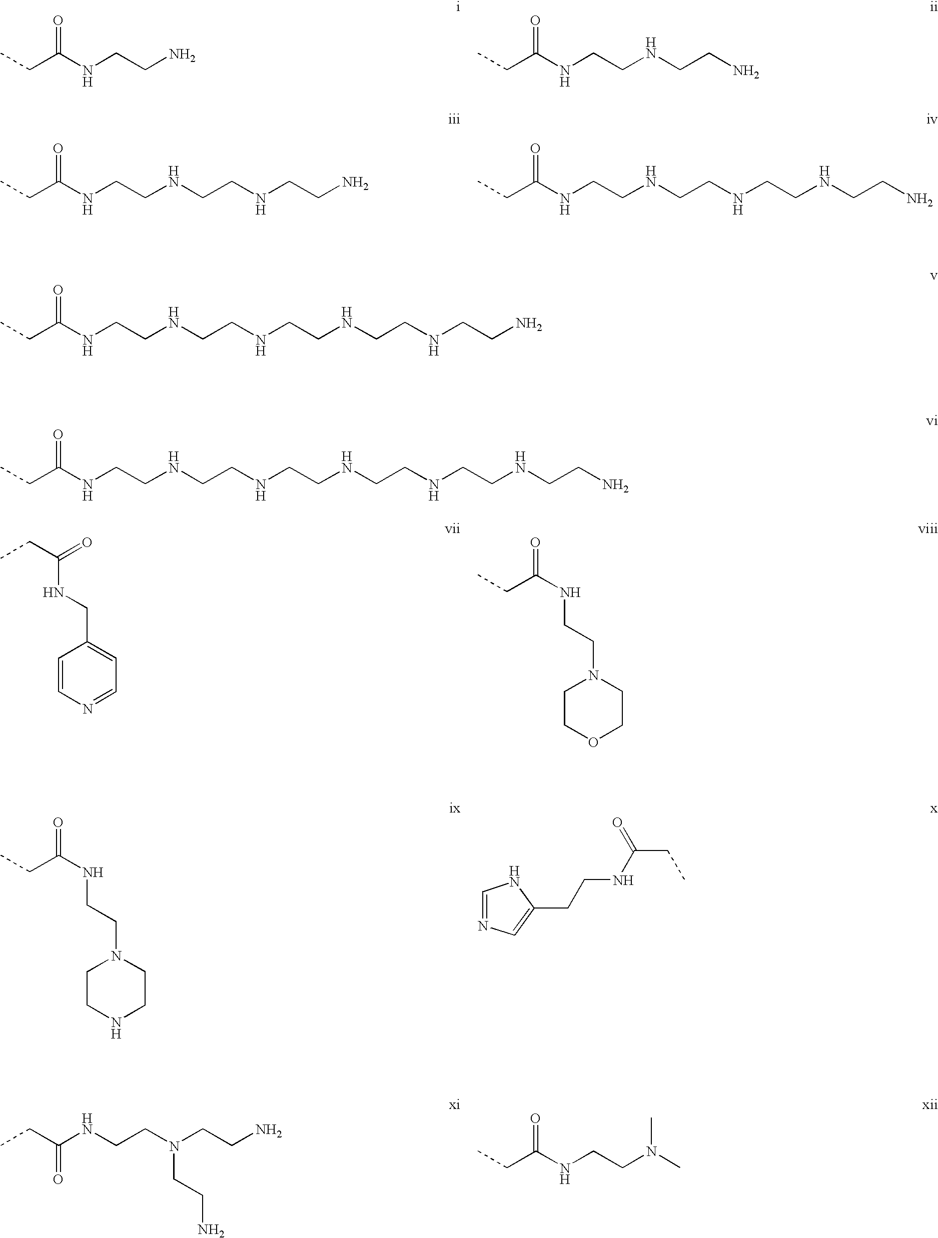

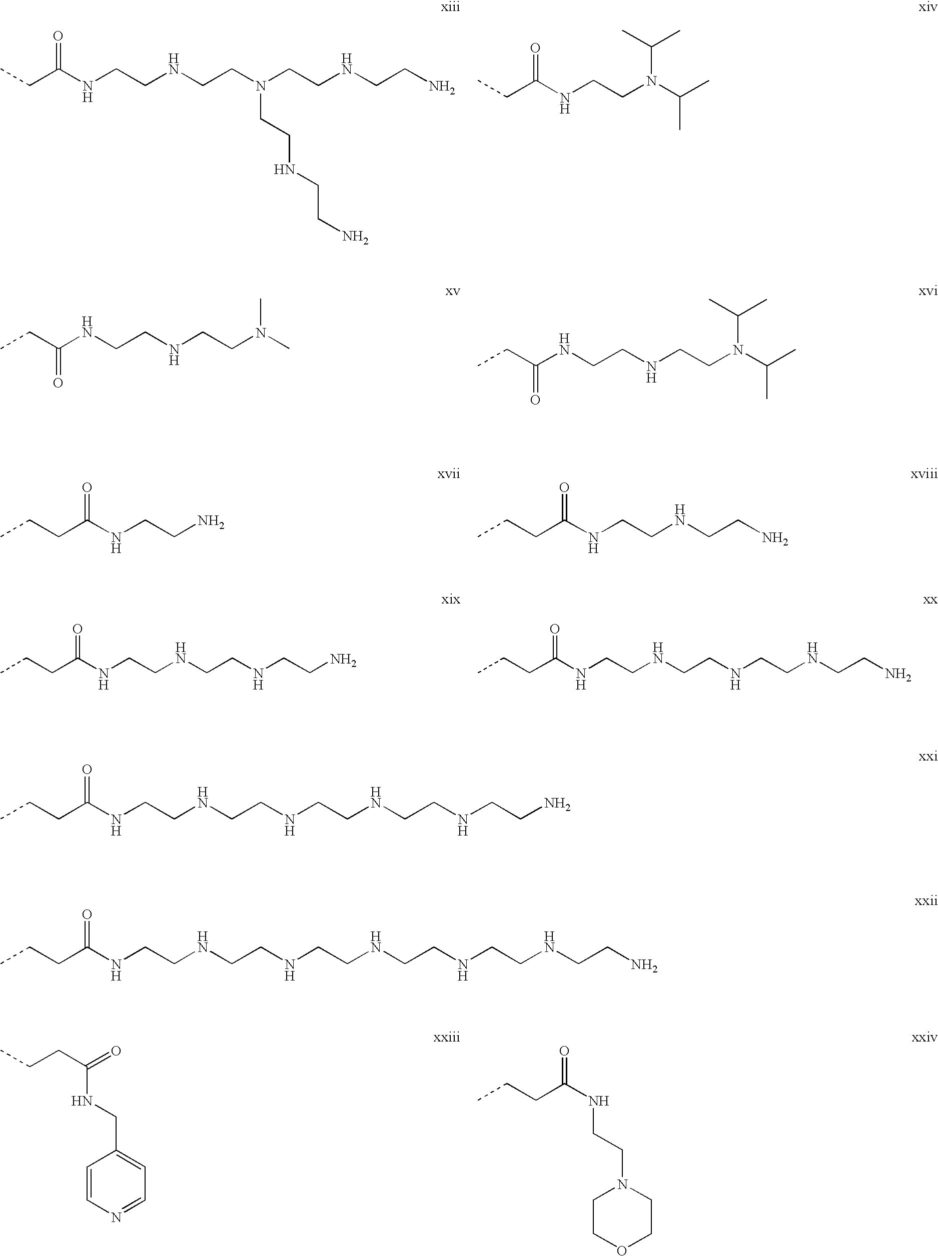

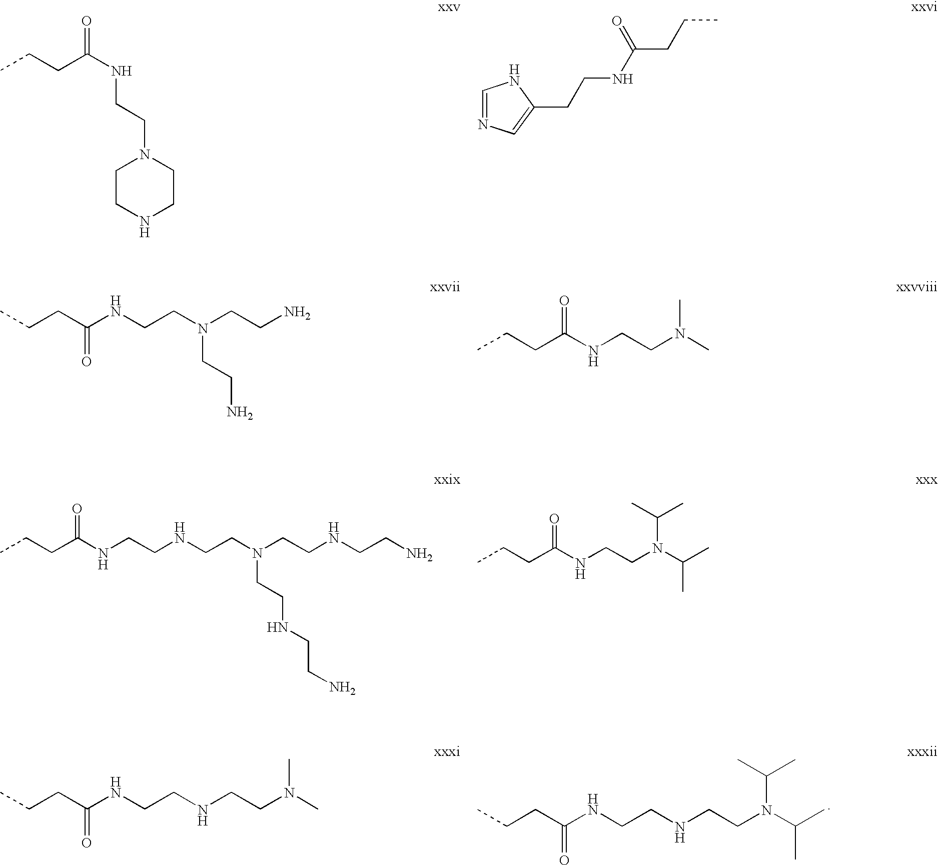

22-28. (canceled)

29. The copolymer of claim 1, wherein R³ is a targeting group selected from folate, a Her-2 binding peptide, a urokinase-type plasminogen activator receptor (uPAR) antagonist, a CXCR4 chemokine receptor antagonist, a GRP78 peptide antagonist, an RGD peptide, an RGD cyclic peptide, a luteinizing hormone-releasing hormone (LHRH) antagonist peptide, an aminopeptidase targeting peptide, a brain homing peptide, a kidney homing peptide, a heart homing peptide, a gut homing peptide, an integrin homing peptide, an angiogencid tumor endothelium homing peptide, an ovary homing peptide, a uterus homing peptide, a sperm homing peptide, a microglia homing peptide, a synovium homing peptide, a urothelium homing peptide, a prostate homing peptide, a lung homing peptide, a skin homing peptide, a retina homing peptide, a pancreas homing peptide, a liver homing peptide, a lymph node homing peptide, an adrenal gland homing peptide, a thyroid homing peptide, a bladder homing peptide, a breast homing peptide, a neuroblastoma homing peptide, a lymphona homing peptide, a muscle homing peptide, a wound vasculature homing peptide, an adipose tissue homing peptide, a virus binding peptide, or a fusogenic peptide.

30-31. (canceled)

32. The copolymer of claim 1, wherein the copolymer of formula I-b comprises a diblock copolymer of formula b: 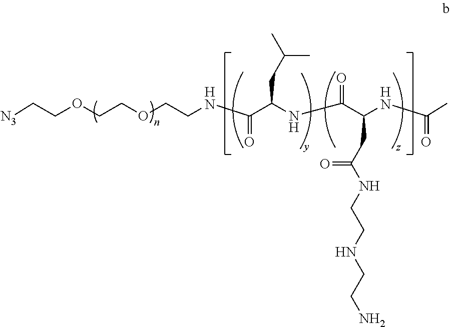
wherein:
n is 50-2500;
y is 5 to 250; and
z is 5 to 250.

33. The copolymer of claim 1, wherein the copolymer of formula I-b comprises a diblock copolymer of formula c: 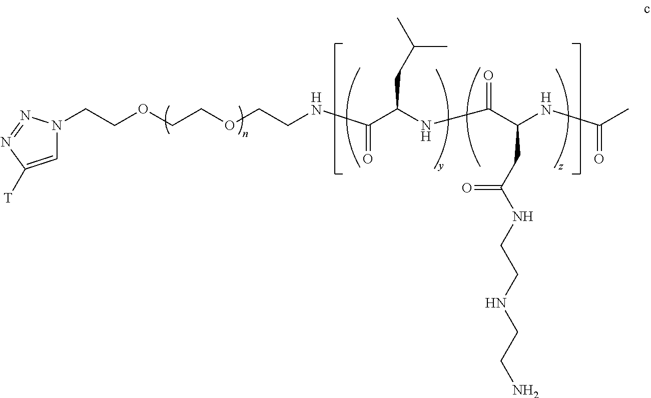
wherein:
n is 50-2500;
y is 5 to 250;
z is 5 to 250; and
T is a targeting group moiety.

34-40. (canceled)
